(19) United States
(12) Patent Application Publication
(10) Pub. No.: US 2026/0128499 A1
(43) Pub. Date: May 7, 2026

(54) Foldable Electronic Device

(71) Applicant: HUAWEI TECHNOLOGIES CO., LTD., Shenzhen (CN)

(72) Inventors: Liang Xue, Shanghai (CN); Jiaming Wang, Shanghai (CN); Dong Yu, Shanghai (CN); Jikang Wang, Shanghai (CN); Huatao Liu, Shanghai (CN); Baokun Xi, Shenzhen (CN); Kun Feng, Shanghai (CN)

(73) Assignee: HUAWEI TECHNOLOGIES CO., LTD., Shenzhen (CN)

(21) Appl. No.: 19/426,907

(22) Filed: Dec. 19, 2025

Related U.S. Application Data
(63) Continuation of application No. PCT/CN2024/100152, filed on Jun. 19, 2024.

(30) Foreign Application Priority Data
Jun. 21, 2023 (CN) 202310748091.6
Mar. 19, 2024 (CN) 202410313049.6

(51) Int. Cl. H01Q 1/22; H01Q 1/48; H01Q 9/00

(52) U.S. Cl. CPC H01Q 1/22; H01Q 1/48; H01Q 9/00

(57) ABSTRACT

A foldable electronic device includes an antenna, where the antenna uses a first side frame and a second side frame that are disposed in the foldable electronic device as radiators. A part of the first side frame is used as a feed stub, and a part of the second side frame is used as a parasitic stub. A gap is provided on the parasitic stub, so that a radiation aperture of the parasitic stub is increased.

### CROSS-REFERENCE TO RELATED APPLICATIONS

This is a continuation of International Patent Application No. PCT/CN2024/100152 filed on Jun. 19, 2024, which claims priority to Chinese Patent Application No. 202310748091.6 filed on Jun. 21, 2023, and Chinese Patent Application No. 202410313049.6 filed on Mar. 19, 2024. All of the aforementioned patent applications are hereby incorporated by reference in their entireties.

### TECHNICAL FIELD

This disclosure relates to the field of wireless communication, and in particular, to a foldable electronic device.

### BACKGROUND

Wireless communication technologies are rapidly evolving. In the past, a second generation (2G) mobile communication system mainly supports a call function, electronic devices are merely tools used by people to send and receive Short Message Service (SMS) messages and perform voice communication, and a wireless network access function is extremely slow because data is transmitted through a voice channel. Nowadays, in addition to making calls, sending SMS messages, and taking photos, an electronic device can be further used for listening to music online, watching online movies, making video calls in real time, and the like, covering various applications such as a call application, a movie and television entertainment application, and an e-commerce application in people's life. In this case, a plurality of functional applications may need to upload and download data over a wireless network. Therefore, high-speed data transmission becomes extremely important.

As people have an increasingly high requirement for high-speed data transmission, a development trend of an industrial design (ID) of the electronic device is to have a large screen-to-body ratio and a plurality of cameras. Consequently, antenna clearance is greatly reduced, and space for layout is increasingly limited. However, this is in conflict with features of the antenna serving as an open system, restricting performance of the antenna.

### SUMMARY

Embodiments of this disclosure provide a foldable electronic device, including an antenna. The antenna uses a first side frame and a second side frame that are disposed in a foldable manner of an electronic device as radiators. A part of the first side frame is used as a radiation stub (a stub for feeding a signal at a feed point), and a part of the second side frame is used as a parasitic stub (a stub for coupling a signal by coupling a main radiation stub). A gap is provided on the parasitic stub, so that a radiation aperture of the antenna is increased to improve a radiation characteristic of the antenna.

According to a first aspect, a foldable electronic device is provided, including: a first housing, a second housing, and a ground plane, where the first housing includes a first side frame, the second housing includes a second side frame, at least a part of the first side frame and the ground plane are spaced apart, and at least a part of the second side frame and the ground plane are spaced apart; the first side frame includes a first position and a second position, where the first side frame is coupled to the ground plane at the first position or is provided with a first slot at the first position, and the first side frame is coupled to the ground plane at the second position or is provided with a second slot at the second position; and the second side frame includes a third position and a fourth position, the second side frame is coupled to the ground plane at the third position, and the second side frame is provided with a third slot at the fourth position; a first rotating shaft, where the first rotating shaft is located between the first housing and the second housing, and the first rotating shaft is rotatably connected to the first housing and the second housing separately; and an antenna, where the antenna includes: a first radiator and a first feed circuit, where the first radiator is a conductive part, between the first position and the second position, of the first side frame, the first radiator includes a first feed point, and the first feed circuit is coupled to the first feed point; and a second radiator and a first element, where the second radiator is a conductive part, between the third position and the fourth position, of the second side frame, and a length of the second radiator is less than or equal to three times a length of the first radiator; and the second radiator includes a first coupling point and a second coupling point, the second radiator is provided with a fourth slot between the first coupling point and the second coupling point, a first end of the first element is coupled to the first coupling point, and a second end of the first element is coupled to the second coupling point, where when the foldable electronic device is in a folded state, the first radiator and the second radiator at least partially overlap in a first direction, the first radiator is configured to generate a first resonance, the second radiator and the first element are configured to generate a first parasitic resonance, and the first direction is a thickness direction of the foldable electronic device.

According to this embodiment of this disclosure, the fourth slot is provided between the first coupling point and the second coupling point, and the first element is coupled (the first element may be configured to determine an equivalent capacitance value of the fourth slot), so that a radiation aperture of the second radiator can be increased. Because the radiation aperture of the second radiator is increased, strength of a single current strong point of the second radiator can be reduced, a current distribution is even, and a conductor loss and a dielectric loss caused by the second radiator, and a conductor and a medium that are disposed around the second radiator are reduced. In this way, total efficiency and radiation efficiency of the antenna are improved.

With reference to the first aspect, in some implementations of the first aspect, the antenna further includes a second element, the second radiator includes the third coupling point, a first end of the second element is coupled to the third coupling point, a second end of the second element is coupled to the ground plane, and the second radiator, the first element, and the second element are configured to generate the first parasitic resonance.

According to this embodiment of this disclosure, in the technical solution provided in this embodiment of this disclosure, the second radiator is coupled to the ground plane at the third coupling point via an element, so that a radiation aperture of the second radiator can be increased. Because the radiation aperture of the second radiator is increased, strength of a single current strong point of the second radiator can be reduced, a current distribution is even, and a conductor loss and a dielectric loss caused by the second radiator, and a conductor and a medium that are disposed around the second radiator are reduced. In this way, total efficiency and radiation efficiency of the antenna are improved.

With reference to the first aspect, in some implementations of the first aspect, a length of the second radiator between the third position and the fourth slot is less than a length of the second radiator between the third slot and the fourth slot.

According to this embodiment of this disclosure, because the second side frame is coupled to the ground plane at the third position, a current of the second radiator near the third position is strong, and a current of the second radiator near the fourth position is weak. When the fourth slot is provided in an area with a large current, an effect of reducing strength of a single current strong point of the second radiator is more obvious, and the current distribution on the second radiator is more even. Because the current distribution on the second radiator is more even, the conductor loss and the dielectric loss that are caused by the second radiator, and the conductor and the medium that are disposed around the second radiator are smaller. In an embodiment, the current distribution on the second radiator is more even, the radiation aperture of the second radiator is improved more significantly, and the effect of improving total efficiency and radiation efficiency of the antenna is better.

With reference to the first aspect, in some implementations of the first aspect, an equivalent inductance value of the second element is less than or equal to 10 nanohenries (nH).

With reference to the first aspect, in some implementations of the first aspect, the first coupling point is located between the third position and the fourth slot, and the second coupling point is located between the fourth position and the fourth slot; or the third coupling point is located between the third position and the first coupling point, and a distance between the first coupling point and the third coupling point is greater than or equal to 0 millimeters (mm) and less than or equal to 5 mm; or the third coupling point is located between the fourth position and the second coupling point, and a distance between the second coupling point and the third coupling point is greater than or equal to 0 mm and less than or equal to 5 mm.

According to this embodiment of this disclosure, when the distance between the third coupling point and the first coupling point is equal to 0 mm, the third coupling point overlaps the first coupling point. In an embodiment, the first end of the first element and the first end of the second element may be coupled to the first coupling point (the third coupling point) via a same connector.

The third coupling point may be located between the third position and the first coupling point, and the second element may be an inductor, and may further increase the radiation aperture of the second radiator. It should be understood that, when the third coupling point is located between the third position and the first coupling point, a relationship between the first element and the second element is similar to a series connection relationship.

In an embodiment, when the third coupling point is located between the third position and the first coupling point, the second element may be a capacitor that may be configured to reduce the radiation aperture of the second radiator. The radiation aperture of the second radiator is adjusted via both the first element and the second element, to achieve a parasitic resonance on an expected frequency band.

When the distance between the third coupling point and the second coupling point is equal to 0 mm, the third coupling point overlaps the second coupling point. In an embodiment, the second end of the first element and the first end of the second element may be coupled to the second coupling point (the third coupling point) via a same connector.

The third coupling point may be located between the fourth position and the second coupling point, and the second element may be a capacitor that may improve an equivalent capacitance between the first coupling point and the third coupling point. It should be understood that, when the third coupling point is located between the fourth position and the second coupling point, a relationship between the first element and the second element is similar to a parallel connection relationship. In an embodiment, when the equivalent capacitance value of the first element is 2 picofarads (pF), a loss is high, and the loss can be reduced via the second element in a case in which a same effect (for example, a same radiation aperture) is ensured (the equivalent capacitance value of the first element is 1 pF, an equivalent capacitance value of the second element is 1 pF, and an equivalent capacitance value between the first coupling point and the third coupling point is 2 pF), to improve the radiation characteristic of the antenna.

In an embodiment, when the third coupling point is located between the fourth position and the second coupling point, the second element may be an inductor that may be configured to reduce the radiation aperture of the second radiator. The radiation aperture of the second radiator is adjusted via both the first element and the second element, to achieve a parasitic resonance on an expected frequency band.

With reference to the first aspect, in some implementations of the first aspect, a width of the fourth slot is greater than or equal to 0.1 mm and less than or equal to 2 mm.

With reference to the first aspect, in some implementations of the first aspect, a distance between the first coupling point and the fourth slot is less than or equal to 5 mm, and/or a distance between the second coupling point and the fourth slot is less than or equal to 5 mm.

With reference to the first aspect, in some implementations of the first aspect, the first side frame is coupled to the ground plane at the first position, and the first side frame is provided with the second slot at the second position, where when the foldable electronic device is in a folded state, the second slot is aligned with the third slot or the fourth slot in the first direction.

With reference to the first aspect, in some implementations of the first aspect, an equivalent capacitance value of the first element is less than or equal to a first threshold; and when a resonance point frequency of the first parasitic resonance is less than or equal to 1 gigahertz (GHz), the first threshold is 10 pF; or when a resonance point frequency of the first parasitic resonance is greater than 1 GHz, the first threshold is 2 pF.

With reference to the first aspect, in some implementations of the first aspect, an electrical length of the second radiator is greater than three eighths of a first wavelength, and the first wavelength is a wavelength corresponding to the first parasitic resonance.

According to this embodiment of this disclosure, the first end of the second radiator is a ground end, and the second end is an open end. The first parasitic resonance of the second radiator may correspond to a quarter-wavelength mode. The second element and the fourth slot may make the electrical length of the second radiator greater than three eighths of the first wavelength. In this case, a current on the second radiator is codirectional (a reversal does not occur), and an electric field between the second radiator and the ground plane is not reversed. The electrical length of the second radiator increases from a quarter of the first wavelength to more than three eighths of the first wavelength, but the second radiator still operates in the quarter-wavelength mode. In this case, a current density on the second radiator 240 is dispersed, and a current density between the second radiator and the ground plane is reduced, so that a loss caused by the radiator, and a conductor and a medium that are disposed around the radiator is reduced, and the radiation characteristic of the antenna is further improved.

With reference to the first aspect, in some implementations of the first aspect, the length of the second radiator is greater than or equal to 0.8 times the length of the first radiator.

With reference to the first aspect, in some implementations of the first aspect, the length of the second radiator is greater than or equal to 1.5 times the length of the first radiator, and is less than or equal to 2.5 times the length of the first radiator.

With reference to the first aspect, in some implementations of the first aspect, a difference between the resonance point frequency of the first parasitic resonance and the resonance point frequency of the first resonance is less than or equal to 200 megahertz (MHz).

With reference to the first aspect, in some implementations of the first aspect, the first side frame is coupled to the ground plane at the first position, and the first side frame is provided with the second slot at the second position.

According to this embodiment of this disclosure, when one of a first end and a second end of the first radiator is a ground end, the other end is an open end, and a current on the first radiator is codirectional, it may be considered that the first radiator operates in the quarter-wavelength mode. A current at the ground end of the first radiator is strong, and an electric field at the open end of the first radiator is strong.

With reference to the first aspect, in some implementations of the first aspect, the first side frame includes a fifth position and a sixth position, the second position is located between the fifth position and the first position, the fifth position is located between the second position and the sixth position, the first side frame is coupled to the ground plane at the first position and the fifth position, and the first side frame is respectively provided with the second slot and a fifth slot at the second position and the sixth position; and the antenna includes a third radiator and a second feed circuit, where the third radiator is a conductive part, between the fifth position and the sixth position, of the first side frame, the third radiator includes the second feed point, and the second feed circuit is coupled to the second feed point.

With reference to the first aspect, in some implementations of the first aspect, the first side frame includes a fifth position and a sixth position, the second position is located between the fifth position and the first position, the fifth position is located between the second position and the sixth position, the first side frame is coupled to the ground plane at the first position and the fifth position, and the first side frame is respectively provided with the second slot and a fifth slot at the second position and the sixth position; and the antenna includes a third radiator and a second feed circuit, where the third radiator is a conductive part, between the second position and the sixth position, of the first side frame, the third radiator includes the second feed point, and the second feed circuit is coupled to the second feed point.

According to this embodiment of this disclosure, the first radiator and the first feed circuit may form a first antenna element. The third radiator and the second feed circuit may form a second antenna element. The second radiator may be used as a parasitic stub of both the first antenna element and the second antenna element, and is configured to improve radiation characteristics of the first antenna element and the second antenna element. In addition, because the first antenna element and the second antenna element may reuse the second radiator, an overall structure of the antenna can be miniaturized while the radiation characteristics of the first antenna element and the second antenna element are improved.

With reference to the first aspect, in some implementations of the first aspect, the antenna includes a third element; and the third radiator further includes a fourth coupling point, the second feed point is located between the fifth position and the sixth position, the fourth coupling point is located between the second position and the fifth position, a first end of the third element is coupled to the fourth coupling point, and a second end of the third element is coupled to the ground plane.

With reference to the first aspect, in some implementations of the first aspect, the foldable electronic device further includes a third housing, the third housing includes a third side frame, and at least a part of the third side frame and the ground plane are spaced apart, where the third side frame includes a fifth position and a sixth position, the third side frame is coupled to the ground plane at the fifth position or is provided with a fifth slot at the fifth position, and the third side frame is coupled to the ground plane at the sixth position or is provided with a sixth slot at the sixth position; the foldable electronic device further includes a second rotating shaft, where the second rotating shaft is located between the first housing and the third housing, and the second rotating shaft is rotatably connected to the first housing and the third housing separately; the antenna includes a third radiator and a second feed circuit, the third radiator is a conductive part, between the fifth position and the sixth position, of the first side frame, the third radiator includes the second feed point, and the second feed circuit is coupled to the second feed point; and when the foldable electronic device is in the folded state, the third radiator and the second radiator at least partially overlap in the first direction.

With reference to the first aspect, in some implementations of the first aspect, the first side frame is provided with the first slot at the first position, and the first side frame is provided with the second slot at the second position; the third side frame is coupled to the ground plane at the fifth position, and the third side frame is provided with the sixth slot at the sixth position; and the first side frame further includes a first ground point, the first ground point is located between the first position and the second position, and the first side frame is coupled to the ground plane at the first ground point.

With reference to the first aspect, in some implementations of the first aspect, the antenna includes a third element; and the first radiator further includes a fourth coupling point, the first feed point is located between the first ground point and the second position, the fourth coupling point is located between the first position and the first ground point, a first end of the third element is coupled to the fourth coupling point, and a second end of the third element is coupled to the ground plane.

With reference to the first aspect, in some implementations of the first aspect, the first side frame is provided with the first slot at the first position, and the first side frame is provided with the second slot at the second position; the third side frame is provided with the fifth slot at the fifth position, and the third side frame is provided with the sixth slot at the sixth position; the first side frame further includes a first ground point, the first ground point is located between the first position and the second position, and the first side frame is coupled to the ground plane at the first ground point; and the third side frame further includes a second ground point, the second ground point is located between the fifth position and the sixth position, and the third side frame is coupled to the ground plane at the ground point.

With reference to the first aspect, in some implementations of the first aspect, the antenna includes a first tuning component and a second tuning component; the third radiator further includes a fourth coupling point and a fifth coupling point, the fourth coupling point is located between the fifth position and the sixth position, and the fifth coupling point is located between the second position and the fifth position; and a first end of the first tuning component is coupled to the fourth coupling point, a second end of the first tuning component is coupled to the ground plane, a first end of the second tuning component is coupled to the fifth coupling point, and a second end of the second tuning component is coupled to the ground plane.

With reference to the first aspect, in some implementations of the first aspect, when the foldable electronic device is in the folded state, the first radiator and the third radiator at least partially overlap in the first direction.

With reference to the first aspect, in some implementations of the first aspect, when the foldable electronic device is in the folded state, the first radiator and the third radiator do not overlap in the first direction.

With reference to the first aspect, in some implementations of the first aspect, the third radiator is configured to generate a second resonance, and a difference between the resonance point frequency of the first parasitic resonance and a resonance point frequency of the second resonance is less than or equal to 200 MHz.

With reference to the first aspect, in some implementations of the first aspect, the third radiator is configured to generate the second resonance, and a resonance frequency band of the first resonance and a resonance frequency band of the second resonance have the same frequency or are adjacent.

With reference to the first aspect, in some implementations of the first aspect, the foldable electronic device further includes a third housing, the third housing includes a third side frame, and at least a part of the third side frame and the ground plane are spaced apart, where the third side frame includes a fifth position and a sixth position, the third side frame is coupled to the ground plane at the fifth position, and the third side frame is provided with a fifth slot at the sixth position; the foldable electronic device further includes a second rotating shaft, where the second rotating shaft is located between the second housing and the third housing, and the second rotating shaft is rotatably connected to the first housing and the third housing separately; the antenna includes the third radiator, the third radiator is a conductive part, between the fifth position and the sixth position, of the third side frame; and when the foldable electronic device is in the folded state, the third radiator and the first radiator at least partially overlap in the first direction.

According to this embodiment of this disclosure, the second radiator and the third radiator that are used as parasitic stubs are respectively located on different housings, and at least partially overlap the first radiator that is used as a main radiation stub in the first direction, to generate a resonance through indirect coupling.

With reference to the first aspect, in some implementations of the first aspect, the antenna includes a fourth element; and the third radiator further includes a fifth coupling point and a sixth coupling point, the third radiator is provided with a sixth slot between the fifth coupling point and the sixth coupling point, a first end of the fourth element is coupled to the fifth coupling point, and a second end of the fourth element is coupled to the sixth coupling point.

With reference to the first aspect, in some implementations of the first aspect, the second side frame includes a fifth position and a sixth position, the fourth position is between the fifth position and the third position, the fifth position is between the fourth position and the sixth position, the second side frame is coupled to the ground plane at the fifth position, and the second side frame is provided with a sixth slot at the sixth position; the antenna includes a third radiator and a fourth element, where the third radiator is a conductive part, between the fifth position and the sixth position, of the second side frame, the third radiator and the first radiator do not overlap in the first direction, the second radiator includes a seventh coupling point, the third radiator includes an eighth coupling point, a first end of the fourth element is coupled to the seventh coupling point, and a second end of the fourth element is coupled to the eighth coupling point.

According to this embodiment of this disclosure, the second radiator and the third radiator are separately located on a same housing, and the second radiator generates a resonance through indirect coupling. The third radiator is coupled to the seventh coupling point of the second radiator through the eighth coupling point, and is indirectly coupled to the second radiator, to generate a resonance.

According to a second aspect, a foldable electronic device is provided, including: a first housing, a second housing, and a ground plane, where the first housing includes a first side frame, the second housing includes a second side frame, at least a part of the first side frame and the ground plane are spaced apart, and at least a part of the second side frame and the ground plane are spaced apart; the first side frame includes a first position and a second position, the first side frame is coupled to the ground plane at the first position or is provided with a first slot at the first position, the first side frame is coupled to the ground plane at the second position or is provided with a second slot at the second position; and the second side frame includes a third position, a fourth position, and a fifth position, the fifth position is located between the third position and the fourth position, the second side frame is coupled to the ground plane at the third position and the fourth position, and the second side frame is provided with a third slot at the fifth position; a first rotating shaft, where the first rotating shaft is located between the first housing and the second housing, and the first rotating shaft is rotatably connected to the first housing and the second housing separately; and an antenna, where the antenna includes: a first radiator and a first feed circuit, where the first radiator is a conductive part, between the first position and the second position, of the first side frame, the first radiator includes a first feed point, and the first feed circuit is coupled to the first feed point; and a second radiator, a first element, and a second element, where the second radiator is a conductive part, between the third position and the fourth position, of the second side frame, and a length of the second radiator is less than or equal to three times a length of the first radiator; the second radiator includes a first coupling point, a second coupling point, a third coupling point, and a fourth coupling point, where the first coupling point and the second coupling point are located between the third position and the fifth position, the third coupling point and the fourth coupling point are located between the fourth position and the fifth position, the second radiator is provided with a fourth slot between the first coupling point and the second coupling point, the second radiator is provided with a fifth slot between the third coupling point and the fourth coupling point, a first end of the first element is coupled to the first coupling point, a second end of the first element is coupled to the second coupling point, a first end of the second element is coupled to the third coupling point, and a second end of the second element is coupled to the fourth coupling point; and when the foldable electronic device is in a folded state, the first radiator and the second radiator at least partially overlap in a first direction, the first radiator is configured to generate a first resonance, the second radiator, the first element, and the second element are configured to generate a first parasitic resonance, a difference between the resonance point frequency of the first parasitic resonance and the resonance point frequency of the first resonance is less than or equal to 200 MHZ, and the first direction is a thickness direction of the foldable electronic device.

According to a third aspect, a foldable electronic device is provided, including: a first housing, a second housing, and a ground plane, where the first housing includes a first side frame, the second housing includes a second side frame, at least a part of the first side frame and the ground plane are spaced apart, and at least a part of the second side frame and the ground plane are spaced apart; the first side frame includes a first position and a second position, the first side frame is coupled to the ground plane at the first position or is provided with a first slot at the first position, the first side frame is coupled to the ground plane at the second position or is provided with a second slot at the second position; and the second side frame includes a third position, a fourth position, and a fifth position, the fifth position is located between the third position and the fourth position, the second side frame is respectively provided with a third slot and a fourth slot at the third position and the fourth position, and the second side frame is coupled to the ground plane at the fifth position; a first rotating shaft, where the first rotating shaft is located between the first housing and the second housing, and the first rotating shaft is rotatably connected to the first housing and the second housing separately; and an antenna, where the antenna includes: a first radiator and a first feed circuit, where the first radiator is a conductive part, between the first position and the second position, of the first side frame, the first radiator includes a first feed point, and the first feed circuit is coupled to the first feed point; and a second radiator, a first element, and a second element, where the second radiator is a conductive part, between the third position and the fourth position, of the second side frame, a length of the second radiator is greater than or equal to a length of the first radiator, and is less than or equal to three times the length of the first radiator; the second radiator includes a first coupling point, a second coupling point, a third coupling point, and a fourth coupling point, where the first coupling point and the second coupling point are located between the third position and the fifth position, the third coupling point and the fourth coupling point are located between the fourth position and the fifth position, the second radiator is provided with a fifth slot between the first coupling point and the second coupling point, the second radiator is provided with a sixth slot between the third coupling point and the fourth coupling point, a first end of the first element is coupled to the first coupling point, a second end of the first element is coupled to the second coupling point, a first end of the second element is coupled to the third coupling point, and a second end of the second element is coupled to the fourth coupling point; and when the foldable electronic device is in a folded state, the first radiator and the second radiator at least partially overlap in a first direction, the first radiator is configured to generate a first resonance, the second radiator, the first element, and the second element are configured to generate a first parasitic resonance, a difference between the resonance point frequency of the first parasitic resonance and the resonance point frequency of the first resonance is less than or equal to 200 MHZ, and the first direction is a thickness direction of the foldable electronic device.

### BRIEF DESCRIPTION OF DRAWINGS

FIG. 1 is a diagram of a structure of a foldable electronic device 100 according to an embodiment of this disclosure;

FIG. 2 is a diagram of a structure of a foldable electronic device 100 in an outward-folded state;

FIG. 3 is a diagram of a structure of a foldable electronic device 100 in a possible unfolded state;

FIG. 4 is a diagram of a structure of a foldable electronic device 100 in a possible folded state;

FIG. 5 is a diagram of a structure of a foldable electronic device 100 in a possible partially-unfolded state;

FIGS. 6A-6B show diagrams of a structure in a wire common mode and distribution of corresponding currents and electric fields according to this disclosure;

FIGS. 7A-7B show diagrams of a structure in a wire differential mode and distribution of corresponding currents and electric fields according to this disclosure;

FIGS. 8A-8B show diagrams of a structure in a slot common mode and distribution of corresponding currents, electric fields, and magnetic currents according to this disclosure;

FIGS. 9A-9B show diagrams of a structure in a slot differential mode and distribution of corresponding currents, electric fields, and magnetic currents according to this disclosure;

FIG. 10 is a diagram of a foldable electronic device 100 according to an embodiment of this disclosure;

FIG. 11 is a diagram of a foldable electronic device 100 according to an embodiment of this disclosure;

FIGS. 12A-12C show a diagram of a distributed component according to an embodiment of this disclosure;

FIG. 13 is a diagram of another foldable electronic device 100 according to an embodiment of this disclosure;

FIG. 14 is a diagram of S parameter simulation results of antennas shown in FIG. 11 and FIG. 13;

FIG. 15 shows simulation results of radiation efficiency and total efficiency of antennas shown in FIG. 11 and FIG. 13;

FIG. 16 is a diagram of a foldable electronic device 100 according to an embodiment of this disclosure;

FIG. 17 is a diagram of a foldable electronic device 100 according to an embodiment of this disclosure;

FIG. 18 is a diagram of an S parameter simulation result of an antenna shown in FIG. 17;

FIG. 19 shows simulation results of radiation efficiency and total efficiency of a first antenna element in an antenna shown in FIG. 17;

FIG. 20 shows simulation results of radiation efficiency and total efficiency of a second antenna element in an antenna shown in FIG. 17;

FIG. 21 is a diagram of a foldable electronic device 100 according to an embodiment of this disclosure;

FIG. 22 is a diagram of an S parameter simulation result of an antenna shown in FIG. 21;

FIG. 23 shows simulation results of radiation efficiency and total efficiency of a first antenna element in an antenna shown in FIG. 21;

FIG. 24 shows simulation results of radiation efficiency and total efficiency of a second antenna element in an antenna shown in FIG. 21;

FIG. 25 is a diagram of a foldable electronic device 100 according to an embodiment of this disclosure;

FIG. 26 is a diagram of a foldable electronic device 100 according to an embodiment of this disclosure;

FIG. 27 is a diagram of an S parameter simulation result of an antenna shown in FIG. 25;

FIG. 28 shows simulation results of radiation efficiency and total efficiency of a first antenna element in an antenna shown in FIG. 25;

FIG. 29 shows simulation results of radiation efficiency and total efficiency of a second antenna element in an antenna shown in FIG. 25;

FIG. 30 is a diagram of a foldable electronic device 100 according to an embodiment of this disclosure;

FIG. 31 is a diagram of an S parameter simulation result of an antenna shown in FIG. 30;

FIG. 32 shows simulation results of radiation efficiency and total efficiency of a first antenna element in an antenna shown in FIG. 30;

FIG. 33 shows simulation results of radiation efficiency and total efficiency of a second antenna element in an antenna shown in FIG. 30;

FIG. 34 is a diagram of a foldable electronic device 100 according to an embodiment of this disclosure;

FIG. 35 is a diagram of an S parameter simulation result of an antenna shown in FIG. 34;

FIG. 36 shows simulation results of radiation efficiency and total efficiency of a first antenna element in an antenna shown in FIG. 34;

FIG. 37 shows simulation results of radiation efficiency and total efficiency of a second antenna element in an antenna shown in FIG. 34;

FIG. 38 is a diagram of a foldable electronic device 100 according to an embodiment of this disclosure;

FIG. 39 is a diagram of an S parameter simulation result of an antenna shown in FIG. 38;

FIG. 40 shows simulation results of radiation efficiency and total efficiency of a first antenna element in an antenna shown in FIG. 38;

FIG. 41 shows simulation results of radiation efficiency and total efficiency of a second antenna element in an antenna shown in FIG. 38;

FIG. 42 is a diagram of a foldable electronic device 100 according to an embodiment of this disclosure;

FIG. 43 is a diagram of a foldable electronic device 100 according to an embodiment of this disclosure;

FIG. 44 is a diagram of a foldable electronic device 100 according to an embodiment of this disclosure;

FIG. 45 is a diagram of a foldable electronic device 100 according to an embodiment of this disclosure;

FIG. 46 is a diagram of a foldable electronic device 100 according to an embodiment of this disclosure;

FIG. 47 is a diagram of a foldable electronic device 100 according to an embodiment of this disclosure;

FIG. 48 is a diagram of an S parameter simulation result of an antenna shown in FIG. 47;

FIG. 49 shows simulation results of radiation efficiency and total efficiency of the antenna shown in FIG. 47.

FIG. 50 is a diagram of a foldable electronic device 100 according to an embodiment of this disclosure;

FIG. 51 is a diagram of a foldable electronic device 100 according to an embodiment of this disclosure; and

FIG. 52 is a diagram of a foldable electronic device 100 according to an embodiment of this disclosure.

### DESCRIPTION OF EMBODIMENTS

The following describes possible terms in embodiments of this disclosure.

It should be understood that the term “and/or” in this specification is merely a same field for describing associated objects, and represents that three relationships may exist. For example, A and/or B may represent the following three cases: Only A exists, both A and B exist, and only B exists. In addition, the character “/” in this specification generally indicates an “or” relationship between the associated objects.

In this disclosure, “within a range of . . . ” is used, except when it is separately indicated that no end value is included, end values at both ends of the range are included by default. For example, within a range from 1 to 5, two values 1 and 5 are included.

Coupling: The coupling may be understood as direct coupling and/or indirect coupling, and a “coupling connection” or “coupling” may be understood as a direct coupling connection and/or an indirect coupling connection. The direct coupling may also be referred to as an “electrical connection”, which may be understood as physical contact and electrical conduction of components, or may be understood as a form of connection between different components in a line structure through a physical line that can transmit an electrical signal, like a printed circuit board (PCB) copper foil, or a conducting wire. The “indirect coupling” may be understood as electrical conduction of two conductors in a spaced/non-contact manner. In an embodiment, the indirect coupling may also be referred to as capacitive coupling. For example, signal transmission is implemented by forming an equivalent capacitor through coupling in a slot between two spaced conductive members.

Element/component: The element/component includes at least one of a lumped element/component, and a distributed element/component.

Lumped element/component: The lumped element/component is a general name of all elements whose sizes are far less than a wavelength corresponding to an operating frequency of a circuit. For a signal, a characteristic of the element is always fixed at any time, regardless of a frequency. The lumped element/component may include a lumped capacitor, a lumped inductor, and the like.

Distributed element/component: A difference between the distributed element/component and the lumped element lies in that when a signal passes through an element, a characteristic of each point of the element varies with a change of the signal. In this case, the element cannot be considered as a single body with a fixed characteristic, but should be referred to as a distributed element. The distributed element/component may include a distributed capacitor, a distributed inductor, and the like.

Capacitor: The capacitor may be understood as a lumped capacitor and/or a distributed capacitor. The lumped capacitor includes a capacitive component, for example, a capacitive element. The distributed capacitor (or a distributed type capacitor) is an equivalent capacitor formed by two conductive members that are spaced by a specific slot.

Inductor: The inductor may be understood as a lumped inductor and/or a distributed inductor. The lumped inductor includes an inductive component, for example, an inductive element. The distributed inductor (or a distributed type inductor) is an equivalent inductor formed by a conductive member of a specific length.

Radiator: The radiator is an apparatus configured to receive/send electromagnetic wave radiation in an antenna. In some cases, an “antenna” is a radiator in a narrow sense. The radiator converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator through a feed line. The radiator converts the energy into specific polarized electromagnetic wave energy and transmits the energy in a desired direction. A receive radiator converts specific polarized electromagnetic wave energy from a specific direction of space into modulated high-frequency current energy, and transmits the modulated high-frequency current energy to an input end of a receiver through a feed line.

The radiator may include a conductor having a specific shape and size, for example, a linear radiator or a sheet-like radiator. A specific shape is not limited in this disclosure. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a bracketed conductor, and may also be referred to as a bracketed antenna. In an embodiment, a wire diameter (for example, including a thickness and a width) of the linear radiator or a radiator of the wire antenna is much less than a wavelength (for example, a dielectric wavelength) (for example, is less than 1/16 of the wavelength), and a length may be compared to the wavelength (for example, the dielectric wavelength) (for example, the length is near ⅛ of the wavelength, or ⅛ to ¼ of the wavelength, or ¼ to ½ of the wavelength, or greater). Main forms of the wire antenna include a dipole antenna, a half-wave dipole antenna, a monopole antenna, a loop antenna, and an inverted F antenna (IFA). For example, for the dipole antenna, each dipole antenna usually includes two radiation stubs, and each stub is fed by a feed part from a feed end of the radiation stub. For example, the IFA may be considered as being obtained by adding a ground path to a monopole antenna. The IFA antenna has a feed point and a ground point. A side view of the IFA antenna is inverted F-shaped, and therefore, the IFA antenna is referred to as an inverted F antenna. In an embodiment, the sheet-like radiator may include a microstrip antenna, or a patch antenna, for example, a planar inverted F antenna (PIFA). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. A shape of the sheet-like radiator includes a circular shape, a rectangular shape, a ring shape, and the like. A specific shape is not limited in this disclosure. A structure of the microstrip antenna generally includes a dielectric substrate, a radiator, and a ground plane, where the dielectric substrate is disposed between the radiator and the ground plane.

The radiator may also include a slot or a slit formed on a conductor, for example, a closed or semi-closed slot or slit formed on a grounded conductor surface. In an embodiment, a radiator with a slot or slit may be referred to as a slot antenna or a slotted antenna for short. In an embodiment, a radial size (for example, including a width) of the slot or slit of the slot antenna/slotted antenna is much less than a wavelength (for example, a dielectric wavelength) (for example, is less than 1/16 of the wavelength), and a length size may be compared to the wavelength (for example, the dielectric wavelength) (for example, the length size is near ⅛ of the wavelength, or ⅛ to ¼ of the wavelength, or ¼ to ½ of the wavelength, or greater). In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, the slot is long strip-shaped. In some embodiments, a length of the slot is approximately half the wavelength (for example, the dielectric wavelength). In some embodiments, a length of the slot is approximately an integer multiple of the wavelength (for example, a one-time dielectric wavelength). In some embodiments, the slot may be used for feeding by using a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground plane and is grounded at two ends of the radiator, to form a closed or semi-closed slot or slit. In an embodiment, the radiator of the slot antenna or the slotted antenna may be implemented by a bracketed conductor that is grounded at both ends, and may also be referred to as a bracketed antenna.

A feed circuit/feed structure is a combination of all components of an antenna for receiving and transmitting radio frequency waves. In a receive antenna, the feed circuit may be considered as an antenna part from a first amplifier to a front-end transmitter. In a transmit antenna, the feed circuit may be considered as a part after the last power amplifier. In some cases, a “feed circuit” is understood in a narrow sense as a radio frequency chip, or a “feed circuit” includes a transmission path from a radio frequency chip to a radiator or a feed point on a transmission line. The feed circuit has a function of converting a radio wave into an electrical signal and sending the electrical signal to a receiver component. Usually, the feed circuit is considered as a part of the antenna, and is configured to convert a radio wave into an electrical signal, and vice versa. When the antenna is designed, maximum power transmission possibility and efficiency should be considered. Therefore, a feed impedance of the antenna shall match a load resistance. The feed impedance of the antenna is a combination of a resistance, a capacitance, and an inductance. To ensure a maximum power transmission condition, two impedances (the load resistance and the feed impedance) should match. The matching can be completed by considering a frequency requirement and a design parameter (for example, a gain, directivity, and radiation efficiency) of the antenna.

End/point: The “end/point” in a first end/second end/feed end/ground end/feed point/ground point/coupling point of an antenna radiator cannot be understood in a narrow sense as an endpoint or an end part that is physically disconnected from another radiator, and may also be considered as a point or a section on a continuous radiator. In an embodiment, the “end/point” may include a connection/coupling area that is on the antenna radiator and that is coupled to another conductive structure. For example, the feed end/feed point may be a coupling area (for example, an area opposite to a part of the feed circuit) that is on the antenna radiator and that is coupled to the feed structure or the feed circuit. For another example, the ground end/ground point may be a connection/coupling area that is on the antenna radiator and that is coupled to a ground structure or a ground circuit.

Open end and closed end: In some embodiments, the open end and closed end are defined based on grounding, for example, the closed end is grounded, and the open end is not grounded. In some embodiments, the open end and the closed end are defined based on another conductor, for example, the closed end is electrically connected to the another conductor, and the open end is not electrically connected to the another conductor. In an embodiment, the open end may also be referred to as a floating end, a free end, an opening end or an open-circuit end. In an embodiment, the closed end may also be referred to as a ground end or a short-circuit end. It should be understood that, in some embodiments, another conductor may be coupled through the open end, to transfer coupling energy (which may be understood as transferring a current).

In some embodiments, the “closed end” may also be understood from a perspective of current distribution. The closed end, the ground end, or the like may be understood as a current strong point on a radiator, or may be understood as an electric field weak point on a radiator. In an embodiment, the closed end is coupled to an electronic component (for example, a capacitor or an inductor), so that a current distribution characteristic of a current strong point/an electric field weak point of the radiator may not be changed. In an embodiment, a slit (for example, a slot filled with an insulation material) at or near the closed end may not change a current distribution characteristic of a current strong point/an electric field weak point of the radiator at the slit.

In some embodiments, the “open end” may also be understood from a perspective of current distribution. The open end, the floating end, or the like may be understood as a current weak point on a radiator, or may be understood as an electric field strong point on a radiator. In an embodiment, the open end is coupled to an electronic component (for example, a capacitor or an inductor), so that a current distribution characteristic of a current weak point/an electric field strong point of the electronic component may not be changed.

It should be understood that a radiator end (similar to a radiator at an opening of the open end or the floating end from a perspective of a radiator structure) in a slot is coupled to the electronic component (for example, the capacitor or the inductor), so that the radiator end is a current strong point/an electric field weak point. In this case, it should be understood that the radiator end in the slot is actually a closed end, a ground end, or the like.

Resonance/resonance frequency: The resonance frequency is also called a resonant frequency. The resonance frequency may be a frequency at which an imaginary part of an input impedance of an antenna is zero. The resonance frequency may have a frequency range, namely, a frequency range in which a resonance occurs. A frequency corresponding to a strongest resonance point is a center frequency. A return loss of the center frequency may be less than −20 decibels (dB). It should be understood that, unless otherwise specified, in the “generating a first resonance” of the antenna/radiator mentioned in this disclosure, the first resonance should be a basic mode resonance generated by the antenna/radiator, or a resonance with a lowest frequency generated by the antenna/radiator.

Resonance frequency band/communication frequency band/operating frequency band: Regardless of a type of antenna, the antenna always operates in a specific frequency range (a frequency band width). For example, an operating frequency band of an antenna supporting a B40 frequency band includes a frequency in a range of 2300 MHz to 2400 MHZ. In other words, an operating frequency band of the antenna includes a B40 frequency band. A frequency range that meets a requirement of an indicator may be considered as an operating frequency band of the antenna.

Electrical length: The electrical length may be a ratio of a physical length (namely, a mechanical length or a geometric length) to a wavelength of a transmitted electromagnetic wave, and the electrical length may meet the following formula:

$$\overline{L} = \frac{L}{λ} ,$$

where L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz, the operating wavelength may be a wavelength calculated by using the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (Air wavelength or vacuum wavelength)=Speed of light/Frequency, where the frequency is a frequency (MHz) of the radiation signal, and the speed of light may be 3×10⁸ m/s. A wavelength of a radiated signal in a medium may be calculated as follows: Dielectric wavelength-(Speed of light/\sqrt{ε})/Frequency, where ε is a relative dielectric constant of the medium. The wavelength in embodiments of this disclosure is usually a dielectric wavelength, and may be a dielectric wavelength corresponding to the center frequency of the resonance frequency, or a dielectric wavelength corresponding to the center frequency of the operating frequency band supported by the antenna. For example, it is assumed that a center frequency of a B1 uplink frequency band (with a resonance frequency ranging from 1920 MHz to 1980 MHz) is 1955 MHz, the wavelength may be a dielectric wavelength calculated by using the frequency of 1955 MHz. The “dielectric wavelength” is not limited to the center frequency, and may alternatively be a dielectric wavelength corresponding to the non-center frequency of the resonance frequency or the operating frequency band. For ease of understanding, the dielectric wavelength mentioned in embodiments of this disclosure may be simply calculated by using a relative dielectric constant of the medium filled on one or more sides of the radiator.

Total efficiency of an antenna: The total efficiency of the antenna is a ratio of input power to output power at an antenna port.

Radiation efficiency of an antenna: The radiation efficiency of the antenna is a ratio of power radiated by the antenna to space (namely, power for effectively converting an electromagnetic wave) to active power input to the antenna. Active power input to the antenna=Input power of the antenna-Loss power. The loss power mainly includes return loss power and metal ohmic loss power and/or dielectric loss power. The radiation efficiency is a value for measuring a radiation capability of an antenna. Both a metal loss and a dielectric loss are factors that affect the radiation efficiency.

A person skilled in the art may understand that the efficiency is usually indicated by a percentage, and there is a corresponding conversion relationship between the efficiency and dB. Efficiency closer to 0 dB indicates better antenna efficiency.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter indicates transmit efficiency of the antenna. The S11 parameter is usually a negative number. A smaller S11 parameter indicates a smaller return loss of the antenna, less energy reflected back by the antenna, namely, more energy that actually enters the antenna, and higher total efficiency of the antenna. A larger S11 parameter indicates a larger antenna return loss and lower total efficiency of the antenna.

It should be noted that, −6 dB is usually used as a standard value of S11 in engineering. When the value of S11 of the antenna is less than −6 dB, it may be considered that the antenna can operate normally, or it may be considered that transmit efficiency of the antenna is good.

It should be understood that, as mentioned in embodiments of this disclosure, that a first resonance and a second resonance have a same resonance frequency band (also referred to as having the same frequency) (for example, S11<−4 dB) may be understood as any one of the following cases.

The resonance frequency band of the first resonance and the resonance frequency band of the second resonance include a same communication frequency band. In an embodiment, the resonance frequency band of the first resonance and the resonance frequency band of the second resonance may be applied to a multi-input multi-output (MIMO) antenna system. For example, if the resonance frequency band of the first resonance and the resonance frequency band of the second resonance each include a sub-6th generation (6G) frequency band in 5th generation (5G), it may be considered that the resonance frequency band of the first resonance and the resonance frequency band of the second resonance have the same frequency.

The resonance frequency band of the first resonance and the resonance frequency band of the second resonance at least partially overlap. For example, the resonance frequency band of the first resonance includes a B35 frequency band (1.85 GHz to 1.91 GHZ) in Long-Term Evolution (LTE), the resonance frequency band of the second resonance includes a B39 frequency band (1.88 GHz to 1.92 GHZ) in LTE, and a frequency of the resonance frequency band of the first resonance and a frequency of the resonance frequency band of the second resonance partially overlap. In this case, it may be considered that the first resonance and the second resonance have the same frequency.

It should be understood that, as mentioned in embodiments of this disclosure, that the operating frequency bands of the first resonance and the second resonance are adjacent may be understood as follows.

In the resonance frequency band of the first resonance and the resonance frequency band of the second resonance, a spacing between a start frequency of a higher frequency band and an end frequency of a lower frequency band is less than 10% of a center frequency of the higher frequency band. For example, if the resonance frequency band of the first resonance includes a B3 frequency band (1.71 GHz to 1.785 GHZ) in LTE, and the resonance frequency band of the second resonance includes a LI frequency band (1578.42 MHz+1.023 MHz) in Global Positioning System (GPS), and the B3 frequency band (1.71 GHz to 1.785 GHZ) and the LI frequency band (1578.42 MHz+1.023 MHz) are adjacent frequency bands, it may be considered that the resonance frequency band of the first resonance and the resonance frequency band of the second resonance are adjacent frequency bands. Alternatively, for example, if the resonance frequency band of the first resonance includes a B40 frequency band (2.3 GHz to 2.4 GHZ) in LTE, and the resonance frequency band of the second resonance includes a Bluetooth (BT) frequency band (2.4 GHz to 2.485 GHZ), and the B40 frequency band (2.3 GHZ to 2.4 GHZ) and the BT frequency band (2.4 GHz to 2.485 GHZ) are adjacent frequency bands, it may be considered that the resonance frequency band of the first resonance and the resonance frequency band of the second resonance are adjacent frequency bands.

Ground (Ground plane) (GND): The ground may generally mean at least a part of any grounding plane, grounding plate, ground metal layer, or the like in an electronic device (like a mobile phone), or at least a part of any combination of the foregoing grounding plane, grounding plate, ground component, or the like. The “ground” may be configured to ground components in the electronic device. In an embodiment, the “ground” may be a grounding plane of a circuit board of the electronic device, or may be a grounding plate formed by a middle frame of the electronic device or a ground metal layer formed by a metal film below a screen of the electronic device. In an embodiment, the circuit board may be a PCB, for example, an 8-layer board, a 10-layer board, a 12-layer board, a 13-layer board, or a 14-layer board respectively having 8, 10, 12, 13, or 14 layers of conductive materials, or an element that is separated and electrically insulated by a dielectric layer or an insulation layer, for example, glass fiber, polymer, or the like. In an embodiment, the circuit board includes a dielectric substrate, a grounding plane, and a wiring layer. The wiring layer and the grounding plane are electrically connected through a via hole. In an embodiment, components such as a display, a touchscreen, an input button, a transmitter, a processor, a memory, a battery, a charging circuit, and a system on chip (SoC) structure may be installed on or connected to the circuit board, or electrically connected to the wiring layer and/or the grounding plane in the circuit board. For example, a radio frequency source is disposed at the wiring layer.

Any of the foregoing grounding plane, or grounding plate, or ground metal layer is made of a conductive material. In an embodiment, the conductive material may be any one of the following materials: copper, aluminum, stainless steel, brass and alloys thereof, copper foil on an insulation laminate, aluminum foil on an insulation laminate, gold foil on an insulation laminate, silver-plated copper, silver-plated copper foil on an insulation laminate, silver foil on an insulation laminate and tin-plated copper, cloth impregnated with graphite powder, a graphite-coated laminate, a copper-plated laminate, a brass-plated laminate and an aluminum-plated laminate. A person skilled in the art may understand that the grounding plane/grounding plate/ground metal layer may alternatively be made of another conductive material.

Grounding: The grounding refers to coupling to the ground/ground plane in any manner. In an embodiment, the grounding may be grounding by using an entity, for example, grounding by using an entity (or referred to as entity grounding) at a specific position on the side frame is implemented by using some mechanical parts of the middle frame. In an embodiment, the grounding may be grounding by using a component, for example, grounding by using a component (or referred to as component grounding) like a capacitor/inductor/resistor connected in series or in parallel.

The following describes technical solutions of embodiments in this disclosure with reference to accompanying drawings.

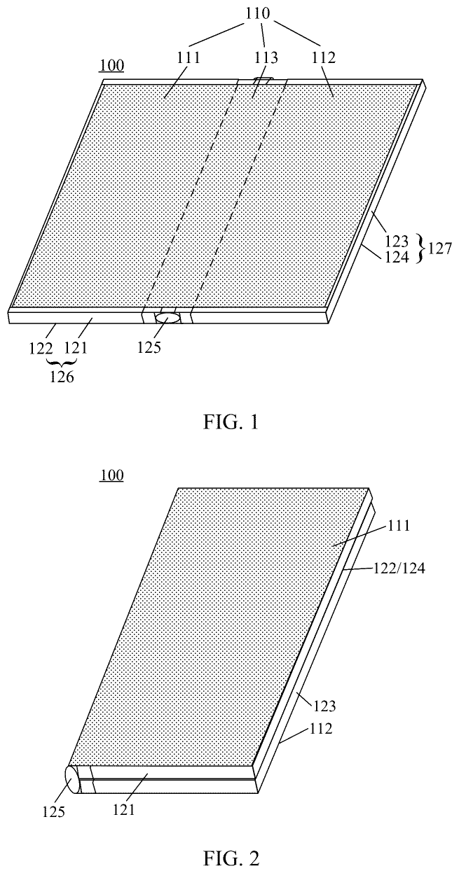

FIG. 1 is a diagram of a structure of a foldable electronic device 100 according to an embodiment of this disclosure. The foldable electronic device 100 may be an electronic device with a folding function, for example, a mobile phone, a tablet computer, an e-reader, a notebook computer, or a wearable device like a watch. The embodiment shown in FIG. 1 is described by using a foldable mobile phone as an example.

Refer to FIG. 1. The foldable electronic device 100 may include a flexible display 110, a first side frame 121, a first cover body 122, a second side frame 123, a second cover body 124, and a rotating shaft 125. In some embodiments, the first side frame 121, the first cover body 122, the second side frame 123, and the second cover body 124 may form a first housing 126 and a second housing 127 that support the flexible display 110. In some other embodiments, at least one of the first cover body 122 and the second cover body 124 may include a display.

A lattice pattern filled in FIG. 1 may schematically represent the flexible display 110. The flexible display 110 may have features of strong flexibility and bendability, and may provide a user with a new bendability-based interaction mode. A display panel of the flexible display 110 may be a liquid-crystal display (LCD), an organic light-emitting diode (OLED), an active-matrix organic light-emitting diode (AMOLED), a flexible light-emitting diode (FLED), a quantum-dot light-emitting diode (QLED), or the like. This is not limited in embodiments of this disclosure.

The flexible display 110 may include a first display part 111 corresponding to the first housing 126, a second display part 112 corresponding to the second housing 127, and a foldable display part 113 corresponding to the rotating shaft 125. The foldable display part 113 may be connected between the first display part 111 and the second display part 112.

The first side frame 121 may surround a periphery of the first cover body 122, and at least a part of the first side frame 121 may further surround a periphery of the first display part 111. The first display part 111 and the first cover body 122 may be spaced apart in parallel, and the first display part 111 and the first cover body 122 may be located on two sides of the first side frame 121. Space between the first display part 111 and the first cover body 122 may be used to dispose a component of the foldable electronic device 100, for example, an antenna or a circuit board component.

The second side frame 123 may surround a periphery of the second cover body 124, and at least a part of the second side frame 123 may further surround a periphery of the second display part 112. The second display part 112 and the second cover body 124 may be spaced apart in parallel, and the second display part 112 and the second cover body 124 may be located on two sides of the second side frame 123. Space between the second display part 112 and the second cover body 124 may be used to dispose a component of the foldable electronic device 100, for example, an antenna or a circuit board component.

In an embodiment provided in this disclosure, the cover body and the side frame may be two parts of the housing of the foldable electronic device 100. The cover body and the side frame may be connected, and a form of the connection may not belong to an assembly manner such as clamping, bonding, welding, riveting, or clearance fit. A connection relationship between the cover body and the side frame is usually difficult to be divided. In another embodiment provided in this disclosure, the cover body and the side frame may be two different parts. The housing of the foldable electronic device 100 may be formed by assembling the cover body and the side frame.

At least a part of the side frame may serve as a radiator of an antenna to transmit/receive a radio frequency signal, and there may be a slot between the part of the side frame that serves as the radiator and another part of the cover body, to ensure that the radiator of the antenna has a good radiation environment. In an embodiment, the cover body may be provided with a gap at the part of the side frame that serves as the radiator, to facilitate radiation of the antenna.

The antenna of the electronic device 100 may be further disposed in the side frame. When the side frame of the electronic device 100 is made of a non-conductive material, the radiator of the antenna may be located in the electronic device 100 and disposed along the side frame. For example, the radiator of the antenna is disposed close to the side frame, to reduce a volume occupied by the radiator of the antenna as much as possible, and be closer to the outside of the electronic device 100, so as to implement better signal transmission effect. It should be noted that, that the radiator of the antenna is disposed close to the side frame means that the radiator of the antenna may be disposed in close contact with the side frame, or may be disposed close to the side frame. For example, there may be a specific small slot between the radiator of the antenna and the side frame.

The antenna of the electronic device 100 may be further disposed in the housing, for example, a bracketed antenna or a millimeter-wave antenna (not shown in FIG. 1). Clearance of the antenna disposed in the housing may be obtained by using a slit/hole in any one of the cover body, and/or the side frame, and/or the display, or by using a non-conductive slot/aperture formed between any several of the cover body, and/or the side frame, and/or the display. The clearance of the antenna may be provided, to ensure radiation performance of the antenna. It should be understood that the clearance of the antenna may be a non-conductive area formed by any conductive component in the electronic device 100, and the antenna radiates a signal to external space through the non-conductive area. In an embodiment, a form of the antenna may be an antenna form based on a flexible mainboard (FPC), an antenna form based on laser-direct-structuring (LDS), or an antenna form like a microstrip disk antenna (MDA). In an embodiment, the antenna may alternatively use a transparent structure embedded into a display of the electronic device 100, so that the antenna is a transparent antenna element embedded into the display of the electronic device 100.

The foldable electronic device 100 may further include a PCB (not shown in the figure). The PCB is disposed in a cavity formed by the cover body. The PCB may be a flame-resistant material (FR-4) dielectric board, or may be a Rogers dielectric board, or may be a hybrid dielectric board of Rogers and FR-4, or the like. Herein, FR-4 is a grade designation for a flame-resistant material, and the Rogers dielectric board is a high-frequency board. An element, for example, a radio frequency chip, is carried on the PCB 17. In an embodiment, a metal layer may be disposed on the PCB. The metal layer may be configured to ground an element carried on the PCB, or may be configured to ground another element, for example, a bracketed antenna or a side frame antenna. The metal layer may be referred to as a ground plane, a grounding plate, or a grounding plane. In an embodiment, the metal layer may be formed by etching metal on a surface of any dielectric board in the PCB. In an embodiment, the metal layer used for grounding may be disposed on a side that is of the PCB and that is close to the flexible display 110. In an embodiment, an edge of the PCB may be considered as an edge of the grounding plane of the PCB. The electronic device 100 may further have another ground plane/grounding plate/grounding plane. As described above, details are not described herein again.

The rotating shaft 125 may be connected between the first housing 126 and the second housing 127. Under an action of the rotating shaft 125, the first housing 126 and the second housing 127 may be close to or away from each other. Correspondingly, the first display part 111 of the flexible display 110 and the second display part 112 of the flexible display 110 may be close to or far away from each other, so that the flexible display 110 may be folded or unfolded.

In an example, the rotating shaft 125 may include, for example, a main shaft, a first connection component, and a second connection component. The first connection component may be fastened to the first cover body 122, the second connection component may be fastened to the second cover body 124, and the first connection component and the second connection component may rotate relative to the main shaft. Mutual movement between the first connection component and the second connection component may drive mutual movement between the first housing 126 and the second housing 127, to implement folding and unfolding functions of the foldable electronic device 100.

The foldable electronic device 100 shown in FIG. 1 is currently in an unfolded state. In the unfolded state, an angle between the first housing 126 and the second housing 127 may be about 180°. The flexible display 110 may be in the unfolded state shown in FIG. 1.

FIG. 2 shows a possible folded state of the foldable electronic device 100. FIG. 2 shows an outward folded state (the outward folded state may be referred to as an outward-folded state for short) of the foldable electronic device 100. The outward folded state shown in FIG. 2 may be, for example, a left-right outward folded state or a top-down outward folded state. With reference to FIG. 1 and FIG. 2, the following describes a possible folded state of the foldable electronic device 100.

In this embodiment of this disclosure, that the foldable electronic device 100 is in a folded state may mean that the foldable electronic device 100 is currently bent, and the foldable electronic device 100 reaches a maximum bending degree. In this case, the first cover body 122 and the second cover body 124 may be approximately parallel to each other, spaced from each other, or disposed face to face. In addition, a spacing distance between the first cover body 122 and the second cover body 124 is minimal, and at least a part of the first housing 126 and at least a part of the second housing 127 are accommodated in space enclosed by the flexible display 110. The first display part 111, the first housing 126, the second housing 127, and the second display part 112 are sequentially stacked. Similarly, the first display part 111 and the second display part 112 may be approximately parallel to each other, and are spaced from each other. A spacing distance between the first cover body 122 and the second cover body 124 is less than a spacing distance between the first display part 111 and the second display part 112. In this case, the first display part 111 and the second display part 112 may be considered to be located on different planes.

With reference to FIG. 1 and FIG. 2, when the foldable electronic device 100 is in the outward folded state, the first cover body 122 and the second cover body 124 may be close to each other, and the first display part 111 and the second display part 112 may be close to each other. The first display part 111, the second display part 112, and the foldable display part 123 may form a housing area for accommodating the first cover body 122, the second cover body 124, and the rotating shaft 125. That is, the first cover body 122, the second cover body 124, and the rotating shaft 125 may be accommodated in space between the first display part 111 and the second display part 112.

It should be understood that the foldable electronic device 100 may be folded inward (the inward folded state may be referred to as an inward-folded state for short). When the foldable electronic device 100 is in the inward folded state, the first cover body 122 and the second cover body 124 may be close to each other, and the first display part 111 and the second display part 112 may be close to each other. The first cover body 122, the second cover body 124, and the rotating shaft 125 may form a housing area for accommodating the first display part 111, the second display part 112, and the foldable display part 123. That is, the first display part 111, the second display part 112, and the foldable display part 123 may be accommodated in space between the first cover body 122 and the second cover body 124.

The foldable electronic device 100 may be switched between a folded state and an unfolded state. When the foldable electronic device 100 is in the folded state, space occupied by the foldable electronic device 100 is small. When the foldable electronic device 100 is in the unfolded state, the foldable electronic device 100 may display a large screen, to increase a viewing range of a user.

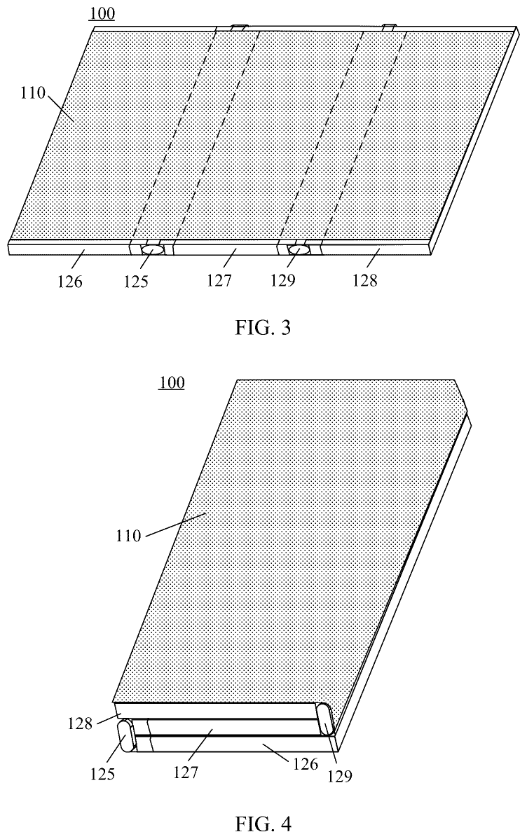

The foldable electronic device 100 may further include a third housing 128 and a rotating shaft 129, as shown in FIG. 3. The rotating shaft 129 may be connected between the third housing 128 and the second housing 127. The third housing 128 and the second housing 127 may be close to or far away from each other. As a quantity of foldable parts of the foldable electronic device 100 increases, in a case in which a same screen size is maintained in the unfolded state, space occupied by the foldable electronic device 100 may be further reduced in the folded state.

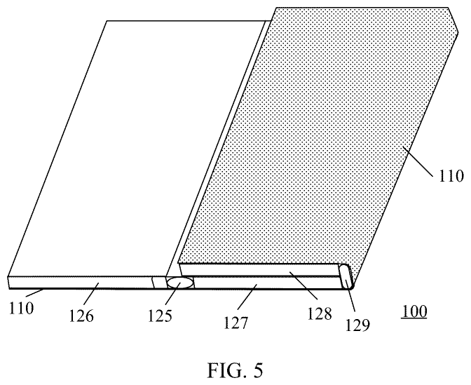

However, the foldable electronic device 100 shown in FIG. 3 has three foldable parts (the first housing 126, the second housing 127, and the third housing 128). Therefore, the foldable electronic device 100 has three forms: 1, an unfolded state. 2, a folded state, and 3, a partially-unfolded state.
1. FIG. 3 shows a possible unfolded state of the foldable electronic device 100. In the unfolded state, angles among the first housing 126, the second housing 127, and the third housing 128 may be about 180°. In this case, the flexible display 110 may be in the unfolded state.
2. FIG. 4 shows a possible folded state (a triple-fold state) of the foldable electronic device 100. In the folded state, the first housing 126 and the second housing 127 rotate along the rotating shaft 125, and the second housing 127 and the third housing 128 rotate along the rotating shaft 129, so that the foldable electronic device 100 reaches a maximum bending degree. In this case, the first housing 126, the second housing 127, and the third housing 128 may be considered to be located on different planes.
3. FIG. 5 shows a possible partially-unfolded state (a two-fold state) of the foldable electronic device 100. In a partially-unfolded state, an angle between the first housing 126 and the second housing 127 may be about 180°, and the second housing 127 and the third housing 128 rotate along the rotating shaft 129, so that the third housing 128 approaches the second housing 127. In this case, the first housing 126 and the second housing 127 are considered to be located on a same plane, and the second housing 127 and the third housing 128 may be considered to be located on different planes. In another possible partially-unfolded state, an angle between the third housing 128 and the second housing 127 may be about 180°, and the first housing 126 and the second housing 127 rotate along the rotating shaft 125, so that the first housing 126 approaches the second housing 127.

FIG. 1 shows only an example of some parts included in the electronic device 100. Actual shapes, actual sizes, and actual structures of these parts are not limited to those in FIG. 1.

It should be understood that, in embodiments of this disclosure, it may be considered that a surface on which the display of the electronic device is located is a front surface, a surface on which the rear cover is located is a rear surface, and a surface on which the side frame is located is a side surface.

It should be understood that, in embodiments of this disclosure, it is considered that when a user holds the electronic device (the user usually holds the electronic device vertically and faces the display), an orientation in which the electronic device is located has a top part, a bottom part, a left part, and a right part. It should be understood that, in embodiments of this disclosure, it is considered that when a user holds the electronic device (the user usually holds the electronic device vertically and faces the display), an orientation in which the electronic device is located has a top part, a bottom part, a left part, and a right part.

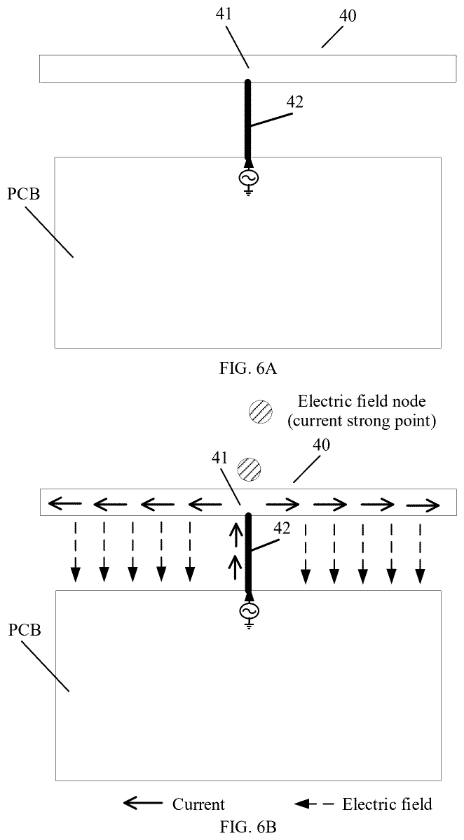

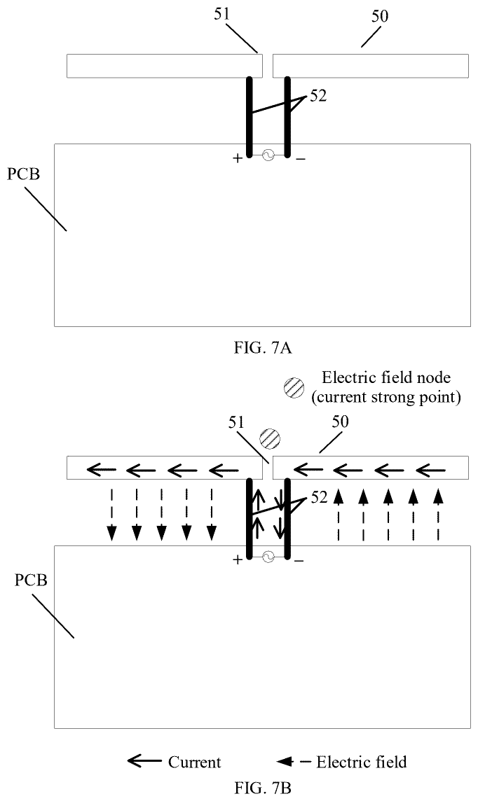

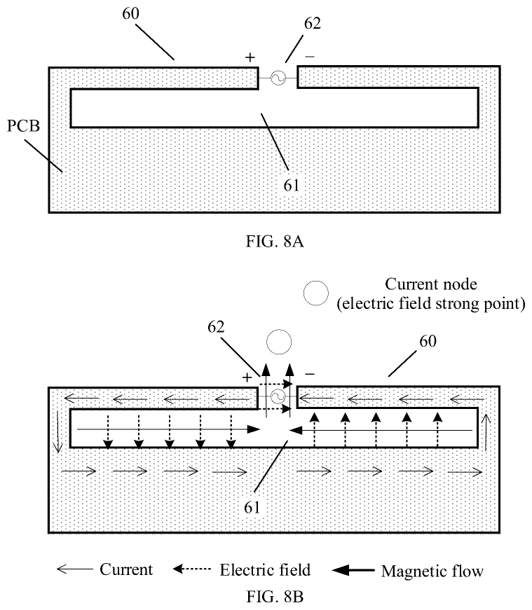

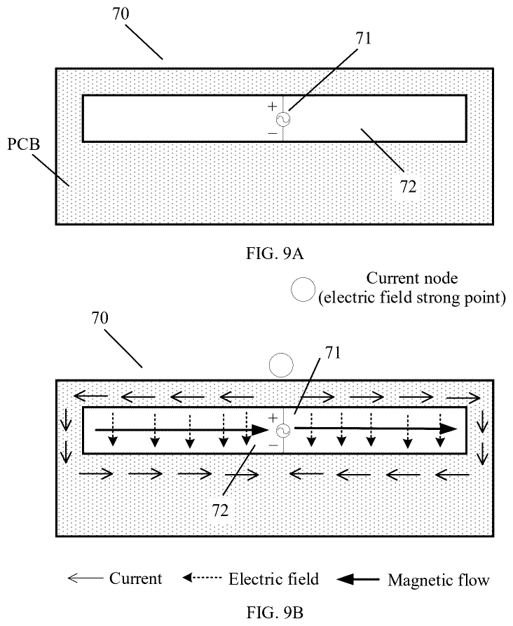

First, this disclosure relates to four antenna modes as described with reference to FIG. 6A to FIG. 9B. FIGS. 6A-6B show diagrams of a structure in a common mode of an antenna and distribution of corresponding currents and electric fields according to this disclosure. FIGS. 7A-7B show diagrams of a structure in a differential mode of another antenna and distribution of corresponding currents and electric fields according to this disclosure. As shown in FIGS. 6A-6B and FIGS. 7A-7B, two ends of an antenna radiator are open, and a common mode and a differential mode of the antenna radiator may be respectively referred to as a wire common mode and a wire differential mode. FIGS. 8A-8B show diagrams of a structure in a common mode of an antenna and distribution of corresponding currents, electric fields, and magnetic currents according to this disclosure. FIGS. 9A-9B show diagrams of a structure in a differential mode of another antenna and distribution of corresponding currents, electric fields, and magnetic currents according to this disclosure. Two ends of an antenna radiator in FIGS. 8-8B and FIGS. 9A-9B are coupled to a ground plane for grounding, and a common mode and a differential mode of the antenna radiator may be respectively referred to as a slot common mode and a slot differential mode.

It should be understood that the “common mode” or the “CM mode” in this disclosure includes a wire common mode and a slot common mod, and the “differential mode” or the “DM mode” in this disclosure includes a wire differential mode and a slot differential mode, which may be specifically determined based on a structure of an antenna.

It should be understood that a “common-differential mode” or a “CM-DM mode” in this disclosure is a wire common mode and a wire differential mode that are generated on a same radiator, or is a slot common mode and a slot differential mode that are generated on a same radiator, and may be specifically determined based on a structure of an antenna.

### 1. Wire Common Mode (CM) Mode

Herein, FIG. 6A shows that two ends of a radiator of an antenna 40 are open, and a feed circuit (not shown in the figure) is connected to a middle position 41. In an embodiment, the antenna 40 adopts a symmetrical feed form. The feed circuit may be connected to the middle position 41 of the antenna 40 through a feed line 42. It should be understood that the symmetrical feed form may be understood as that one end of the feed circuit is connected to the radiator, and the other end of the feed circuit is coupled to a ground plane for grounding. A coupling point (a feed point) between the feed circuit and the radiator is located at a center of the radiator, and the center of the radiator, for example, may be a center of a geometric structure, or a midpoint of an electrical length (or an area within a specific range near the midpoint).

The middle position 41 of the antenna 40 may be, for example, a geometric center of the antenna, or a midpoint of an electrical length of the radiator. For example, a connection joint between the feed line 42 and the antenna 40 covers the middle position 41.

Herein, FIG. 6B shows current and electric field distribution of the antenna 40. As shown in FIG. 6B, currents are reversely distributed on two sides of the middle position 41, for example, symmetrically distributed; and electric fields are codirectionally distributed on the two sides of the middle position 41. As shown in FIG. 6B, currents at the feed line 42 are codirectionally distributed. Based on the codirectional distribution of the currents at the feed line 42, such feeding shown in FIG. 6A may be referred to as wire CM feeding. Currents are reversely distributed on two sides of the connection joint between the radiator and the feed line 42. In this case, the antenna mode shown in FIG. 6B may be referred to as the wire CM mode (which may also be referred to as the CM mode for short, for example, for a wire antenna, the CM mode is a wire CM mode). A current and an electric field shown in FIG. 6B may be respectively referred to as a current and an electric field in the wire CM mode.

The current is strong at the middle position 41 of the antenna 40 (a current strong point is near the middle position 41 of the antenna 40), and is weak at two ends of the antenna 40, as shown in FIG. 6B. The electric field is weak at the middle position 41 of the antenna 40, and is strong at the two ends of the antenna 40.

### 2. Wire Differential Mode (DM) Mode

As shown in FIG. 7A, left and right ends of two radiators of an antenna 50 are open ends, and a feed circuit is connected to a middle position 51. In an embodiment, the antenna 50 adopts an anti-symmetrical feed form. One end of the feed circuit is connected to one of the radiators through a feed line 52, and the other end of the feed circuit is connected to the other one of the radiators through a feed line 52. The middle position 51 may be a geometric center of the antenna 50, or a slot formed between the radiators.

It should be understood that, “central anti-symmetrical feed” mentioned in this disclosure may be understood as that positive and negative electrodes of the feed element are respectively connected to two coupling points near the center between the radiators. In an embodiment, signals output from the positive and negative electrodes of the feed element have a same amplitude but opposite phases (for example, a phase difference is 180°+) 10°.

Herein, FIG. 7B shows current and electric field distribution of the antenna 50. As shown in FIG. 7B, currents are codirectionally distributed, for example, anti-symmetrically distributed, on two sides of the middle position 51 of the antenna 50; and electric fields are reversely distributed on the two sides of the middle position 51. As shown in FIG. 7B, currents at the feed line 52 are reversely distributed. Based on the reverse distribution of the currents at the feed line 52, such feeding shown in FIG. 7A may be referred to as wire DM feeding. Currents are codirectionally distributed on two sides of a connection joint between the radiator and the feed line 52. In this case, the antenna mode shown in FIG. 7B may be referred to as the wire DM mode (which may also be referred to as the DM mode for short, for example, for a wire antenna, the DM mode is a wire DM mode). A current and an electric field shown in FIG. 7B may be respectively referred to as a current and an electric field in the wire DM mode.

The current is strong at the middle position 51 of the antenna 50 (a current strong point is near the middle position 51 of the antenna 50), and is weak at two ends of the antenna 50, as shown in FIG. 7B. The electric field is weak at the middle position 51 of the antenna 50, and is strong at the two ends of the wire antenna 50.

It should be understood that, the radiator of the antenna may be understood as a metal mechanical part that generates radiation, and there may be one radiator as shown in FIGS. 6A-6B, or may be two radiators as shown in FIGS. 7A-7B, which may be adjusted based on an actual design or production requirement. For example, for the wire CM mode, two radiators may also be used as shown in FIGS. 7A-7B, two ends of the two radiators are disposed opposite to each other and are spaced apart with a slot, and a symmetrical feed manner is used for the ends that are close to each other. For example, an effect similar to that of the antenna structure shown in FIGS. 6A-6B may also be achieved by separately feeding a same feed signal into the ends of that are of the two radiators and that are close to each other. Correspondingly, for the wire DM mode, one radiator may also be used as shown in FIGS. 6A-6B, two feed points are disposed at a middle position of the radiator, and an anti-symmetrical feed manner is used. For example, an effect similar to that of the antenna structure shown in FIGS. 7A-7B may also be achieved if signals of a same amplitude but opposite phases are respectively fed at two symmetrical feed points on the radiator.

### 3. Wire CM-DM Mode

FIGS. 6A-6B and FIGS. 7A-7B respectively show that when two ends of a radiator are open, a wire CM mode and a wire DM mode are respectively generated in different feed manners.

When an antenna adopts an asymmetric feed form (including a side feed form and an offset feed form, where a feed point deviates from a middle position of the radiator), or a ground point (a position coupled to a ground plane) of the radiator is asymmetric (the ground point deviates from the middle position of the radiator), the antenna may generate both a first resonance and a second resonance, which respectively correspond to the wire CM mode and the wire DM mode. For example, the first resonance corresponds to the wire CM mode, and current and electric field distribution is shown in FIG. 6B. The second resonance corresponds to the wire DM mode, and current and electric field distribution is shown in FIG. 7B.

### 4. Slot CM Mode

A radiator of an antenna 60 shown in FIG. 8A has a hollow slot or slit 61, or a radiator of an antenna 60 and a ground (for example, a ground plane, which may be a PCB) may enclose the slot 61. The slot 61 may be formed by slotting the ground plane. An opening 62 is provided on a side of the slot 61, and the opening 62 may be specifically disposed on a middle position of the side. The middle position of the side of the slot 61 may be, for example, a geometric center of the antenna 60 or a midpoint of an electrical length of the radiator. For example, an area in which the opening 62 is provided on the radiator covers the middle position of the side. A feed circuit may be connected to the opening 62, and anti-symmetric feed is used. It should be understood that the anti-symmetrical feed may be understood as that positive and negative electrodes of the feed circuit are respectively connected to two ends of the radiator. Signals output from the positive and negative electrodes of the feed circuit have a same amplitude but opposite phases (for example, a phase difference is 180°±10°).

Herein, FIG. 8B shows current, electric field, and magnetic flow distribution of the antenna 60. As shown in FIG. 8B, currents are codirectionally distributed around the slot 61 and on a conductor (for example, the ground plane and/or the radiator 60) surrounding the slot 61, electric fields are reversely distributed on two sides of a middle position of the slot 61, and magnetic currents are reversely distributed on the two sides of the middle position of the slot 61. As shown in FIG. 8B, the electric fields are codirectional at the opening 62 (for example, a feed position), and the magnetic current is codirectional at the opening 62 (for example, the feed position). Because the magnetic current is codirectional at the opening 62 (the feed position), the feeding shown in FIG. 8A may be referred to as slot CM feeding. As the currents are codirectionally distributed (for example, anti-symmetrically distributed) on radiators on two sides of the opening 62, or as the currents are codirectionally distributed around the slot 61 and on a conductor surrounding the slot 61, the antenna mode shown in FIG. 8B may be referred to as a slot CM mode (which may also be referred to as a CM mode for short, for example, for a slot antenna, the CM mode is a slot CM mode). An electric field, a current, and a magnetic flow shown in FIG. 8B may be referred to as an electric field, a current, and a magnetic flow in the slot CM mode.

The magnetic field is weak at the middle position of the antenna 60, and is strong at two ends of the antenna 60. The electric field is strong at the middle position of the antenna 60 (an electric field strong point is near the middle position of the antenna 60), and is weak at the two ends of the antenna 60, as shown in FIG. 8B.

### 5. Slot DM Mode

A radiator of an antenna 70 shown in FIG. 9A has a hollow slot or slit 72, or a radiator of an antenna 70 and a ground (for example, a ground plane, which may be a PCB) may enclose the slot 72. The slot 72 may be formed by slotting the ground plane. A feed circuit is connected to a middle position 71 of the slot 72, and symmetrical feed is used. It should be understood that the symmetrical feed form may be understood as that one end of the feed circuit is connected to the radiator, and the other end of the feed circuit is coupled to a ground plane for grounding. A coupling point (a feed point) between the feed circuit and the radiator is located at a center of the radiator, and the center of the radiator, for example, may be a center of a geometric structure, or a midpoint of an electrical length (or an area within a specific range near the midpoint). A middle position of a side edge of the slot 72 is connected to a positive electrode of the feed circuit, and a middle position of another side edge of the slot 72 is connected to a negative electrode of the feed circuit. The middle position of the side edge of the slot 72 may be, for example, the middle position of the slot antenna 60/the middle position of the ground, for example, the geometric center of the slot antenna, or a midpoint of an electrical length of the radiator. For example, a connection joint between the feed circuit and the radiator covers the middle position 51 of the side.

Herein, FIG. 9B shows current, electric field, and magnetic flow distribution of the antenna 70. As shown in FIG. 9B, on a conductor (for example, the ground plane and/or the radiator 60) surrounding the slot 72, currents are distributed around the slot 72 and are reversely distributed on two sides of the middle position of the slot 72, electric fields are codirectionally distributed on the two sides of the middle position 71, and magnetic currents are codirectionally distributed on the two sides of the middle position 71. Magnetic currents at the feed circuit are reversely distributed (not shown). Based on the reverse distribution of the magnetic currents at the feed circuit, such feeding shown in FIG. 9A may be referred to as slot DM feeding. As currents are reversely distributed (for example, symmetrically distributed) on two sides of the connection joint between the feed circuit and the radiator, or as currents are reversely distributed (for example, symmetrically distributed) around the slot 71, the antenna mode shown in FIG. 9B may be referred to as a slot DM mode (which may also be referred to as a DM mode for short, for example, for a slot antenna, the DM mode is a slot DM mode). An electric field, a current, and a magnetic flow shown in FIG. 9B may be referred to as an electric field, a current, and a magnetic flow in the slot DM mode.

The current is weak at the middle position of the antenna 70, and is strong at two ends of the antenna 70. The electric field is strong at the middle position of the antenna 70 (an electric field strong point is near the middle position of the antenna 60), and is weak at the two ends of the slot antenna 70, as shown in FIG. 9B.

It should be understood that, the radiator of the antenna may be understood as a metal mechanical part (for example, including a part of the ground plane) that generates radiation, and may include an opening as shown in FIGS. 8A-8B, or may be in a shape of a complete loop as shown in FIGS. 9A-9B, which may be adjusted based on an actual design or production requirement. For example, for the slot CM mode, a complete annular radiator may also be used as shown in FIGS. 9A-9B, two feed points are disposed at the middle position of the radiator on one side of the slot 61, and anti-symmetrical feed is used. For example, an effect similar to that of the antenna structure shown in FIGS. 8A-8B may also be achieved if signals of a same amplitude but opposite phases are respectively fed into two ends of an original opening position. Correspondingly, for the slot DM mode, a radiator including an opening may also be used as shown in FIGS. 8A-8B, and symmetrical feed is used at both ends of the opening position. For example, an effect similar to that of the antenna structure shown in FIGS. 9A-9B may also be achieved by separately feeding a same feed source signal into two ends of the radiator on two sides of the opening.

### 6. Slot CM-DM Mode

FIGS. 8A-8B and FIGS. 9A-9B show that a slot structure uses different feed manners to generate a slot CM mode and a slot DM mode respectively.

When an antenna adopts an asymmetric feed form (including a side feed form or an offset feed form, where a feed point deviates from a middle position), or an opening on one side of a slot is asymmetric (the opening deviates from a middle position of the side), the antenna may generate both a first resonance and a second resonance, which respectively correspond to the slot CM mode and the slot DM mode. For example, the first resonance corresponds to the slot CM mode, and current, electric field, and magnetic flow distribution is shown in FIG. 8B. The second resonance corresponds to the slot DM mode, and current, electric field, and magnetic flow distribution is shown in FIG. 9B.

Because the above antenna structure may have two operating modes (electric fields are symmetrically distributed or anti-symmetrically distributed) in which the electric fields are orthogonal ((integrally orthogonal) an inner product of the electric fields is zero in far field), the antenna structure has good isolation between the two operating modes, and may be used in a MIMO antenna system in an electronic device.

In addition, when two antenna structures respectively operate in the two operating modes (the electric fields are symmetrically distributed or anti-symmetrically distributed) in which the electric fields are orthogonal ((integrally orthogonal) an inner product of the electric fields is zero in far field), there is good isolation between the two antenna structures, and the two antenna structures may be used as subunits in the MIMO antenna system in the electronic device.

It should be understood that the two antenna structures may be understood as antenna structures in which signals are separately fed into a first feed circuit and a second feed circuit. The first feed circuit is different from the second feed circuit. In the electronic device, the first feed circuit and the second feed circuit may be different radio frequency channels in a radio frequency chip (RF IC).

Embodiments of this disclosure provide a foldable electronic device, including an antenna. The antenna uses a first side frame and a second side frame that are disposed a foldable manner of an electronic device as radiators. A part of the first side frame is used as a radiation stub (including a feed point), and a part of the second side frame is used as a parasitic stub. A gap is provided on the parasitic stub, so that a radiation aperture of the antenna is increased to improve a radiation characteristic of the antenna.

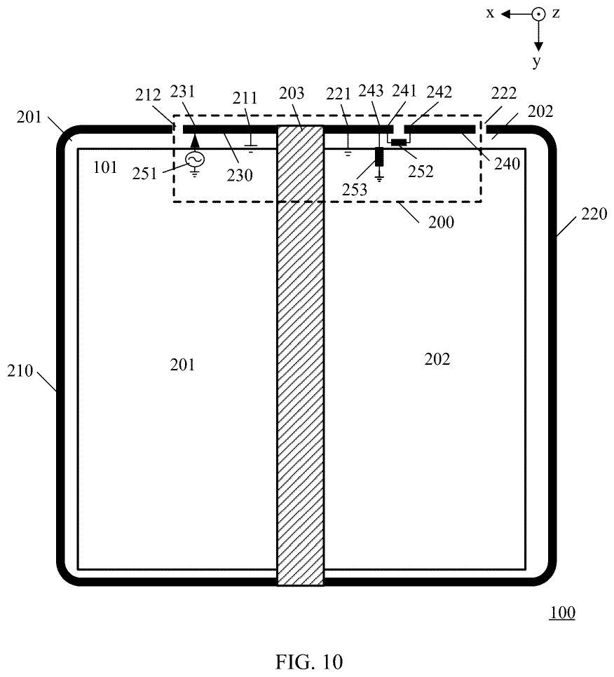

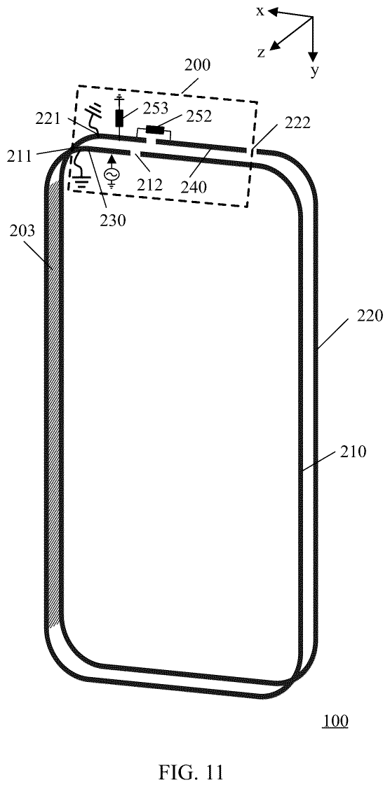

FIG. 10 is a diagram of a foldable electronic device 100 according to an embodiment of this disclosure.

As shown in FIG. 10, the foldable electronic device 100 may include a first housing 201, a second housing 202, and a ground plane 101.

The first housing 201 includes a first side frame 210, and at least a part of the first side frame 210 and the ground plane 101 are spaced apart. The second housing 202 includes a second side frame 220, and at least a part of the second side frame 220 and the ground plane 101 are spaced apart.

The first side frame 210 includes a first position 211 and a second position 212. In an embodiment, the first side frame 210 is coupled to the ground plane 101 at the first position 211 or is provided with a first slot at the first position 211. In an embodiment, the first side frame 210 is coupled to the ground plane 101 at the second position 212 or is provided with a second slot at the second position 212.

It should be understood that, in this embodiment of this disclosure, a coupling connection is described by using only an electrical connection as an example. During actual production or practice, the coupling connection may also be implemented through indirect coupling. For brevity of description, details are not described again.

The second side frame 220 includes a third position 221 and a fourth position 222. The second side frame 220 is coupled to the ground plane 101 at the third position 221, and a third slot is provided on the second side frame 220 at the fourth position 222.

In an embodiment, the foldable electronic device 100 may further include a first rotating shaft 203. The first rotating shaft 203 is located between the first housing 201 and the second housing 202, and the first rotating shaft 203 is rotatably connected to the first housing 201 and the second housing 202, so that the first housing 201 and the second housing 202 can rotate relative to each other.

It should be understood that, in the foldable electronic device 100 shown in FIG. 10, the first rotating shaft 203 is directly connected to the first housing 201 and the second housing 202, so that the first housing 201 and the second housing 202 can rotate relative to each other. In addition, “the first rotating shaft 203 is rotatably connected to the first housing 201 and the second housing 202” includes this case: The first rotating shaft 203 may be rotatably connected to the first housing or the second housing through one or more second rotating shafts and one or more intermediate housings. For example, in an embodiment, the foldable electronic device 100 may further include a first rotating shaft and a second rotating shaft, and one or more intermediate housings located between the first rotating shaft and the second rotating shaft. The first rotating shaft is located between the first housing 201 and the intermediate housing, and the first rotating shaft is rotatably connected to the first housing 201 and the intermediate housing, so that the first housing 201 and the intermediate housing can rotate relative to each other. The second rotating shaft is located between the intermediate housing and the second housing 202, and the first rotating shaft 203 is rotatably connected to the intermediate housing and the second housing 202, so that the intermediate housing and the second housing 202 can rotate relative to each other.

The foldable electronic device 100 may further include an antenna 200. The antenna 200 includes a first radiator 230, a second radiator 240, a first feed circuit 251, and a first element 252.

The first radiator 230 is a conductive part of the first side frame 210 between the first position 211 and the second position 212. The first radiator 230 includes a first feed point 231, and the first feed circuit 251 is coupled to the first feed point 231.

The second radiator 240 is a conductive part of the second side frame 220 between the third position 221 and the fourth position 222. A fourth slot is provided on the second radiator 240, or a fourth slot is provided on the second side frame 220 between the third position 221 and the fourth position 222. Two ends of the first element 252 are respectively coupled to radiator parts that are of the second radiator 240 and that are on two sides of the fourth slot. A length of the second radiator 240 is less than or equal to three times a length of the first radiator 230.

It should be understood that the “length” in this disclosure is a physical length, and an “electrical length” in this disclosure is a ratio of the physical length to a wavelength of a transmitted electromagnetic wave.

In an embodiment, the length of the second radiator 240 is greater than the length of the first radiator 230.

The length of the second radiator 240 may be greater than or equal to three halves of the length of the first radiator 230 and less than or equal to five halves of the length of the first radiator 230.

Alternatively, the length of the second radiator 240 may be greater than or equal to 1.8 times the length of the first radiator 230 and less than or equal to 2.2 times the length of the first radiator 230.

In an embodiment, the length of the second radiator 240 may be less than or equal to the length of the first radiator 230.

The length of the second radiator 240 may be greater than or equal to 0.8 times the length of the first radiator 230 and less than or equal to the length of the first radiator 230.

Alternatively, the length of the second radiator 240 may be greater than or equal to 0.9 times the length of the first radiator 230 and less than or equal to the length of the first radiator 230.

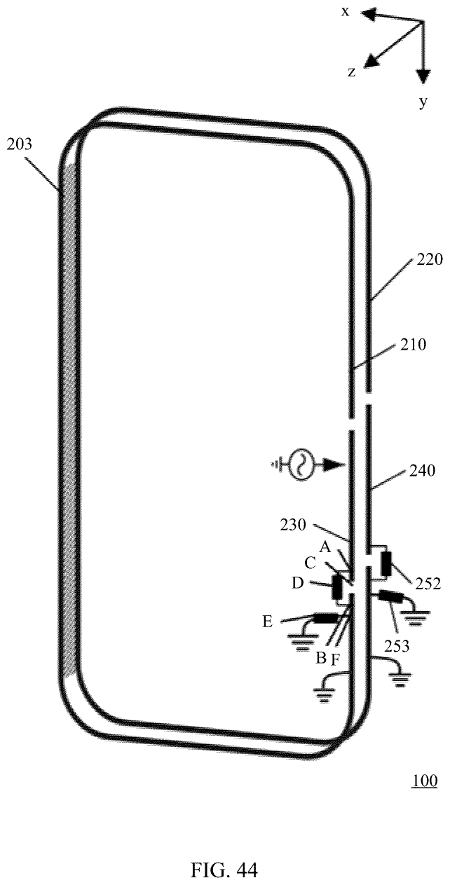

For example, the first radiator 230 may also be provided with a slot. In other words, the first side frame 210 may be provided with a slot between the first position 211 and the second position 212, and may be provided with a corresponding element. Two ends of the element are respectively coupled to radiator parts that are of the first radiator 230 and that are on two sides of the slot. In this way, structures of the first radiator 230 and the second radiator 240 are similar, and lengths of the first radiator 230 and the second radiator 240 are close to each other. For details, refer to the following embodiment shown in FIG. 44.

It should be understood that a ratio of the length of the second radiator 240 to the length of the first radiator 230 may be adjusted based on actual production or design.

The second radiator 240 further includes a first coupling point 241 and a second coupling point 242. The second radiator 240 is provided with the fourth slot between the first coupling point 241 and the second coupling point 242. A first end of the first element 252 is coupled to the first coupling point 241, and a second end of the first element 252 is coupled to the second coupling point 242.

In an embodiment, the first element 252 may be configured to adjust an equivalent capacitance between the first coupling point 241 and the second coupling point 242, so as to adjust a radiation characteristic (for example, a frequency of a resonance point) of a first parasitic resonance. In an embodiment, a distance between the fourth slot and each of the first coupling point 241 and the second coupling point 242 is less than or equal to 5 mm. The distance between the fourth slot and each of the first coupling point 241 and the second coupling point 242 may be understood as a minimum distance between conductors on two sides of the fourth slot and each of the first coupling point 241 and the second coupling point 242. When the first element 252 is electrically connected to the first coupling point 241 and the second coupling point 242 via a metal spring plate, the distance between the fourth slot and each of the first coupling point 241 and the second coupling point 242 may be understood as a minimum distance between a center of a part that is of the metal spring plate and that is in contact with the coupling point and conductors on two sides of the fourth slot.

It should be understood that an equivalent capacitor between the first coupling point 241 and the second coupling point 242 may be understood as a distributed capacitor formed by using the fourth slot and an equivalent capacitor obtained after the first element 252 is connected in parallel. A capacitance value of the equivalent capacitor may be determined by an electrical parameter (for example, an equivalent capacitance value) of the first element 252 and an electrical parameter (for example, a width of the fourth slot and a relative dielectric constant of a medium filled in the fourth slot) of the fourth slot.

In an embodiment, a length of the second radiator 240 between the third position 221 and the fourth slot is less than a length of the second radiator 240 between the third slot and the fourth slot.

According to this embodiment of this disclosure, because the second side frame is coupled to the ground plane at the third position 221, a current near the third position is strong; and the fourth position is provided with a slit, so that a current near the fourth position is weak. When the fourth slot is provided in an area with a strong current on the second radiator 240, an effect of reducing strength of a single current strong point of the second radiator through the fourth slot is more obvious, and current distribution on the second radiator is more even.

In an embodiment, the fourth slot is provided between a midpoint of the second radiator 240 and a ground end (for example, the third position 221). For example, a length of the second radiator 240 between the third position 221 and the fourth slot is less than a length of the second radiator 240 between the third slot and the fourth slot.

In an embodiment, the fourth slot is provided between a midpoint of the second radiator 240 and a ground end (for example, the third position 221). In addition, a length of the second radiator 240 between the third position 221 and the fourth slot is less than or equal to three fifths of a length of the second radiator 240 between the third slot and the fourth slot.

In an embodiment, the fourth slot is provided between a midpoint of the second radiator 240 and a ground end (for example, the third position 221). In addition, a length of the second radiator 240 between the third position 221 and the fourth slot is less than or equal to one third of a length of the second radiator 240 between the third slot and the fourth slot.

In an embodiment, the fourth slot is provided between a midpoint of the second radiator 240 and a ground end (for example, the third position 221). In addition, a length of the second radiator 240 between the third position 221 and the fourth slot is less than or equal to one seventh of a length of the second radiator 240 between the third slot and the fourth slot.

It should be understood that, for the area with the large current on the second radiator 240, a position at which the fourth slot is provided should be understood as a position corresponding to the second radiator 240 (for example, a position for operating in a quarter-wavelength mode) that is not provided with a slit. After the fourth slot is provided, current intensity at the corresponding position becomes weak, to achieve an effect of evenly dispersing a current.

When the foldable electronic device 100 is in a folded state, the first radiator 230 and the second radiator 240 at least partially overlap in a first direction, and the first direction is a thickness direction of the foldable electronic device 100, for example, a z direction.

The first radiator 230 is configured to generate a first resonance. The second radiator 240 and the first element 252 are configured to generate a first parasitic resonance.

It should be understood that, that the second radiator 240 and the first element 252 are configured to generate a first parasitic resonance may be understood as that both the entire second radiator 240 and the first element 252 are configured to generate the first parasitic resonance. An electrical parameter (for example, an electrical length) of the second radiator 240 and an electrical parameter (for example, an equivalent capacitance value or an equivalent inductance value) of the first element 252 directly affect the first parasitic resonance (for example, a frequency of a resonance point). In a comparative embodiment, the first electronic element 252 is not disposed, and a resonance point of the second parasitic resonance deviates from a range of a target frequency band that exceeds a first threshold, where the first threshold may be greater than or equal to 200 MHz.

That the first radiator 230 is configured to generate a first resonance may be understood that the entire radiator is configured to generate the resonance. In addition, it should not be understood that another component (for example, the first element 252) or another radiator (for example, a parasitic radiator in the first housing or a parasitic radiator in the second housing) is not used to affect the resonance.

In an embodiment, “the first radiator 230 is configured to generate a first resonance” and “the second radiator 240 and the first element 252 are configured to generate a first parasitic resonance” may be understood as an entire technical solution, where presence or absence of the first element 252 has greater impact on the first parasitic resonance than on the first resonance. Compared with the solution of this disclosure, in a solution in which the first element 252 is not disposed, a frequency difference offset by the resonance point of the first parasitic resonance is greater than a frequency difference offset by the first resonance. For example, the frequency difference offset by the resonance point of the first parasitic resonance is more than two times or more than five times greater than the frequency difference offset by the first resonance.

It should be understood that, in the technical solution provided in this embodiment of this disclosure, when the foldable electronic device 100 is in the folded state, the first radiator 230 in the antenna 200 is used as a main radiation stub (a stub for feeding a signal through a feed point), the second radiator 240 is used as a parasitic stub (a stub for coupling a signal by coupling the main radiation stub), and the second radiator 240 may generate the first parasitic resonance by coupling with the first radiator 230. A resonance frequency of the first parasitic resonance may be determined based on the length of the second radiator 240, and the resonance frequency of the first parasitic resonance may be determined based on the electrical parameter of the second radiator 240 and the electrical parameter of the first element 252. In an embodiment, the length of the second radiator 240, the length of the second radiator 240, and the electrical parameter of the first element 252 are adjusted for the first parasitic resonance to be close to the first resonance. The first resonance and the first parasitic resonance jointly form an operating frequency band, to expand an operating bandwidth of the antenna 200, and jointly support an operating frequency band of the foldable electronic device 100.

That the first resonance and the first parasitic resonance jointly form an operating frequency band may be understood as that the first parasitic resonance and the first resonance are close to each other, and jointly form a resonance frequency band. For example, a resonance point frequency of the first resonance is lower than a resonance point frequency of the first parasitic resonance, or a resonance point frequency of the first resonance is higher than a resonance point frequency of the first parasitic resonance. In an embodiment, it may also be understood that the resonance point of the first resonance is connected to the resonance point of the first parasitic resonance in a S11 diagram, and S11 in a connected area is less than −4 dB, so as to form a resonance frequency band.

In addition, an operating frequency band that is of the foldable electronic device 100 and that is set between the first coupling point 241 and the second coupling point 242 may be understood as a frequency range, for example, a low band (LB) (698 MHz to 960 MHz), a middle band (middle band, MB) (1710 MHz to 2170 MHz), or a high band (high band, HB) (2300 MHz to 2690 MHz) in a cellular network. For example, an operating frequency band of the foldable electronic device 100 is LB (698 MHz to 960 MHz). The operating frequency band may include a plurality of communication frequency bands that are within the frequency range, for example, B5 and B8. This may be correspondingly understood in this embodiment of this disclosure.

In an embodiment, a resonance frequency band of the antenna 200 includes any operating frequency band within a range of 600 MHz to 1.5 GHZ, and a difference between the resonance point frequency of the first parasitic resonance and the resonance point frequency of the first resonance may be less than or equal to 200 MHz. Alternatively, in an embodiment, a resonance frequency band of the antenna 200 includes any operating frequency band within a range of 600 MHz to 1.5 GHZ, and a difference between the resonance point frequency of the first parasitic resonance and the resonance point frequency of the first resonance may be less than or equal to 100 MHz.

In an embodiment, a resonance frequency band of the antenna 200 includes any operating frequency band within a range of 1.5 GHz to 3 GHZ, and a difference between the resonance point frequency of the first parasitic resonance and the resonance point frequency of the first resonance may be less than or equal to 400 MHz. Alternatively, in an embodiment, a resonance frequency band of the antenna 200 includes any operating frequency band within a range of 1.5 GHz to 3 GHZ, and a difference between the resonance point frequency of the first parasitic resonance and the resonance point frequency of the first resonance may be less than or equal to 200 MHz.

In an embodiment, a resonance frequency band of the antenna 200 includes any operating frequency band within a range of 3 GHz to 6 GHZ, and a difference between the resonance point frequency of the first parasitic resonance and the resonance point frequency of the first resonance may be less than or equal to 600 MHz. Alternatively, in an embodiment, a resonance frequency band of the antenna 200 includes any operating frequency band within a range of 3 GHZ to 6 GHz, and a difference between the resonance point frequency of the first parasitic resonance and the resonance point frequency of the first resonance may be less than or equal to 400 MHZ.

The fourth slot is provided between the first coupling point 241 and the second coupling point 242, and the first element 252 is coupled (the fourth slot provided on the second radiator 240 may be considered as an equivalent capacitor disposed on the second radiator 240, for example, a distributed capacitor, and the first element 252 may be configured to determine an equivalent capacitance value of the fourth slot), so that strength of a single current strong point of the second radiator 240 can be reduced for a current distribution to be even. In an embodiment, the current distribution on the second radiator 240 is even, so that a conductor loss and a dielectric loss that are caused by the second radiator 240, and a conductor and a medium that are disposed around the second radiator 240 can be reduced. In an embodiment, the current distribution on the second radiator 240 is even, so that a radiation aperture of the second radiator 240 can be increased. Therefore, the fourth slot is provided between the first coupling point 241 and the second coupling point 242, and the first element 252 is coupled, so that total efficiency and radiation efficiency of the antenna can be improved.

In addition, the first radiator 230 is used as a main radiation stub (a stub for feeding a signal through a feed point), and an antenna structure formed by the first radiator 230 is not limited in this embodiment of this disclosure. For example, the first end and the second end of the first radiator 230 may be adjusted to be ground ends or open ends (for example, the first side frame 210 is coupled to the ground plane 101 at the first position 211 or is provided with the first slot at the first position 211, and the first side frame 210 is coupled to the ground plane 101 at the second position 212 or is provided with the second slot at the second position 212), so that the first radiator 230 forms different antenna structures. The antenna structure formed by the first radiator 230 may operate in different antenna modes. For example, the first end and the second end of the first radiator 230 are open ends, and the first radiator may operate in the foregoing wire CM-DM mode. The first end and the second end of the first radiator 230 are ground ends, and the first radiator may operate in the foregoing slot CM-DM mode. One of the first end and the second end of the first radiator 230 is a ground end, and the other end is an open end, and the first radiator 230 may operate in a quarter-wavelength mode.

It should be understood that, when one of the first end and the second end of the first radiator 230 is a ground end, the other end is an open end, and a current on the first radiator 230 is codirectional, it may be considered that the first radiator 230 operates in the quarter-wavelength mode. A current at the ground end of the first radiator 230 is strong, and an electric field at the open end of the first radiator 230 is strong.

In an embodiment, a length of the second radiator 240 between the third position 221 and the fourth slot is less than a length of the second radiator 240 between the third slot and the fourth slot.

It should be understood that, because the second side frame 220 is coupled to the ground plane at the third position 221, a current of the second radiator 240 near the third position 221 is strong, and a current near the fourth position 222 is weak. When the fourth slot is provided in an area with a large current, an effect of reducing strength of a single current strong point of the second radiator 240 is more obvious, and the current distribution on the second radiator 240 is more even. Because the current distribution on the second radiator 240 is more even, the conductor loss and the dielectric loss that are caused by the second radiator 240, and the conductor and the medium that are disposed around the second radiator 240 are smaller. In an embodiment, the current distribution on the second radiator 240 is more even, the radiation aperture of the second radiator 240 is improved more significantly, and the effect of improving total efficiency and radiation efficiency of the antenna is better.

In an embodiment, the first radiator 230 and the second radiator 240 are disposed adjacent to each other in the first direction (for example, no other conductor is disposed between the first radiator 230 and the second radiator 240). In an embodiment, when the first side frame 210 is provided with a slot at the first position/second position 212, the slot provided on the first side frame 210 is aligned with the third slot or the fourth slot, so that when an electrical signal is fed, the third slot or the fourth slot may obtain more energy by using an electric field in the slot provided on the first side frame 210 through coupling. This improves a radiation characteristic of a parasitic resonance generated by the second radiator.

It should be understood that, in this embodiment of this disclosure, alignment may be understood as that two slots at least partially overlap in the first direction. When the two slots completely overlap in the first direction, the radiation characteristic of the parasitic resonance generated by the second radiator is optimal.

In an embodiment, the first radiator 230 and the second radiator 240 are spaced apart in the first direction (for example, another conductor is disposed between the first radiator 230 and the second radiator 240, for example, in a multi-fold electronic device, the first radiator 230 and the second radiator 240 are disposed on non-adjacent housings). In an embodiment, when the first side frame 210 is provided with a slot at the first position/second position 212, the slot provided on the first side frame 210 is aligned with the third slot or the fourth slot, so that when an electrical signal is fed, the third slot or the fourth slot may obtain more energy by using an electric field in the slot provided on the first side frame 210 through coupling. This improves a radiation characteristic of a resonance generated by the second radiator.

In an embodiment, a second feed point may be further disposed on the second radiator 240. When the foldable electronic device 100 is in an unfolded state, the second radiator 240 may be fed with an electrical signal through the second feed point as a main radiation stub. In addition, in an embodiment, when the foldable electronic device 100 is in the folded state, the second radiator 240 may be used as a parasitic stub in the antenna 200, and may be fed with an electrical signal through the second feed point as a main radiation stub of another antenna. This is not limited in this embodiment of this disclosure.

FIG. 11 is a diagram of the foldable electronic device 100 according to an embodiment of this disclosure.

As shown in FIG. 11, the first side frame 210 is coupled to a ground plane at the first position 211, and is provided with a second slot at the second position 212. The second side frame 220 is coupled to the ground plane at the third position 221, and is provided with a third slot at the fourth position 222.

It should be understood that, in the two-dimensional diagram shown in FIG. 10 and the three-dimensional diagram shown in FIG. 11, the second slot at the second position 212 and the fourth slot between the coupling point 241 and the coupling point 242 may be aligned in a folded state, to meet an appearance consistency requirement of the electronic device. In two-dimensional and three-dimensional diagrams in other embodiments of this disclosure, slots provided on different frame bodies may be understood similarly. For example, in the three-dimensional diagram, the slots are illustrated in a staggered manner to display radiator structures on different frame bodies of the foldable electronic device 100 conveniently.

In an embodiment, a width of the second slot/third slot/fourth slot is greater than or equal to 0.1 mm and less than or equal to 2 mm. It should be understood that, in this embodiment of this disclosure, the width of the slot provided on the side frame may be within the foregoing range.

In an embodiment, the antenna 200 further includes a second element 253. The second radiator 240 includes a third coupling point 243. A first end of the second element 253 is coupled to the third coupling point 243, and a second end of the second element 253 is coupled to the ground plane.

It should be understood that, in the technical solution provided in this embodiment of this disclosure, the second radiator 240 is coupled to the ground plane at the third coupling point 243 via the second element 253, and/or the fourth slot is provided between the first coupling point 241 and the second coupling point 242, and the first element 252 is coupled between the first coupling point 241 and the second coupling point 242, so that total efficiency and radiation efficiency of the antenna can be improved. A current density on the second radiator 240 may be dispersed (for example, strength of a single current strong point is reduced for a current distribution to be even) by disposing the first element 252 and/or the second element 253. In an embodiment, the current distribution on the second radiator 240 is even, so that a conductor loss and a dielectric loss that are caused by the second radiator 240, and a conductor and a medium that are disposed around the second radiator 240 can be reduced. In an embodiment, the current distribution on the second radiator 240 is even, so that a radiation aperture of the second radiator 240 can be increased.

In an embodiment, an electric field generated by the second radiator 240 is codirectional from a first end to a second end of the second radiator 240.

In an embodiment, a current on the second radiator 240 may be reversed in an area near the third coupling point 243 for the electric field generated by the second radiator 240 to be continuous. In this case, the electric field cannot reach a node at the third coupling point 243, so that the electric field generated by the radiator is continuous, is not reversed (for example, an electric field reverse area is not included), and has no node. This disperses current density on the entire radiator, increases a radiation aperture of the second radiator 240, namely, a total radiation aperture (a total radiation aperture of the first radiator 230 and the second radiator 240) of the antenna 200, reduces a loss caused by the conductor and the medium, and improves a radiation characteristic of the antenna.

In an embodiment, no switch is disposed between the second radiator 240 and the second element 253 (for example, no switch is disposed between the third coupling point 243 and the first end of the second element 253), or no switch is disposed between the second element 253 and the ground plane (for example, no switch is disposed between the second end of the second element 253 and the ground plane). In this embodiment of this disclosure, an element connected in series between the second radiator 240 and the ground plane is configured to disperse a current density on the radiator, thereby reducing a loss caused by the radiator and a conductor disposed around the radiator. In an embodiment, the second element 253 may affect a frequency of a resonance point of a resonance to a specific extent, but is different from a tuning circuit mainly configured to adjust the frequency of the resonance point of the resonance. In addition, no switch is disposed at the first element to switch a frequency band, and the switch may introduce an additional insertion loss, thereby deteriorating radiation performance of the antenna.

In an embodiment, a switch may alternatively be disposed between the second radiator 240 and the second element 253. When the antenna 200 operates in different operating frequency bands, the second element 253 with different capacitance values or inductance values is switched.

In an embodiment, the second radiator 240 may be configured to generate a first parasitic resonance. An electrical length of the second radiator 240 may be greater than three eighths of a first wavelength, and the first wavelength may be a wavelength corresponding to the first parasitic resonance.

It should be understood that the first end of the second radiator 240 is coupled to the ground plane as a ground end, and the second end is an open end. The first parasitic resonance of the second radiator 240 may correspond to a quarter-wavelength mode. The second element 253 and the fourth slot may make the electrical length of the second radiator 240 greater than three eighths of the first wavelength. In this case, the current on the second radiator 240 is codirectional (for example, a reversal does not occur), and an electric field between the second radiator 240 and the ground plane is not reversed. The electrical length of the second radiator 240 increases from a quarter of the first wavelength to more than three eighths of the first wavelength, but the second radiator still operates in the quarter-wavelength mode. In this case, a current density on the second radiator 240 is dispersed, and a current density between the second radiator 240 and the ground plane is reduced, so that a loss caused by the radiator, and a conductor and a medium that are disposed around the radiator is reduced, and the radiation characteristic of the antenna 200 is further improved.

In an embodiment, the first radiator 230 may be configured to generate a first resonance. In an embodiment, a first end of the first radiator 230 is coupled to the ground plane as a ground end, and a second end is an open end. The first radiator 230 may operate in the quarter-wavelength mode. An electrical length of the first radiator is a quarter of a second wavelength, and the second wavelength is a wavelength corresponding to the first resonance.

In an embodiment, a length of the second side frame 220 between the third position 221 and the fourth position 222 is greater than or equal to five halves of a length of the first side frame 210 between the first position 211 and the second position 212.

In an embodiment, an electrical length between the third position 221 and the fourth slot is less than a quarter of the first wavelength. An electrical length between the fourth position 222 and the fourth slot is less than a half of the first wavelength.

In an embodiment, the first coupling point 241 is located between the third position 221 and the fourth slot, and the second coupling point 242 is located between the fourth position 222 and the fourth slot.

In an embodiment, the third coupling point 243 may be located between the third position 221 and the first coupling point 241. In an embodiment, a distance (for example, a length of the second radiator between the third coupling point 243 and the first coupling point 241) between the third coupling point 243 and the first coupling point 241 is greater than or equal to 0 mm and less than or equal to 5 mm.

It should be understood that, when the distance between the third coupling point 243 and the first coupling point 241 is equal to 0 mm, the third coupling point 243 overlaps the first coupling point 241. In an embodiment, the first end of the first element 252 and the first end of the second element 253 may be coupled to the first coupling point 241 (the third coupling point 243) via a same connector.

When the third coupling point 243 may be located between the third position 221 and the first coupling point 241, a relationship between the first element 252 and the second element 253 is similar to a series connection relationship. In an embodiment, the second element 253 may be an inductor, so that the radiation aperture of the second radiator may be further increased. In an embodiment, the second element may be a capacitor, and may be configured to reduce the radiation aperture of the second radiator. The radiation aperture of the second radiator is adjusted via both the first element and the second element, to achieve a parasitic resonance on an expected frequency band.

In an embodiment, the third coupling point 243 may be located between the fourth position 222 and the second coupling point 242. In an embodiment, a distance (for example, a length of the second radiator between the third coupling point 243 and the second coupling point 242) between the third coupling point 243 and the second coupling point 242 is greater than or equal to 0 mm and less than or equal to 5 mm.

It should be understood that, when the distance between the third coupling point 243 and the second coupling point 242 is equal to 0 mm, the third coupling point 243 overlaps the second coupling point 242. In an embodiment, the second end of the first element 252 and the first end of the second element 253 may be coupled to the second coupling point 242 (the third coupling point 243) via a same connector.

When the third coupling point 243 may be located between the fourth position 222 and the second coupling point 242, a relationship between the first element 252 and the second element 253 is similar to a parallel connection relationship. In an embodiment, the second element 253 may be a capacitor, and may increase an equivalent capacitance between the first coupling point 241 and the third coupling point 253. In an embodiment, when the equivalent capacitance value of the first element 252 is 2 pF, a loss is high, and the loss can be reduced via the second element 253 in a case in which a same effect (for example, a same radiation aperture) is ensured (the equivalent capacitance value of the first element 252 is 1 pF, an equivalent capacitance value of the second element 253 is 1 pF, and an equivalent capacitance value between the first coupling point 241 and the third coupling point 253 is 2 pF), to improve the radiation characteristic of the antenna. In an embodiment, the second element may be an inductor, and may be configured to reduce the radiation aperture of the second radiator. The radiation aperture of the second radiator is adjusted via both the first element and the second element, to achieve a parasitic resonance on an expected frequency band.

It should be understood that the third coupling point 243 may be located at any position on the second radiator 240. This is not limited in this embodiment of this disclosure. When a length of the second radiator between the third coupling point 243 and the first coupling point 241/second coupling point 242 is less than or equal to 5 mm, the radiation aperture of the second radiator 240 may be better adjusted, and the radiation characteristic of the antenna 200 is improved.

In an embodiment, one third coupling point 243 may be separately disposed between the third position 221 and the first coupling point 241, and between the fourth position 222 and the second coupling point 242, and each third coupling point 243 is coupled to the ground plane via the corresponding second element 253.

In an embodiment, a switch may be disposed between the first element 252 and/or the second element 253 and the second radiator 240, and is configured to switch a position of a parasitic resonance, or may be understood as being configured to switch the radiation aperture of the second radiator 240. The switch may be configured to switch the first element 252 and/or the second element 253 having different electrical parameters.

In an embodiment, the switch may be electrically connected between the first end of the first element 252 and the first coupling point 241 or between the second end of the first element 252 and the second coupling point 242. The switch may be configured to switch the first element 252 with different electrical parameters, so that the radiation aperture of the second radiator 240 may be switched.

In an embodiment, the second element 253 may include an inductor, a capacitor, and a 0-ohm resistor. A switch is disposed between the second element 253 and the third coupling point 243, or a switch is disposed between the second element 253 and the ground, and the second element 253 or the inductor, the capacitor, or the 0-ohm resistor is switched via the switch. Alternatively, the switch may be configured to switch a position of the third coupling point 243, so that the third coupling point 243 may be located between the fourth position 222 and the second coupling point 242 or between the third position 221 and the first coupling point 241. For example, when the second element 253 is an inductor, the third coupling point 243 is located between the third position 221 and the first coupling point 241, so that the radiation diameter of the second radiator 240 increases; and the third coupling point 243 is located between the fourth position 222 and the second coupling point 242, so that the radiation diameter of the second radiator 240 decreases.

In an embodiment, the second slot at the second position 212 and the fourth slot provided on the second radiator 240 at least partially overlap in a first direction (for example, a z direction). Alternatively, the second slot at the second position 212 and the third slot at the fourth position 222 at least partially overlap in a first direction (for example, a z direction).

It should be understood that, when the second slot at the second position 212 and the fourth slot (or the third slot at the fourth position 222) partially overlap in the first direction, and when an electrical signal is fed through the first feed point 231, the second radiator 240 may obtain more energy by using an electric field at the slot through coupling, to improve a radiation characteristic of a resonance generated by the second radiator.

In an embodiment, the second element 253 may be an inductor or an element equivalent to an inductor.

In an embodiment, an equivalent inductance value of the second element 253 may be less than or equal to 10 nH.

It should be understood that, the equivalent inductance value of the second element 253 is designed based on different resonance point frequencies of the first parasitic resonance for the current distribution on the second radiator 240 to be even, so that the conductor loss and the dielectric loss are reduced, and the radiation aperture of the second radiator 240 is increased, to improve the radiation characteristic of the antenna.

In an embodiment, the first element 252 may be a capacitor or an element equivalent to a capacitor.

In an embodiment, the equivalent capacitance value of the first element 252 may be less than or equal to a first threshold. The first threshold may be designed based on a resonance point frequency of the first parasitic resonance generated by the second radiator 240. When the resonance point frequency of the first parasitic resonance is less than or equal to 1 GHz, the first threshold is 10 pF. When the resonance point frequency of the first parasitic resonance is greater than 1 GHz, the first threshold is 2 pF.

It should be understood that, the equivalent inductance value of the first element 252 is designed based on different resonance point frequencies of the first parasitic resonance for the current distribution on the second radiator 240 to be even, so that the conductor loss and the dielectric loss are reduced, and the radiation aperture of the second radiator 240 is increased, to improve the radiation characteristic of the antenna.

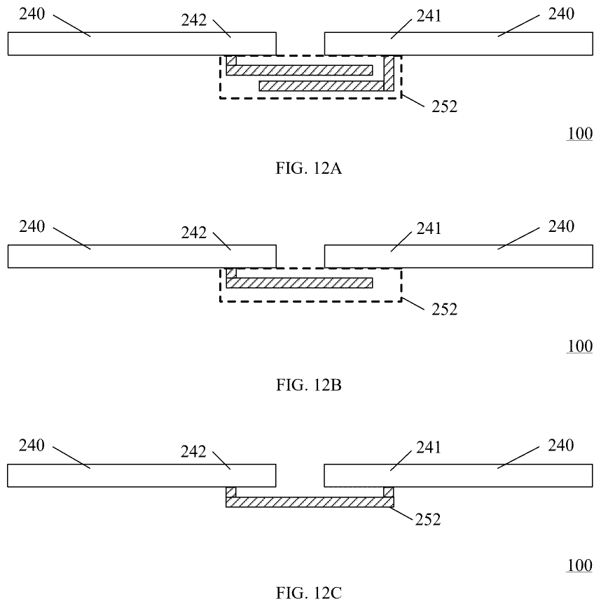

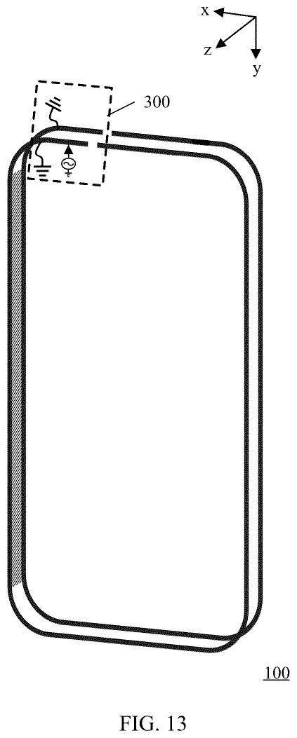

In an embodiment, when the first element 252 is a capacitor, a distributed capacitor structure formed by extending conductors on two sides (for example, at the first coupling point 241 and/or the second coupling point 242) of the fourth slot to the electronic device may be used for implementation, as shown in FIGS. 12A-12B. In an embodiment, when the first element 252 is an inductor, a metal piece electrically connected between the first coupling point 241 and the second coupling point 242 may be equivalent to an inductor, as shown in FIG. 12C. It should be understood that, for brevity of description, only the first element 252 is used as an example for description, and the element described in this embodiment of this disclosure may be implemented by using a distributed component or a lumped component.

FIG. 13 is a diagram of another foldable electronic device 100 according to an embodiment of this disclosure.

As shown in FIG. 13, the foldable electronic device 100 includes an antenna 300.

It should be understood that a difference between the antenna 300 shown in FIG. 13 and the antenna 200 shown in FIG. 11 lies only in that a parasitic stub (a second radiator) does not include a first coupling point, a second coupling point, and a third coupling point, and a first element and a fourth slot are not provided on the second radiator.

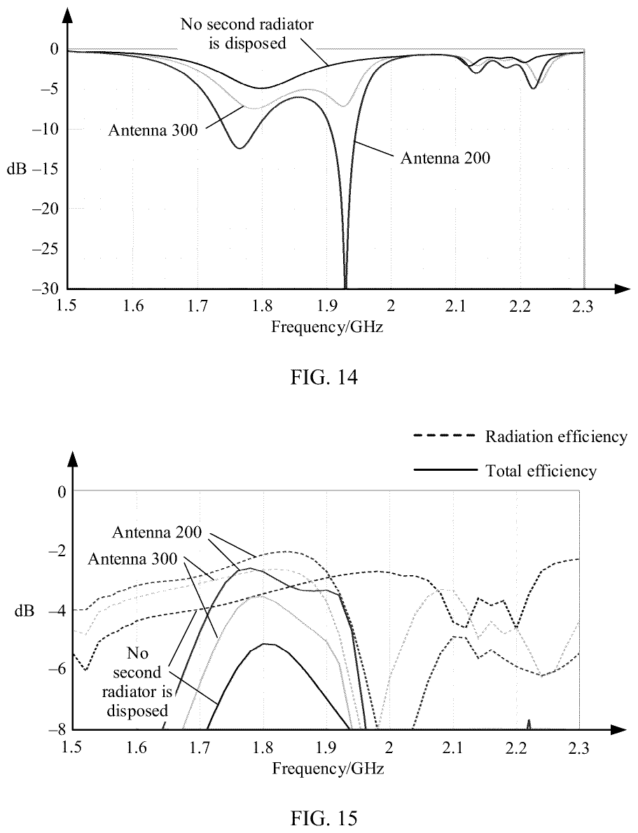

FIG. 14 and FIG. 15 are diagrams of simulation results of the antennas shown in FIG. 11 and FIG. 13. FIG. 14 is a diagram of S parameter simulation results of the antennas shown in FIG. 11 and FIG. 13. FIG. 15 shows simulation results of radiation efficiency and total efficiency of the antennas shown in FIG. 11 and FIG. 13.

As shown in FIG. 14, the S parameter simulation results of the antennas shown in FIG. 11 and FIG. 13 are shown.

When the foldable electronic device is in a folded state and no second radiator is disposed, the antenna generates a resonance only by a first radiator near 1.8 GHz.

When the foldable electronic device is in the folded state, the antenna 300 shown in FIG. 13 may generate two resonances near 1.8 GHz and near 1.9 GHZ. The resonance (a first parasitic resonance) near 1.9 GHz may be generated by the second radiator.

When the foldable electronic device is in the folded state, the antenna 200 shown in FIG. 11 may generate two resonances near 1.8 GHz and near 1.9 GHz. The resonance (the first parasitic resonance) near 1.9 GHz may be generated by the second radiator. When S11<−5 dB, an operating bandwidth of the antenna 200 shown in FIG. 11 is wider than an operating bandwidth of the antenna 300 shown in FIG. 13.

As shown in FIG. 15, compared with those in a case in which the foldable electronic device is in the folded state and no second radiator is disposed, and only the first radiator generates a resonance, in a case in which the antennas shown in FIG. 11 and FIG. 13 each generate a resonance by using the first radiator and the second radiator, both total efficiency and radiation efficiency are improved.

In the antenna 200 shown in FIG. 11, the second radiator is coupled to a ground plane at the first coupling point via the first element, so that when the second radiator obtains energy from the first radiator through coupling to generate a resonance, a current density on the second radiator can be dispersed, strength of a single current strong point is reduced, and current distribution is even. This reduces a loss caused by the second radiator, and a conductor and a medium that are disposed around the second radiator. In addition, a slot provided on the second radiator may further increase a radiation aperture, thereby improving total efficiency and radiation efficiency of the antenna 200. Therefore, compared with the antenna 300 shown in FIG. 13, the antenna 200 shown in FIG. 11 has higher radiation efficiency and total efficiency.

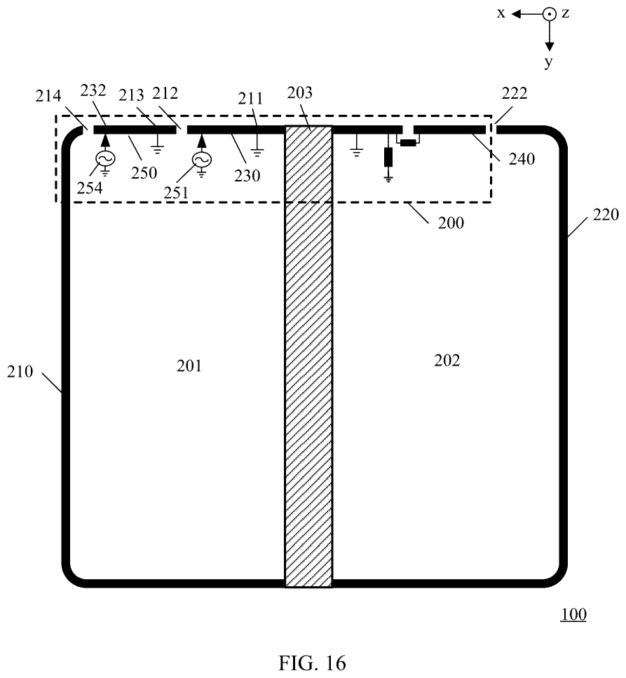

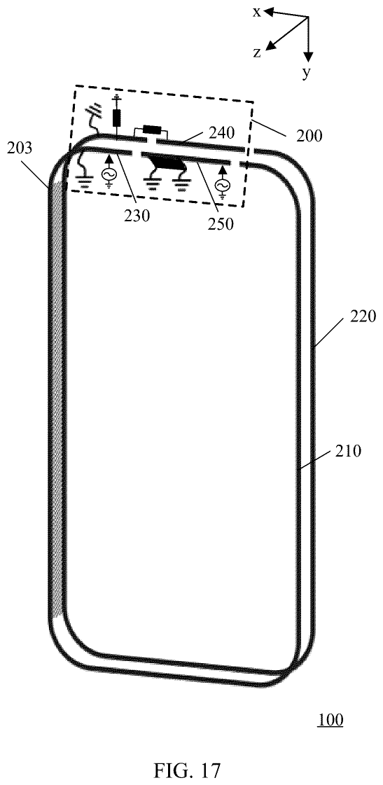

FIG. 16 is a diagram of the foldable electronic device 100 according to an embodiment of this disclosure.

As shown in FIG. 16, the antenna 200 includes a third radiator 250 and a second feed circuit 254. The third radiator 250 includes a second feed point 232, and the second feed circuit 254 is coupled to the second feed point 232.

The first side frame 210 includes a fifth position 213 and a sixth position 214. The second position 212 is located between the fifth position 213 and the first position 211, and the fifth position 213 is located between the second position 212 and the sixth position 214. The third radiator 250 is a conductive part between the fifth position 213 and the sixth position 214. In an embodiment, the first side frame 210 is coupled to a ground plane at the fifth position 213, and is provided with a fifth slot at the sixth position 214.

As shown in FIG. 17, when the foldable electronic device 100 is in a folded state, the third radiator 250 and the second radiator 240 at least partially overlap in a first direction, and the first direction is a thickness direction of the foldable electronic device 100, for example, a z direction.

It should be understood that a difference between the antenna 200 shown in FIG. 17 and the antenna 200 shown in FIG. 10 lies only in that the third radiator 250 and the second feed circuit 254 are added.

The first radiator 230 and the first feed circuit 251 may form a first antenna element. The third radiator 250 and the second feed circuit 252 may form a second antenna element. The second radiator 240 may be used as a parasitic stub of both the first antenna element and the second antenna element, and is configured to improve radiation characteristics of the first antenna element and the second antenna element. In addition, because the first antenna element and the second antenna element may reuse the second radiator 240, an overall structure of the antenna can be miniaturized while the radiation characteristics of the first antenna element and the second antenna element are improved.

In an embodiment, the second radiator 240 may be configured to generate a first parasitic resonance. The first parasitic resonance may be used to improve the radiation characteristics of the first antenna element and the second antenna element.

In an embodiment, the first side frame 210 may be coupled to the ground plane at the fifth position 213 via a ground member. In an embodiment, a width of the ground member may be greater than or equal to 2 mm, so that the first antenna element and the second antenna element have good isolation.

In an embodiment, a third slot at the fourth position 222 and a fifth slot at the sixth position 214 at least partially overlap in the first direction (for example, the z direction). In an embodiment, a second slot at the second position 212 and a fourth slot are aligned (at least partially overlap) in the first direction (for example, the z direction).

It should be understood that, when the corresponding slots partially overlap in the first direction, and when an electrical signal is fed through a feed point, the second radiator 240 may obtain more energy by using electric fields in the slots through coupling, so that a radiation characteristic of a resonance generated by the second radiator is improved.

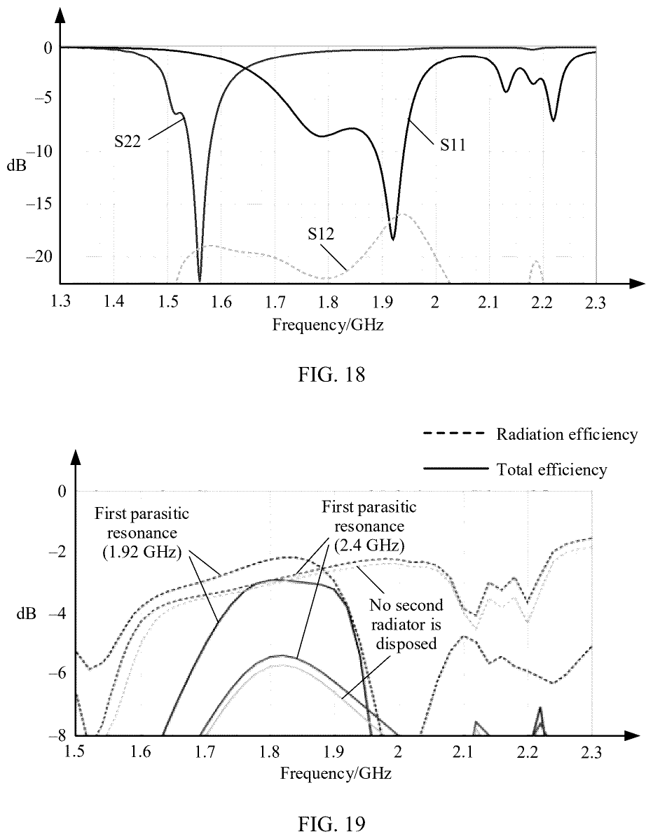

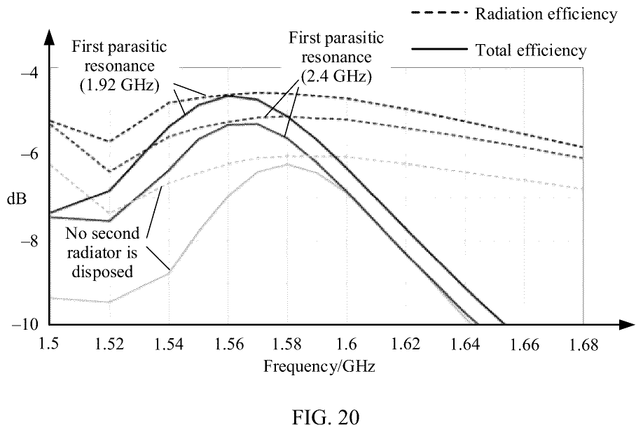

FIG. 18 to FIG. 20 are diagrams of a simulation result of the antenna shown in FIG. 17. FIG. 18 is a diagram of an S parameter simulation result of the antenna shown in FIG. 17. FIG. 19 shows simulation results of radiation efficiency and total efficiency of a first antenna element in the antenna shown in FIG. 17. FIG. 20 shows simulation results of radiation efficiency and total efficiency of a second antenna element in the antenna shown in FIG. 17.

As shown in FIG. 18, the simulation result of the S parameter of the antenna shown in FIG. 17 is shown.

The first antenna element (S11) may generate resonances near 1.8 GHz and near 1.92 GHz. The resonance (a first resonance) generated near 1.8 GHz may be generated by the first radiator, and the resonance (a first parasitic resonance) generated near 1.92 GHz may be generated by the second radiator.

The second antenna element (S22) may generate a resonance near 1.56 GHZ, and the resonance (a second resonance) may be generated by the third radiator.

In the foregoing frequency band, isolation (S12) between the first antenna element and the second antenna element is less than −15 dB, and there is good isolation between the two antenna elements.

It should be understood that, in the foregoing embodiment, only an example in which the first antenna element and the second antenna element have different operating frequency bands is used for description, and the first parasitic resonance may be used to expand an operating bandwidth of a first antenna.

As shown in FIG. 19, when the foldable electronic device is in a folded state, in comparison with a case in which no second radiator is disposed in the foldable electronic device, and the first antenna generates a resonance only by using the first radiator, in a case in which the first antenna element generates a resonance by using the first radiator and the second radiator, both total efficiency and radiation efficiency are improved.

In addition, when a resonance point of the first parasitic resonance is located at 1.92 GHz, total efficiency and radiation efficiency of the first antenna element are better than those in a case in which the first parasitic resonance is located at 2.4 GHz.

As shown in FIG. 20, when the foldable electronic device is in the folded state, in comparison with a case in which no second radiator is disposed in the foldable electronic device and only a resonance is generated by using the third radiator, in a case in which the second radiator is disposed, both total efficiency and radiation efficiency of the second antenna element are improved.

It should be understood that the resonance point of the first parasitic resonance generated by the second radiator is located at 1.92 GHz or 2.4 GHz, and is far away from a resonance point (at 1.56 GHz) of the second resonance generated by the third radiator, and is not displayed in the S parameter shown in FIG. 18. However, the first parasitic resonance significantly improves total efficiency and radiation efficiency of the second antenna element.

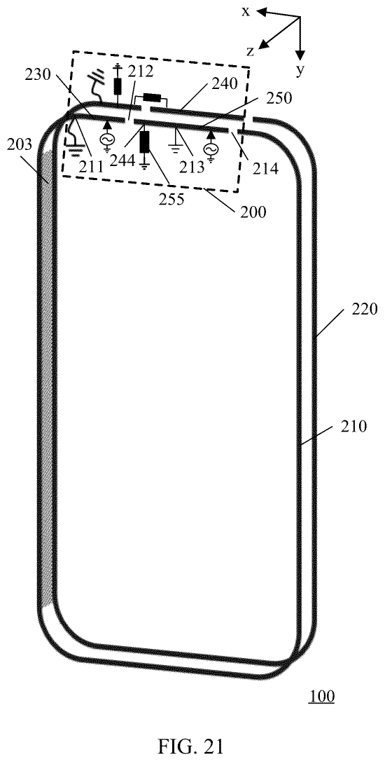

FIG. 21 is a diagram of the foldable electronic device 100 according to an embodiment of this disclosure.

As shown in FIG. 21, the third radiator 250 is a conductive part between the second position 212 and the sixth position 214. The first side frame 210 is coupled to the ground plane at the fifth position 213, and is provided with a sixth slot at the sixth position 214.

The antenna 200 may further include a third element 255. The third radiator 250 may further include a fourth coupling point 244. A first end of the third element 255 is coupled to the fourth coupling point 244, and a second end is coupled to the ground plane. The third element 255 may be configured to enable the third radiator 250 to operate in a DM mode.

It should be understood that a difference between the antenna 200 shown in FIG. 21 and the antenna 200 shown in FIG. 17 lies only in that the third radiator 250 has different operating modes. In the antenna 200 shown in FIG. 17, a first end of the third radiator 250 is coupled to the ground plane as a ground end, and a second end is an open end for operating in a quarter-wave mode. In the antenna 200 shown in FIG. 21, a first end and a second end of the third radiator 250 are open ends, and form a T-shaped structure for operating in a wire DM mode.

In an embodiment, a distance between the second position 212 and the fourth coupling point 244 is less than or equal to a half of a distance between the second position 212 and the fifth position 213.

In an embodiment, the third element 255 may be a capacitor or an element equivalent to a capacitor.

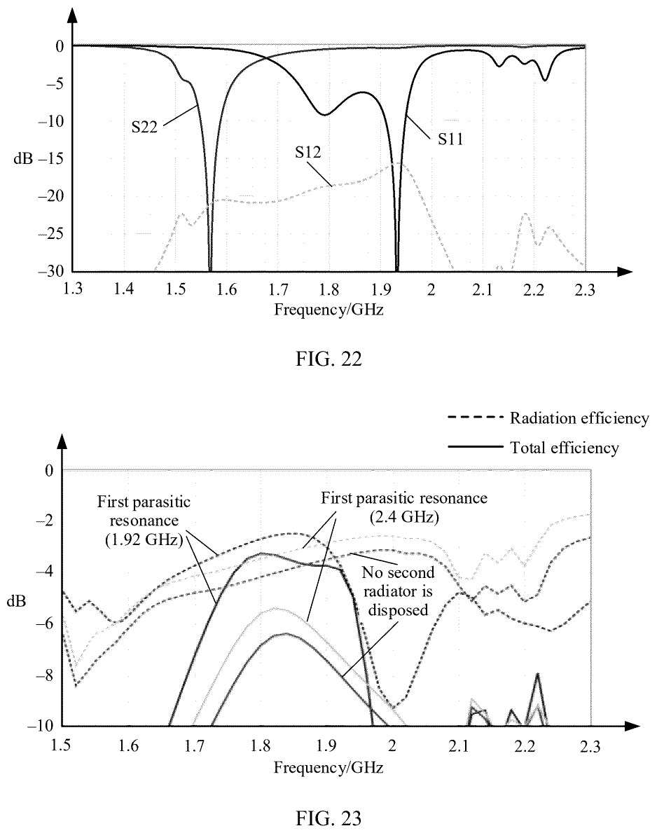

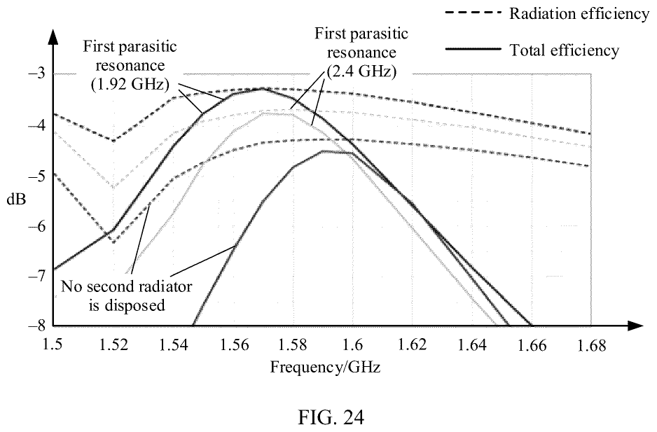

FIG. 22 to FIG. 24 are diagrams of a simulation result of the antenna shown in FIG. 21. FIG. 22 is a diagram of an S parameter simulation result of the antenna shown in FIG. 21. FIG. 23 shows simulation results of radiation efficiency and total efficiency of a first antenna element in the antenna shown in FIG. 21. FIG. 24 shows simulation results of radiation efficiency and total efficiency of a second antenna element in the antenna shown in FIG. 21.

As shown in FIG. 22, the simulation result of the S parameter of the antenna shown in FIG. 32 is shown.

The first antenna element (S11) may generate resonances near 1.8 GHz and near 1.92 GHz. The resonance (a first resonance) generated near 1.8 GHz may be generated by the first radiator, and the resonance (a first parasitic resonance) generated near 1.92 GHz may be generated by the second radiator.

The second antenna element (S22) may generate a resonance near 1.58 GHz, and the resonance (a second resonance) may be generated by the third radiator.

In the foregoing frequency band, isolation (S12) between the first antenna element and the second antenna element is less than −15 dB, and there is good isolation between the two antenna elements.

As shown in FIG. 23, when the foldable electronic device is in a folded state, in comparison with a case in which no second radiator is disposed in the foldable electronic device, and only a resonance is only generated by using the first radiator, in a case in which the first antenna element generates a resonance by using the first radiator and the second radiator, both total efficiency and radiation efficiency are improved.

In addition, when a resonance point of the first parasitic resonance is located at 1.92 GHz, total efficiency and radiation efficiency of the first antenna element are better than those in a case in which the first parasitic resonance is located at 2.4 GHz.

As shown in FIG. 24, when the foldable electronic device is in the folded state, in comparison with a case in which no second radiator is disposed in the foldable electronic device and only a second antenna generates a resonance by using the third radiator, in a case in which the second radiator is disposed, both total efficiency and radiation efficiency of the second antenna element are improved.

It should be understood that the resonance point of the first parasitic resonance generated by the second radiator is located at 1.92 GHz or 2.4 GHz, and is far away from a resonance point (at 1.56 GHz) of the second resonance generated by the third radiator, and is not displayed in the S parameter shown in FIG. 18 for the second antenna. However, the first parasitic resonance significantly improves total efficiency and radiation efficiency of the second antenna element.

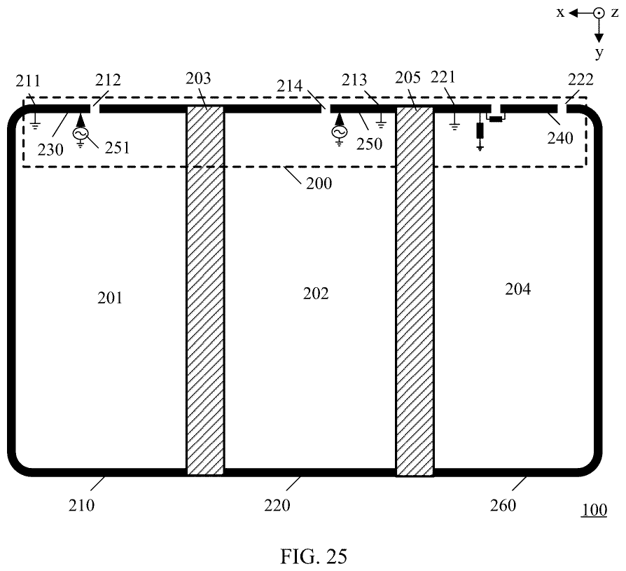

FIG. 25 is a diagram of the foldable electronic device 100 according to an embodiment of this disclosure.

It should be understood that, in the foregoing embodiment, only an example in which the foldable electronic device 100 (for example, a two-fold electronic device) includes only two housings is used for description. In actual production or design, the technical solutions provided in embodiments of this disclosure may also be applied to a plurality of housings (for example, a multi-fold electronic device). As shown in FIG. 25, only an example in which the foldable electronic device 100 includes three housings is used for description.

As shown in FIG. 25, the foldable electronic device 100 may further include a third housing 204 and a second rotating shaft 205. The second rotating shaft 205 is located between the second housing 202 and the third housing 204, and the second rotating shaft 205 is rotatably connected to the second housing 202 and the third housing 204, so that the second housing 202 and the third housing 204 can rotate relative to each other.

The third housing 204 may include a third side frame 260.

The third position 221 and the fourth position 222 may be located on the third side frame 260. The fifth position 213 and the sixth position 214 may be located on the second side frame 220. The first radiator 210 is a conductive part between the first position 211 and the second position 212. The second radiator 220 is a conductive part between the third position 221 and the fourth position 222. The third radiator 250 includes a conductive part between the fifth position 213 and the sixth position 214.

It should be understood that, a difference between the antenna 200 shown in FIG. 25 and the antenna 200 shown in FIG. 16 lies only in that the third position 221 and the fourth position 222, and the fifth position 213 and the sixth position 214 are different. The first radiator 230 and the third radiator 250 are respectively located on the first housing 201 and the second housing 202, and the second radiator 240 is located on the third housing 204.

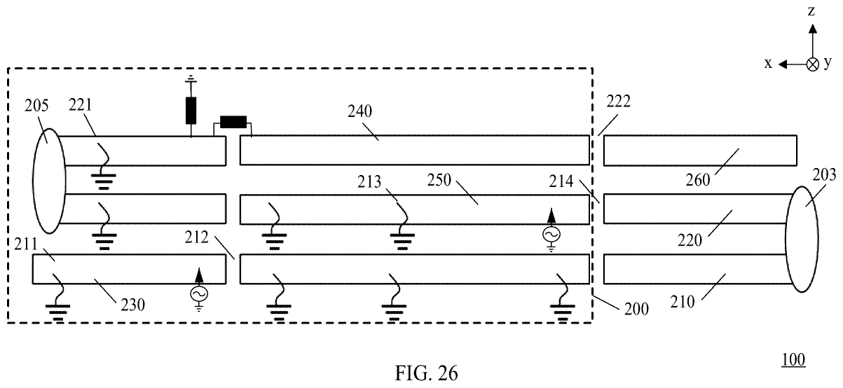

The first radiator 230 and the second radiator 240 at least partially overlap in a first direction, the second radiator 240 and the third radiator 250 at least partially overlap in the first direction, and the first direction is a thickness direction of the foldable electronic device 100, for example, a z direction, as shown in FIG. 26.

In an embodiment, the third radiator 250 is configured to generate a second resonance. In an embodiment, a resonance frequency band of a first resonance generated by the first radiator 230 and a resonance frequency band of the second resonance generated by the third radiator 250 have the same frequency or are adjacent.

It should be understood that, for brevity of description, this embodiment of this disclosure is described only by using an example in which the resonance frequency band of the first resonance and the resonance frequency band of the second resonance have the same frequency.

In an embodiment, the resonance frequency band of the first resonance and the resonance frequency band of the second resonance have the same frequency or are adjacent, and the first parasitic resonance may be close to both the first resonance and the second resonance, and may be used to improve radiation performance of both a first antenna element and a second antenna element. In an embodiment, a difference between a resonance point frequency of the first parasitic resonance and a resonance point frequency of the first resonance is less than or equal to 200 MHZ, and a difference between the resonance point frequency of the first parasitic resonance and the resonance point frequency of the second resonance is less than or equal to 200 MHz.

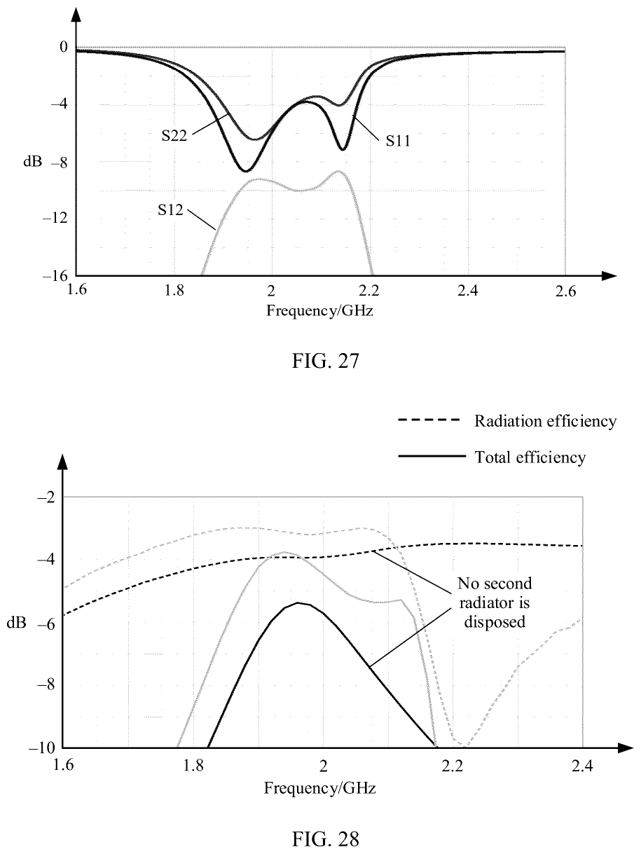

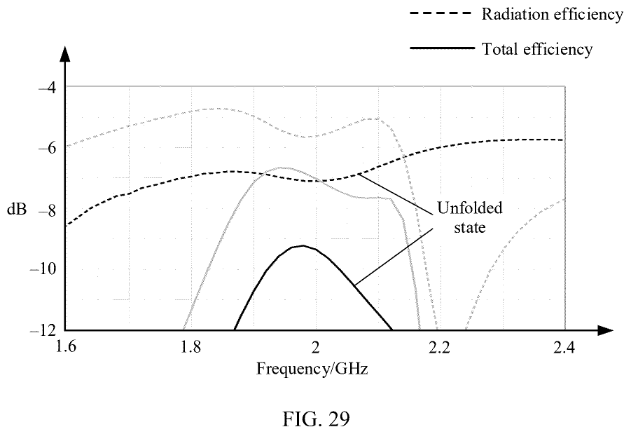

FIG. 27 to FIG. 29 are diagrams of a simulation result of the antenna shown in FIG. 25. FIG. 27 is a diagram of an S parameter simulation result of the antenna shown in FIG. 25. FIG. 28 shows simulation results of radiation efficiency and total efficiency of a first antenna element in the antenna shown in FIG. 25. FIG. 29 shows simulation results of radiation efficiency and total efficiency of a second antenna element in the antenna shown in FIG. 25.

As shown in FIG. 27, the simulation result of the S parameter of the antenna shown in FIG. 25 is shown.

The first antenna element (S11) may generate resonances near 1.95 GHz and near 2.15 GHz. The resonance (a first resonance) generated near 1.95 GHz may be generated by the first radiator, and the resonance (a first parasitic resonance) generated near 2.15 GHz may be generated by the second radiator.

The second antenna element (S22) may generate resonances near 1.95 GHz and near 2.15 GHz. The resonance (a second resonance) generated near 1.95 GHz may be generated by the third radiator, and the resonance (the first parasitic resonance) generated near 2.15 GHz may be generated by the second radiator.

In the foregoing frequency band, because the first antenna element and the second antenna element reuse the first parasitic resonance generated by the second radiator to expand an operating bandwidth, isolation (S12) between the first antenna element and the second antenna element is reduced compared with that in the foregoing embodiment, and the isolation between the first antenna element and the second antenna element is less than −9 dB.

It should be understood that, in the foregoing embodiment, only an example in which the first antenna element and the second antenna element are at a same frequency is used for description. The first antenna element and the second antenna element may include a same communication frequency band, and are used as subunits in a MIMO system.

As shown in FIG. 28, when the foldable electronic device is in a folded state, in comparison with a case in which no second radiator is disposed in the foldable electronic device, and a resonance is only generated by using the first radiator, in a case in which the first antenna element generates a resonance by using the first radiator and the second radiator, both total efficiency and radiation efficiency are improved, where the total efficiency is improved by about 1.5 dB, and the radiation efficiency is improved by about 1 dB.

As shown in FIG. 29, when the foldable electronic device is in a folded state, in comparison with a case in which no second radiator is disposed in the foldable electronic device, and a resonance is only generated by using the third radiator, in a case in which the second antenna element generates a resonance by using the third radiator and the second radiator, both total efficiency and radiation efficiency are improved, where the total efficiency is improved by about 2.5 dB, and the radiation efficiency is improved by about 2 dB.

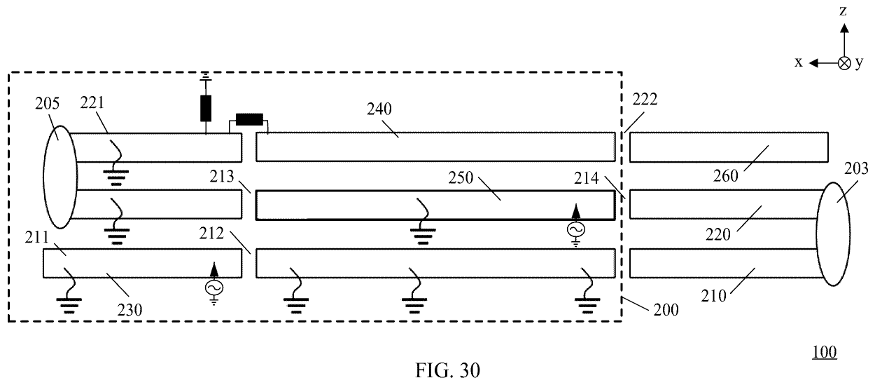

FIG. 30 is a diagram of the foldable electronic device 100 according to an embodiment of this disclosure.

As shown in FIG. 30, the second side frame 220 is provided with a fifth slot and a sixth slot respectively at the fifth position 213 and the sixth position 214. The second side frame 220 between the fifth position 213 and the sixth position 214 includes a ground point, and the second side frame 220 is coupled to a ground plane at the ground point.

In an embodiment, the ground point may be located in a central area of the second side frame 220 between the fifth position 213 and the sixth position 214. The central area may be understood as an area within 5 mm away from a center. A physical length between the center and the fifth position 213 is the same as a physical length between the center and the sixth position 214, or an electrical length between the center and the fifth position 213 is the same as an electrical length between the center and the sixth position 214.

It should be understood that, in the antenna 200 shown in FIG. 26, a first end of the third radiator 250 is coupled to the ground plane as a ground end, and a second end is an open end for operating in a quarter-wave mode. In the antenna 200 shown in FIG. 30, a first end and a second end of the third radiator 250 are open ends, and form a symmetrical T-shaped structure for operating in a wire CM mode.

In an embodiment, currents on the third radiator 250 are reversely distributed on two sides of the ground point, for example, are symmetrically distributed. Correspondingly, the third radiator 250 may operate in the wire CM mode.

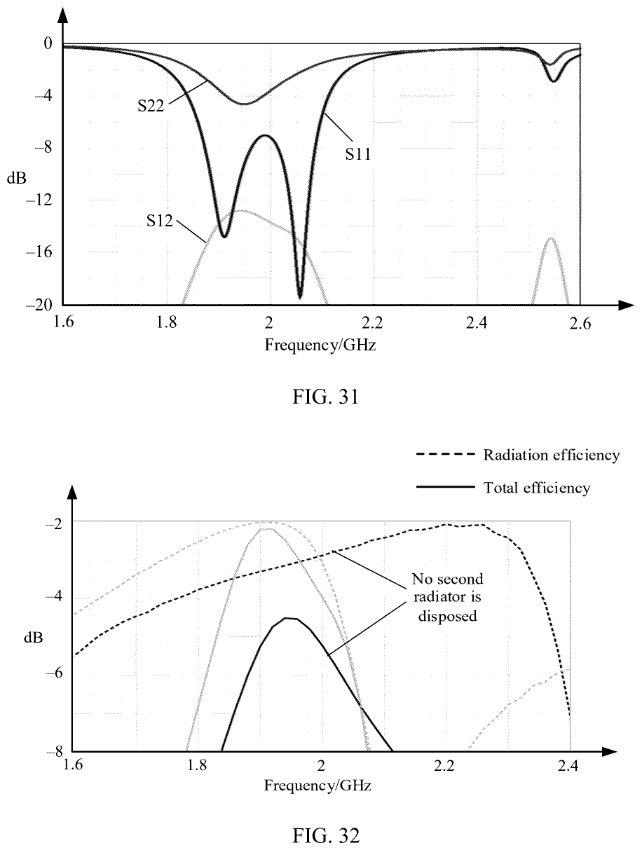

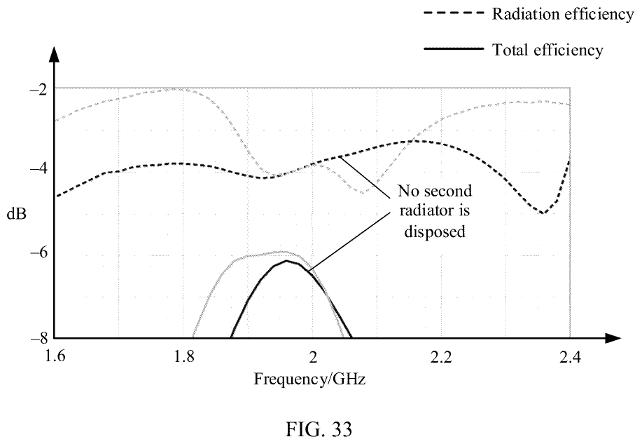

FIG. 31 to FIG. 33 are diagrams of a simulation result of the antenna shown in FIG. 30. FIG. 31 is a diagram of an S parameter simulation result of the antenna shown in FIG. 30. FIG. 32 shows simulation results of radiation efficiency and total efficiency of a first antenna element in the antenna shown in FIG. 30. FIG. 33 shows simulation results of radiation efficiency and total efficiency of a second antenna element in the antenna shown in FIG. 30.

As shown in FIG. 31, the simulation result of the S parameter of the antenna shown in FIG. 30 is shown.

The first antenna element (S11) may generate resonances near 1.9 GHZ and near 2.15 GHz. The resonance (a first resonance) generated near 1.9 GHz may be generated by the first radiator, and the resonance (a first parasitic resonance) generated near 2.15 GHz may be generated by the second radiator.

The second antenna element (S22) may generate a resonance near 1.95 Hz, and the resonance (a second resonance) may be generated by the third radiator.

It should be understood that the third radiator operates in a wire CM mode, and currents on the third radiator are reversely distributed, for example, are symmetrically distributed. However, the second radiator operates in a quarter-wavelength mode, and currents on the second radiator are co-directionally distributed. Therefore, when an electrical signal is fed to the third radiator, the second radiator cannot be excited to generate a first parasitic resonance, and the second antenna element cannot use the first parasitic resonance to expand an operating bandwidth. However, because the second antenna element cannot use the first parasitic resonance, isolation (S12) between the first antenna element and the second antenna element is good, and is less than −13 dB.

As shown in FIG. 32, when the foldable electronic device is in a folded state, in comparison with a case in which no second radiator is disposed in the foldable electronic device, and a resonance is only generated by using the first radiator, in a case in which the first antenna element generates a resonance by using the first radiator and the second radiator, both total efficiency and radiation efficiency are improved, where the total efficiency is improved by about 3 dB, and the radiation efficiency is improved by about 1.5 dB.

As shown in FIG. 33, because the second antenna element cannot use the first parasitic resonance, total efficiency and radiation efficiency of the second antenna element are not significantly improved.

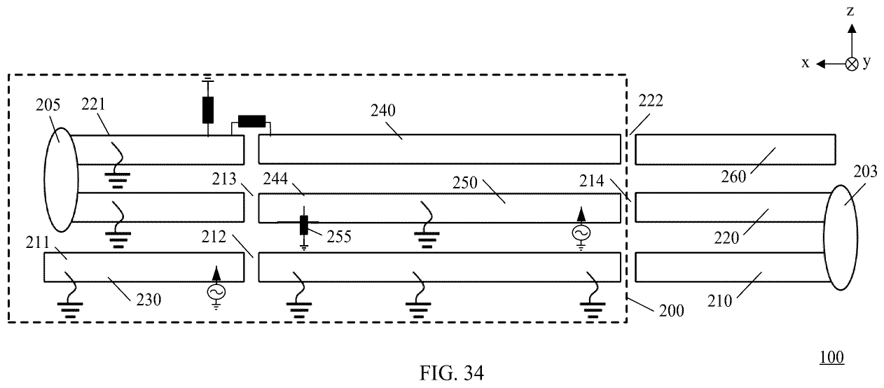

FIG. 34 is a diagram of the foldable electronic device 100 according to an embodiment of this disclosure.

As shown in FIG. 34, the antenna 200 may further include a third element 255. The third radiator 250 may further include a fourth coupling point 244, and the fourth coupling point 244 is located between the fifth position 213 and a ground point. A first end of the third element 255 is coupled to the fourth coupling point 244, and a second end is coupled to the ground plane.

It should be understood that, compared with the antenna 200 shown in FIG. 30, a difference between the antenna 200 shown in FIG. 34 and the antenna 200 shown in FIG. 30 lies only in that the third element 255 is disposed. In the antenna 200 shown in FIG. 30, the third radiator 250 may operate in a wire CM mode, and currents on the third radiator 250 are reversely distributed on two sides of the ground point, for example, are symmetrically distributed. In the antenna 200 shown in FIG. 34, the third element 255 may be configured to change a boundary condition of the third radiator 250, so that the third radiator 250 may operate in the wire DM mode, and currents on the third radiator 250 are co-directionally distributed on two sides of the ground point, for example, are anti-symmetrically distributed.

In an embodiment, a distance between the fifth position 213 and the fourth coupling point 244 is less than or equal to a half of a distance between the fifth position 213 and the ground point.

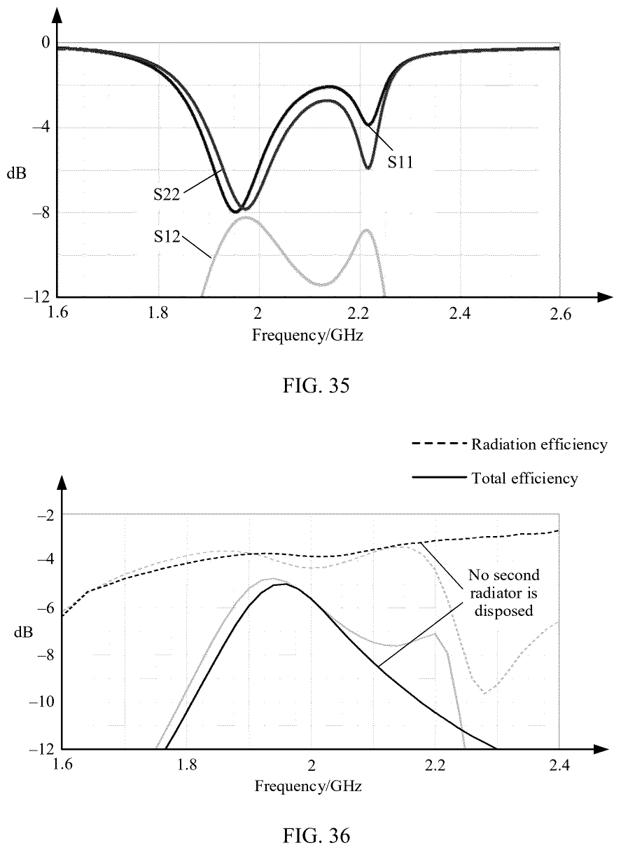

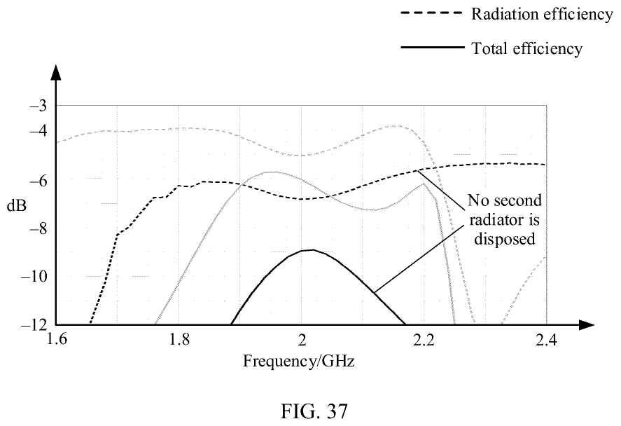

FIG. 35 to FIG. 37 are diagrams of a simulation result of the antenna shown in FIG. 34. FIG. 35 is a diagram of an S parameter simulation result of the antenna shown in FIG. 34. FIG. 36 shows simulation results of radiation efficiency and total efficiency of a first antenna element in the antenna shown in FIG. 34. FIG. 37 shows simulation results of radiation efficiency and total efficiency of a second antenna element in the antenna shown in FIG. 34.

As shown in FIG. 35, the simulation result of the S parameter of the antenna shown in FIG. 34 is shown.

The first antenna element (S11) may generate resonances near 1.95 GHz and near 2.2 GHz. The resonance (a first resonance) generated near 1.95 GHz may be generated by the first radiator, and the resonance (a first parasitic resonance) generated near 2.2 GHz may be generated by the second radiator and the third element 255.

The second antenna element (S22) may generate resonances near 1.95 GHz and near 2.2 GHz. The resonance (a second resonance) generated near 1.95 GHz may be generated by the third radiator, and the resonance (a first parasitic resonance) generated near 2.2 GHz may be generated by the second radiator and the third element 255.

In the foregoing frequency band, because the first antenna element and the second antenna element reuse the first parasitic resonance generated by the second radiator to expand an operating bandwidth, isolation (S12) between the first antenna element and the second antenna element is reduced compared with that in the foregoing embodiment, and the isolation between the first antenna element and the second antenna element is less than −8 dB.

As shown in FIG. 36, when the foldable electronic device is in a folded state, in comparison with a case in which no second radiator is disposed in the foldable electronic device, and a resonance is only generated by using the first radiator, in a case in which the first antenna element generates a resonance by using the first radiator and the second radiator, both total efficiency and radiation efficiency are approximately the same.

As shown in FIG. 37, when the foldable electronic device is in a folded state, in comparison with a case in which no second radiator is disposed in the foldable electronic device, and a resonance is only generated by using the first radiator, in a case in which the second antenna element generates a resonance by using the third radiator and the second radiator, both total efficiency and radiation efficiency are improved, where the total efficiency is improved by about 3.5 dB, and the radiation efficiency is improved by about 2 dB.

It should be understood that, with reference to the simulation results shown in FIG. 32, FIG. 33, FIG. 36, and FIG. 37, when the third radiator operates in a CM mode, the second radiator is used a parasitic stub for improving total efficiency and radiation efficiency of the first antenna element well; and when the third radiator operates in a DM mode, the second radiator is used as a parasitic stub for improving total efficiency and radiation efficiency of the second antenna element well.

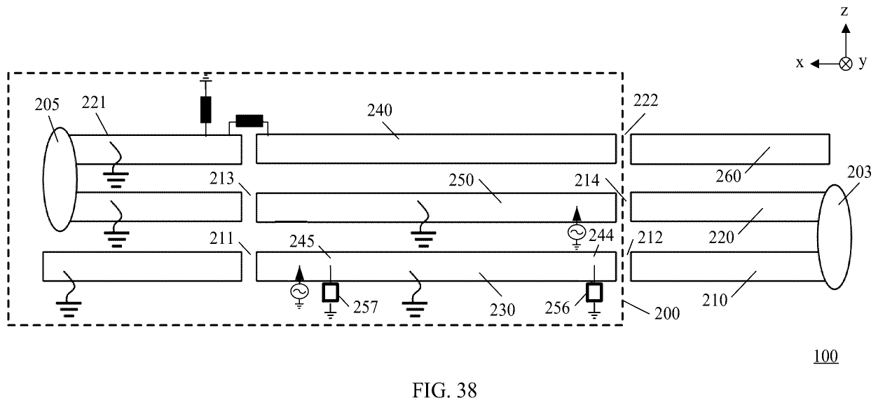

FIG. 38 is a diagram of the foldable electronic device 100 according to an embodiment of this disclosure.

It should be understood that, in the foregoing embodiment, when the antenna 200 includes the third radiator 250, an example in which the first radiator 230 and the third radiator 250 do not overlap in a first direction is used for description. The first direction is a thickness direction of the foldable electronic device 100, for example, a z direction. In the foldable electronic device 100 shown in FIG. 38, the first radiator 230 and the third radiator 250 at least partially overlap in the first direction.

In an embodiment, a first end of the first radiator 230 is an open end, and a second end is an open end. The second side frame 220 between the first position 211 and the second position 212 includes a ground point, and the second side frame 220 is coupled to a ground plane at the ground point for grounding.

In an embodiment, a fourth coupling point 244 is further included between the ground point and the second position 212, and a fifth coupling point 245 is further included between a feed point and the ground point. A first end of a first tuning component 256 is coupled to the fourth coupling point 244, and a second end of first tuning component 256 is coupled to a ground plane. A first end of a second tuning component 257 is coupled to the fifth coupling point 245, and a second end of the second tuning component 257 is coupled to the ground plane. The first tuning component 256 and the second tuning component 257 may be configured to adjust a radiation characteristic of the first radiator 230, for example, may be configured to adjust an operating mode of the first radiator.

For brevity of description, an example in which the first radiator 230 may operate in a wire DM mode is used for description. In an actual application, the first tuning component 256 and the second tuning component 257 may enable the first radiator 230 to operate in different operating modes. In an embodiment, the first tuning component 256 and the second tuning component 257 are adjusted, so that the first radiator 230 may operate in a wire CM mode. In an embodiment, when the first tuning component 256 is equivalent to a short circuit, the first radiator 230 may generate radiation through a part between the first position 211 and the ground point, and operate in a quarter-wavelength mode. In an embodiment, when the first tuning component 256 is equivalent to a short circuit, the second tuning component 257 is adjusted, so that a part between the first position 211 of the first radiator 230 and the ground point may form a slot antenna structure on a first side frame on the other side of the first position 211 for operating in the slot CM mode or slot DM mode.

In an embodiment, a distance between the fourth coupling point 244 and the second position 212 is less than a half of a distance between the ground point and the second position 212. In an embodiment, a distance between the fifth coupling point 245 and the first position 211 is less than a half of a distance between the ground point and the first position 211.

In an embodiment, a first end of the third radiator 250 is an open end, and a second end of the third radiator 250 is an open end. The second side frame 220 between the fifth position 213 and the sixth position 214 includes the ground point, and the second side frame 220 is coupled to the ground plane at the ground point for grounding, so that the third radiator 250 may operate in the wire CM mode.

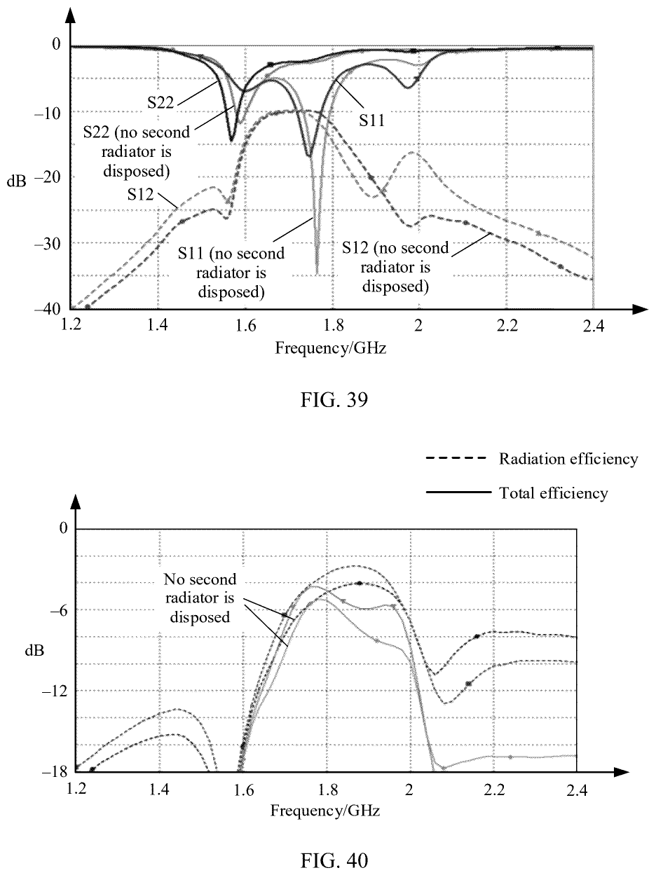

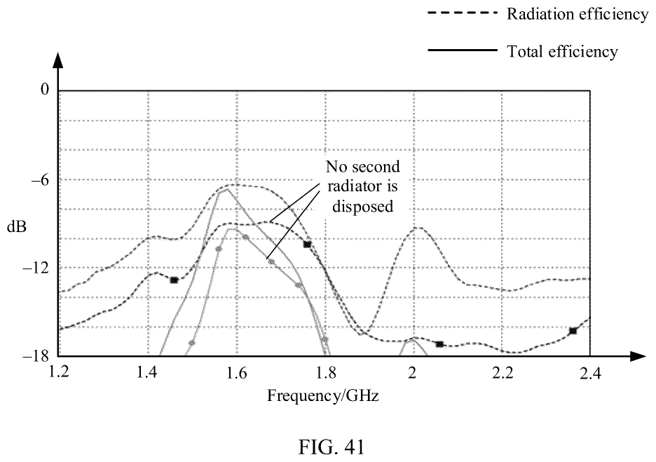

FIG. 39 to FIG. 41 are diagrams of a simulation result of the antenna shown in FIG. 38. FIG. 39 is a diagram of an S parameter simulation result of the antenna shown in FIG. 38. FIG. 40 shows simulation results of radiation efficiency and total efficiency of a first antenna element in the antenna shown in FIG. 38. FIG. 41 shows simulation results of radiation efficiency and total efficiency of a second antenna element in the antenna shown in FIG. 38.

As shown in FIG. 39, the simulation result of the S parameter of the antenna shown in FIG. 38 is shown.

When the second radiator is not disposed, the first antenna element (S11) may generate resonances near 1.6 GHz and 1.7 GHZ. The resonance generated near 1.6 GHz may be generated by the first radiator in a wire CM mode, and the resonance (a first resonance) generated near 1.7 GHz may be generated by the first radiator in a wire DM mode. When the second radiator is disposed, the first antenna element (S11) may additionally generate a new resonance (a first parasitic resonance) by using the second radiator near 2 GHz.

The second antenna element (S22) may generate a resonance near 1.6 GHZ, and the resonance (a second resonance) may be generated by the third radiator.

In the foregoing frequency band, isolation (S12) between the first antenna element and the second antenna element is less than −10 dB, and there is good isolation between the two antenna elements.

As shown in FIG. 40, when the foldable electronic device is in a folded state, in comparison with a case in which no second radiator is disposed in the foldable electronic device, and a resonance is only generated by using the first radiator, in a case in which the first antenna element generates a resonance by using the first radiator and the second radiator, both total efficiency and radiation efficiency are improved, where the total efficiency is improved by about 1.5 dB, and the radiation efficiency is improved by about 1.5 dB.

As shown in FIG. 41, when the foldable electronic device is in a folded state, in comparison with a case in which no second radiator is disposed in the foldable electronic device, and a resonance is only generated by using the first radiator, in a case in which the second antenna element generates a resonance by using the third radiator, both total efficiency and radiation efficiency are improved, where the total efficiency is improved by about 2 dB, and the radiation efficiency is improved by about 2 dB.

It should be understood that a resonance point of the first parasitic resonance generated by the second radiator is located at 2 GHz, and is far away from a resonance point (at 1.6 GHZ) of the second resonance generated by the third radiator, and is not displayed in the S parameter shown in FIG. 39 for the second antenna. However, the first parasitic resonance significantly improves total efficiency and radiation efficiency of the second antenna element.

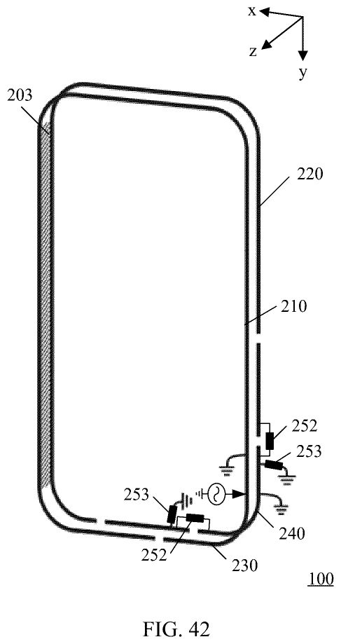

FIG. 42 is a diagram of the foldable electronic device 100 according to an embodiment of this disclosure.

It should be understood that, in the foregoing embodiment, only an example in which the antenna 200 includes one second element 253 is used for description. In actual production or design, a plurality of second elements 253 may alternatively be included, as shown in FIG. 42. The plurality of second elements 253 may further disperse a current density on the second radiator 240 (for example, strength of a single current strong point is reduced for a current distribution to be even), thereby reducing a loss caused by the second radiator 240 and a conductor disposed around the second radiator 240. In an embodiment, the current distribution on the second radiator 240 is even, so that a radiation aperture of the second radiator 240 can be increased. Therefore, the plurality of second elements 253 may further improve total efficiency and radiation efficiency of the antenna.

In an embodiment, the second radiator 240 may further be provided with a plurality of fourth slots, so that strength of a single current strong point of the second radiator 240 can be reduced for a current distribution to be even. In an embodiment, the current distribution on the second radiator 240 is even, so that a conductor loss and a dielectric loss that are caused by the second radiator 240, and a conductor and a medium that are disposed around the second radiator 240 can be reduced. In an embodiment, the current distribution on the second radiator 240 is even, so that a radiation aperture of the second radiator 240 can be increased. Therefore, the fourth slot is provided between the first coupling point 241 and the second coupling point 242, and the first element 252 is coupled, so that total efficiency and radiation efficiency of the antenna can be improved. In an embodiment, the first element 252 may be electrically connected between conductors on two sides of each fourth slot.

In an embodiment, when the second radiator 240 is of a T-shaped structure, the plurality of second elements 253 may be located on two sides of a ground point, some of the second elements 253 are located between the ground point and a third position, and some of the second elements 253 are located between the ground point and a fourth position.

In an embodiment, the second radiator 240 may operate in a wire CM-DM mode.

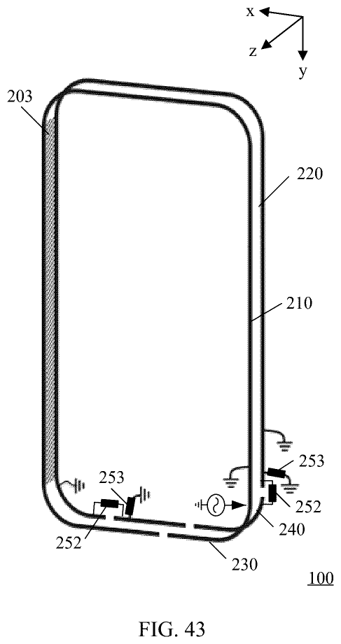

FIG. 43 is a diagram of the foldable electronic device 100 according to an embodiment of this disclosure.

It should be understood that, in the foregoing embodiment, only an example in which the second radiator 240 forms a structure of a wire antenna (for example, both a first end and a second end of the second radiator 240 are open ends, or one of a first end and a second end of the second radiator 240 is a ground end) is used for description. In actual production or design, a structure in which the second radiator 240 forms a slot antenna (for example, both the first end and the second end of the second radiator 240 are coupled to a ground plane as ground ends) is shown in FIG. 43.

As shown in FIG. 43, the second side frame 220 is coupled to the ground plane at the third position 221 and the fourth position 223.

In an embodiment, the second radiator 240 may also operate in a slot CM-DM mode.

FIG. 44 is a diagram of the foldable electronic device 100 according to an embodiment of this disclosure.

It should be understood that, in the foregoing embodiment, only an example in which an element is electrically connected between a parasitic stub (for example, the second radiator 240) and a ground plane is used for description. In actual production or design, an element may also be electrically connected between a main radiation stub (for example, the first radiator 230) and the ground plane, as shown in FIG. 44. The element electrically connected between the main radiation stub and the ground plane may be configured to disperse a current density on the main radiation stub (for example, strength of a single current strong point is reduced for a current distribution to be even), thereby reducing a loss caused by a conductor and a medium that are disposed around the main radiation stub for the current distribution to be even. In an embodiment, the current distribution on the first radiator 230 is even, so that a conductor loss and a dielectric loss that are caused by the first radiator 230, and a conductor and a medium that are disposed around the first radiator 230 can be reduced. In an embodiment, the current distribution on the first radiator 230 is even, so that a radiation aperture of the first radiator 230 can be increased. Therefore, total efficiency and radiation efficiency of an antenna can be further improved.

In an embodiment, the main radiation stub (for example, the first radiator 230) may be further provided with at least one slot, so that strength of a single current strong point of the first radiator 230 can be reduced for the current distribution to be even. In an embodiment, the current distribution on the first radiator 230 is even, so that a conductor loss and a dielectric loss that are caused by the first radiator 230, and a conductor and a medium that are disposed around the first radiator 230 can be reduced. In an embodiment, the current distribution on the first radiator 230 is even, so that a radiation aperture can be increased for improving total efficiency and radiation efficiency of the antenna. In an embodiment, an element may be electrically connected between conductors on two sides of each slot, to determine an equivalent capacitance value of the slot.

It should be understood that, for a specific antenna structure in which a slot is provided on the first radiator 230, refer to a specific structure in which a slot is provided on the second radiator 240.

In an embodiment, the first side frame 210 is coupled to the ground plane at the first position 211, and is provided with a second slot at the second position 212.

The first radiator 230 may include coupling points A and B. The first radiator 230 is provided with a slot C between the coupling point A and the coupling point B. A first end of the element D is coupled to the coupling point A, and a second end of the element D is coupled to the coupling point B.

In an embodiment, the element D may be configured to adjust an equivalent capacitance between the coupling point A and the coupling point B, to adjust a radiation characteristic (for example, a generated resonance frequency) of the first radiator. In an embodiment, a distance between the slot C and each of the coupling point A and the coupling point B is less than or equal to 5 mm. The distance between the slot C and each of the coupling point A and the coupling point B may be understood as a minimum distance between each of the coupling point A and the coupling point B, and conductors on the two sides of the slot C. When the element D is electrically connected to the coupling point A and the coupling point B via a metal spring plate, the distance between the slot C and each of the coupling point A and the coupling point B may be understood as a minimum distance between a center of a part that is of the metal spring plate and that is in contact with the coupling point and the conductors on two sides of the slot C.

It should be understood that an equivalent capacitor between the coupling point A and the coupling point B may be understood as a distributed capacitor formed by the slot C and an equivalent capacitor obtained after the element D is connected in parallel. A capacitance value of the equivalent capacitor may be determined by an electrical parameter (for example, an equivalent capacitance value) of the element D and an electrical parameter (for example, a width of the slot C and a relative dielectric constant of a medium filled in the slot C) of the slot C.

In an embodiment, a length of the first radiator 230 between the first position 211 and the slot C is less than a length of the first radiator 230 between the second slot and the slot C.

According to this embodiment of this disclosure, because the first side frame is coupled to the ground plane at the first position 211, a current near the first position 211 is strong; and the second position 212 is provided with a slit, so that a current near the second position 212 is weak. When the slot C is provided in an area with a strong current on the first radiator 230, an effect of reducing strength of a single current strong point of the first radiator through the slot C is more obvious, and current distribution on the first radiator is more even.

In an embodiment, the slot C is provided between a midpoint of the first radiator 230 and a ground end (for example, the first position 211). For example, a length of the first radiator 230 between the first position 211 and the slot C is less than a length of the first radiator 230 between the second slot and the slot C.

In an embodiment, the slot C is provided between a midpoint of the first radiator 230 and a ground end (for example, the first position 211). In addition, a length of the first radiator 230 between the first position 211 and the slot C is less than or equal to three fifths of a length of the first radiator 230 between the second slot and the slot C.

In an embodiment, the slot C is provided between a midpoint of the first radiator 230 and a ground end (for example, the first position 211). In addition, a length of the first radiator 230 between the first position 211 and the slot C is less than or equal to one third of a length of the first radiator 230 between the second slot and the slot C.

In an embodiment, the slot C is provided between a midpoint of the first radiator 230 and a ground end (for example, the first position 211). In addition, a length of the first radiator 230 between the first position 211 and the slot C is less than or equal to one seventh of a length of the first radiator 230 between the second slot and the slot C.

It should be understood that, for the area with the large current on the first radiator 230, a position at which the slot C is provided should be understood as a position corresponding to the first radiator 230 (for example, operating in a quarter-wavelength mode) that is not provided with a slit. After the slot C is provided, current intensity at the corresponding position becomes weak, to achieve an effect of evenly dispersing a current.

In an embodiment, the first radiator 230 and the element D are configured to generate a first resonance.

In an embodiment, the antenna 200 further includes an element E. The first radiator 240 includes a coupling point F. A first end of the element E is coupled to the coupling point F, and a second end of the element E is coupled to the ground plane. It should be understood that, for a position at which the element E is disposed on the first radiator 230, refer to a position at which the second element 253 is disposed on the second radiator 240. For a function and an effect of the element E on the first radiator 230, refer to a function and an effect of the second element 253 on the second radiator 240. Details are not described herein.

A structure (for example, coupling points A and B that are disposed on the first radiator, and the slot C and the element D that are provided between the coupling points A and B, and/or the coupling point F that is disposed on the first radiator 240 and the element E that is coupled to the coupling point F) related to the first radiator in the embodiment shown in FIG. 44 may be applied to another embodiment of this disclosure, to replace a first radiator structure in another embodiment.

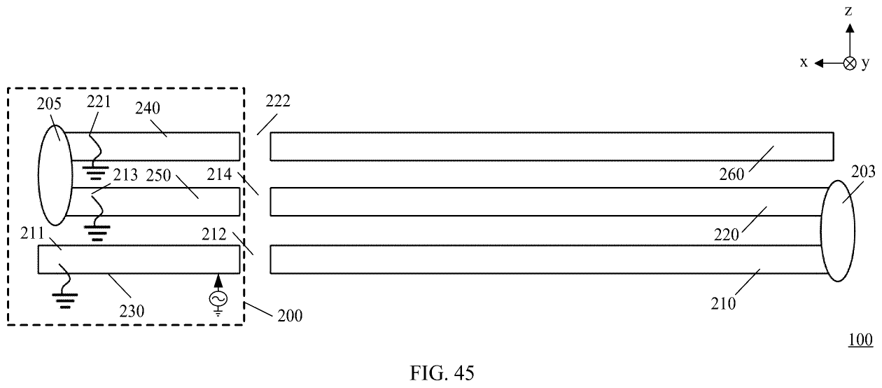

FIG. 45 to FIG. 47 are diagrams of the foldable electronic device 100 according to an embodiment of this disclosure.

It should be understood that, when the antenna 200 includes three radiators (for example, the first radiator 230, the second radiator 240, and the third radiator 250), only one of the radiators (for example, the second radiator 240) is shown as a parasitic stub in the foregoing embodiment to improve a radiation characteristic of an antenna element formed by two main radiators (for example, the first radiator 230 and the third radiator 250).

As shown in FIG. 45, the first side frame 210 is coupled to a ground plane at the first position 211, and is provided with a gap at the second position 212. The second side frame 220 is coupled to the ground plane at the fifth position 213, and is provided with a sixth slot at the sixth position 214. The third side frame 260 is coupled to the ground plane at the third position 221, and is provided with a third slot at the fourth position 222.

For brevity of description, this embodiment of this disclosure is described only by using an example in which first ends of the first radiator 230, the second radiator 240, and the third radiator 250 are all open ends, and second ends are all coupled to the ground plane as ground ends. In actual production or design, the first ends and the second ends of the first radiator 230, the second radiator 240, and the third radiator 250 may be disposed based on actual production.

In an embodiment, the first radiator 230, the second radiator 240, and the third radiator 250 may operate in a quarter-wavelength mode. It should be understood that, in actual production or design, operating modes of the first radiator 230, the second radiator 240, and the third radiator 250 are not limited.

In an embodiment, the first radiator 230 may be configured to generate a first resonance. The second radiator 240 may be configured to generate a first parasitic resonance. The third radiator 250 may be configured to generate a second parasitic resonance. In an embodiment, the first parasitic resonance and the second parasitic resonance may form a resonance frequency band together with the first resonance.

In an embodiment, a second slot at the second position 212, a third slot at the fourth position 222, and a sixth slot at the sixth position 214 at least partially overlap in a first direction (for example, a z direction).

It should be understood that, when the slots partially overlap in the first direction, and when an electrical signal is fed through a first feed point, the second radiator and the third radiator may obtain more energy by using electric fields in the slots through coupling, so that radiation characteristics of resonances generated by the second radiator and the third radiator are improved.

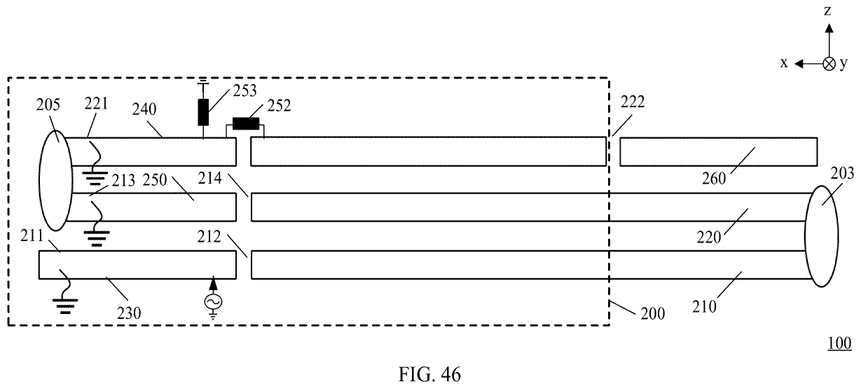

As shown in FIG. 46, relative to the antenna 200 shown in FIG. 45, at least one second element 253 may be electrically connected between the second radiator 240 and the ground plane. The second element 253 may disperse strength of a single current strong point on the second radiator 240 for a current distribution to be even. In an embodiment, the current distribution on the second radiator 240 is even, so that a loss caused by the second radiator 240, and a conductor and a medium that are disposed around the second radiator 240 can be reduced. In an embodiment, the current distribution on the second radiator 240 is even, so that a radiation aperture of the second radiator 240 can be increased for improving total efficiency and radiation efficiency of the antenna.

In an embodiment, the second radiator 240 may further be provided with at least one fourth slot. In an embodiment, the first element 252 may be electrically connected between conductors on two sides of each fourth slot.

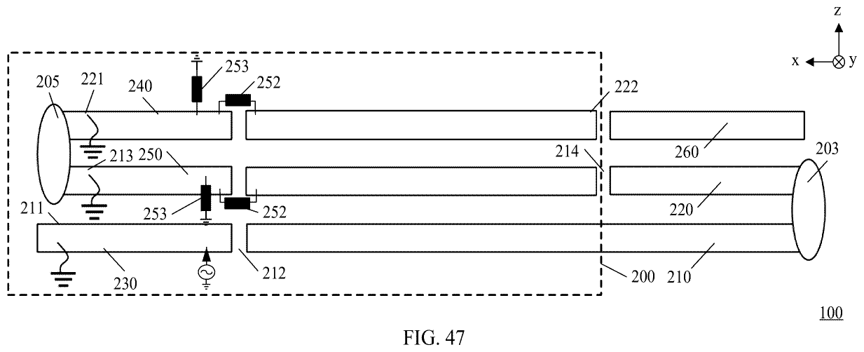

As shown in FIG. 47, relative to the antenna 200 shown in FIG. 46, at least one second element 253 may be coupled between the third radiator 250 and the ground plane. The second element 253 may disperse a current density on the third radiator 250 (for example, strength of a single current strong point is reduced for a current distribution to be even) for the current distribution to be even. In an embodiment, the current distribution on the third radiator 250 is even, so that a loss caused by the third radiator 250 and a conductor disposed around the third radiator 250 can be reduced. In an embodiment, the current distribution on the third radiator 250 is even, so that a radiation aperture of the third radiator 250 can be increased for improving total efficiency and radiation efficiency of the antenna.

In an embodiment, the third radiator 250 may further be provided with at least one fourth slot. In an embodiment, the first element 252 may be electrically connected between conductors on two sides of each fourth slot.

It should be understood that for the first element 252 coupled to the third radiator 250, and the first element 252 coupled to the second radiator 240, the second element 253 may be further coupled between the third radiator 250 and the ground plane, and the second element 253 may be further coupled between the second radiator 240 and the ground plane. For brevity, the first element and the second element are both represented by a same reference sign as the first element and the second element respectively correspond to the first element and the second element described above, and it does not indicate that the first elements (or the second elements) coupled on the two radiators are elements of a same type and/or a same capacitance-inductance value. In an embodiment, the first element 252 coupled to the third radiator 250 may be the foregoing capacitive element, the first element 252 coupled to the second radiator 240 may be the foregoing inductive element, and vice versa. The second element 253 should also be understood correspondingly. In the embodiment shown in FIG. 47, when the foldable electronic device 100 is in a folded state, both the third radiator 250 and the second radiator 240 partially overlap with the first radiator 230 in a first direction, where the first direction is a thickness direction of the foldable electronic device 100, for example, a z direction; and the third radiator 250 is disposed between the second radiator 240 and the first radiator 230 in the first direction.

In an embodiment, the first radiator 230 and the third radiator 250 are spaced apart in the first direction (for example, another conductor is disposed between the first radiator 230 and the third radiator 250, for example, in a multi-fold electronic device, the first radiator 230 and the second radiator 240 are disposed on non-adjacent housings).

In an embodiment, the second radiator 240 and the third radiator 250 may be spaced apart in the first direction (for example, another conductor is disposed between the second radiator 240 and the third radiator 250, for example, in a multi-fold electronic device, the first radiator 230 and the second radiator 240 are disposed on non-adjacent housings).

Refer to the embodiment shown in FIG. 47 again. When the foldable electronic device 100 is in the folded state, in an embodiment, both the second radiator 240 and the first radiator 230 are located on an outermost housing of the electronic device 100 in the first direction.

In an embodiment, the first radiator 230 is configured to generate a first resonance. The second radiator 240 and the first element 252 corresponding to the second radiator 240 are configured to generate a first parasitic resonance. The third radiator 250 and the first element 252 corresponding to the third radiator 250 are configured to generate a second parasitic resonance.

In an embodiment, a resonance frequency band of the antenna 200 includes any operating frequency band within a range of 600 MHz to 1.5 GHZ.

A difference between the resonance point frequency of the first parasitic resonance and the resonance point frequency of the first resonance may be less than or equal to 200 MHz. Alternatively, in an embodiment, a resonance frequency band of the antenna 200 includes any operating frequency band within a range of 600 MHz to 1.5 GHZ, and a difference between the resonance point frequency of the first parasitic resonance and the resonance point frequency of the first resonance may be less than or equal to 100 MHz; and/or a difference between the resonance point frequency of the second parasitic resonance and the resonance point frequency of the first resonance may be less than or equal to 350 MHz; or a difference between the resonance point frequency of the second parasitic resonance and the resonance point frequency of the first resonance is between 150 MHz and 350 MHz (including endpoints).

In an embodiment, a resonance frequency band of the antenna 200 includes any operating frequency band within a range of 1.5 GHz to 3 GHz.

A difference between the resonance point frequency of the first parasitic resonance and the resonance point frequency of the first resonance may be less than or equal to 400 MHZ. Alternatively, in an embodiment, a resonance frequency band of the antenna 200 includes any operating frequency band within a range of 1.5 GHz to 3 GHZ, and a difference between the resonance point frequency of the first parasitic resonance and the resonance point frequency of the first resonance may be less than or equal to 200 MHz; and/or a difference between the resonance point frequency of the second parasitic resonance and the resonance point frequency of the first resonance may be less than or equal to 600 MHz; or a difference between the resonance point frequency of the second parasitic resonance and the resonance point frequency of the first resonance is between 200 MHz and 450 MHz (including endpoints).

In an embodiment, a resonance frequency band of the antenna 200 includes any operating frequency band within a range of 3 GHz to 6 GHz.

A difference between the resonance point frequency of the first parasitic resonance and the resonance point frequency of the first resonance may be less than or equal to 600 MHz. Alternatively, in an embodiment, a resonance frequency band of the antenna 200 includes any operating frequency band within a range of 3 GHz to 6 GHZ, and a difference between the resonance point frequency of the first parasitic resonance and the resonance point frequency of the first resonance may be less than or equal to 400 MHz; and/or a difference between the resonance point frequency of the second parasitic resonance and the resonance point frequency of the first resonance may be less than or equal to 900 MHz; or a difference between the resonance point frequency of the second parasitic resonance and the resonance point frequency of the first resonance is between 350 MHz and 700 MHZ (including endpoints).

It should be understood that the resonance point of the first parasitic resonance, the resonance point of the first resonance, and the resonance point of the second parasitic resonance may be adjusted based on an actual production design. In an embodiment, the difference between the resonance point frequency of the first parasitic resonance and the resonance point frequency of the first resonance is less than the difference between the resonance point frequency of the second parasitic resonance and the resonance point frequency of the first resonance. This optimizes an efficiency pit and improves total efficiency of the antenna.

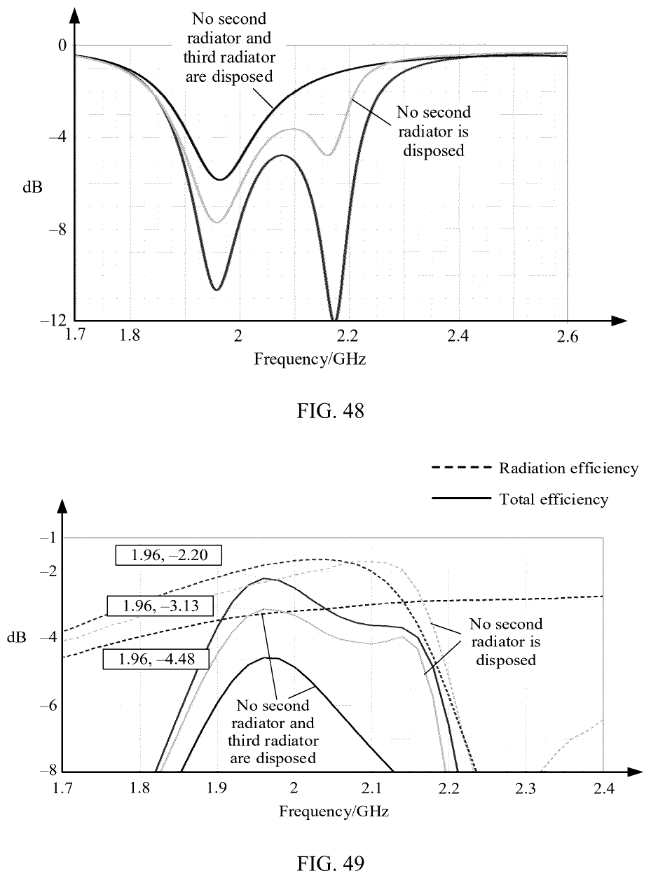

FIG. 48 and FIG. 49 are diagrams of a simulation result of the antenna shown in FIG. 47. FIG. 48 is a diagram of an S parameter simulation result of the antenna shown in FIG. 47. FIG. 49 shows simulation results of radiation efficiency and total efficiency of the antenna shown in FIG. 47.

As shown in FIG. 48, the simulation result of the S parameter of the antenna shown in FIG. 47 is shown.

When the foldable electronic device is in a folded state and no second radiator and no third radiator are disposed, the antenna generates a resonance only by using the first radiator near 1.96 GHz.

When the foldable electronic device is in a folded state and no second radiation is disposed, the antenna may generate a resonance by using the first radiator and the third radiator, and generate two resonances near 1.96 GHz and near 2.16 GHz. The resonance (a first parasitic resonance) near 2.16 GHz may be generated by the third radiator.

When the foldable electronic device is in a folded state, the antenna may generate a resonance by the first radiator, the second radiator, and the third radiator, and the antenna 200 may generate resonances near 1.96 GHz and 2.16 GHz. A second parasitic resonance generated by the second radiator and the first parasitic resonance generated by the third radiator may jointly generate a resonance frequency band, and the first parasitic resonance and the second parasitic resonance cannot be distinguished.

When S11<−3 dB, an operating bandwidth of the antenna when the foldable electronic device is in an unfolded state is less than an operating bandwidth of the antenna when the foldable electronic device is in a partially-unfolded state, and is less than an operating bandwidth of the antenna when the foldable electronic device is in the folded state.

As shown in FIG. 49, in comparison with a case in which no parasitic stub (for example, the second radiator or the third radiator) is disposed in the foldable electronic device, when the parasitic stub is disposed in the foldable electronic device, a radiation characteristic of the antenna is improved through the parasitic stub, and both total efficiency and radiation efficiency are improved.

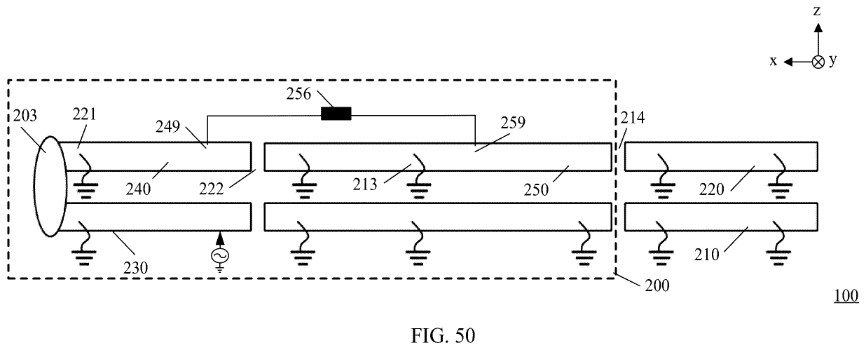

FIG. 50 to FIG. 52 are diagrams of the foldable electronic device 100 according to an embodiment of this disclosure.

As shown in FIG. 50, the third position 221, the fourth position 222, the fifth position 213, and the sixth position 214 may be located on the second side frame 220. The second radiator 240 and the first radiator 230 at least partially overlap in a first direction, and the third radiator 250 and the first radiator 230 do not completely overlap in the first direction.

The second radiator 240 includes a first connection position 249, and the third radiator 250 may include a second connection position 259. The antenna 200 may further include a fourth element 256. A first end of the fourth element 256 is coupled to the first connection position 249, and a second end of the fourth element 256 is coupled to the second connection position 259.

It should be understood that, in the antenna 200 shown in FIG. 45 to FIG. 48, the second radiator 240 and the third radiator 250 that are used as parasitic stubs are respectively located on different housings, and at least partially overlap the first radiator 230 that is used as a main radiation stub in a first direction, to generate a resonance through indirect coupling. However, in the antenna 200 shown in FIG. 50, the second radiator 240 and the third radiator 250 are separately located on a same housing, and the second radiator 240 generates a resonance through indirect coupling. The third radiator 250 is coupled to the first connection position 249 of the second radiator 240 through the second connection position 259, and is indirectly coupled to the second radiator 240, to generate a resonance.

In an embodiment, the fourth element 256 may be configured to adjust a phase difference between an electrical signal at the first connection position 249 and an electrical signal at the second connection position 259, so that indirect coupling between the third radiator 250 and the second radiator 240 can be enhanced, the third radiator 250 is fully excited, and radiation performance is improved.

In an embodiment, the fourth position 222 is located between the third position 221 and the fifth position 213, and the fifth position 213 is located between the sixth position 214 and the fourth position 222, as shown in FIG. 50. In an embodiment, the second side frame 220 between the fourth position 222 and the fifth position 213 is coupled to a ground plane.

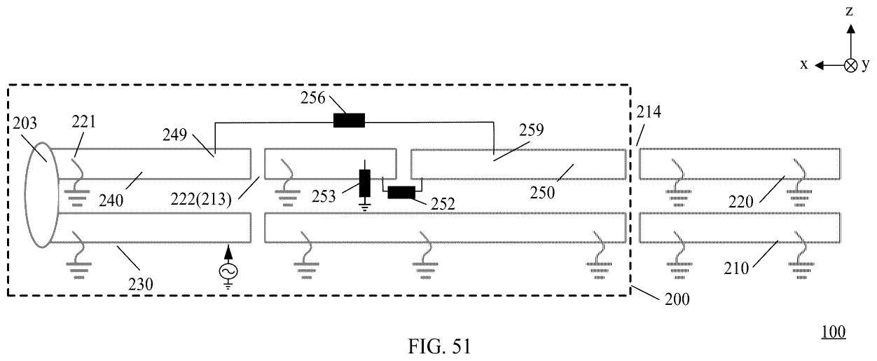

In an embodiment, the fourth position 222 is the same as the fifth position 213, as shown in FIG. 51. In an embodiment, a second end of the second radiator 240 and a first end of the third radiator 250 are opposite to, but do not touch each other.

As shown in FIG. 51, relative to the antenna 200 shown in FIG. 50, at least one second element 253 may be electrically connected between the third radiator 250 and the ground plane. The second element 253 may disperse strength of a single current strong point on the third radiator 250 for a current distribution to be even. In an embodiment, the current distribution on the third radiator 250 is even, so that a loss caused by the third radiator 250, and a conductor and a medium that are disposed around the third radiator 250 can be reduced. In an embodiment, the current distribution on the third radiator 250 is even, so that a radiation aperture of the third radiator 250 can be increased for improving total efficiency and radiation efficiency of the antenna.

In an embodiment, the third radiator 250 may further be provided with at least one fourth slot. In an embodiment, the first element 252 may be electrically connected between conductors on two sides of each fourth slot.

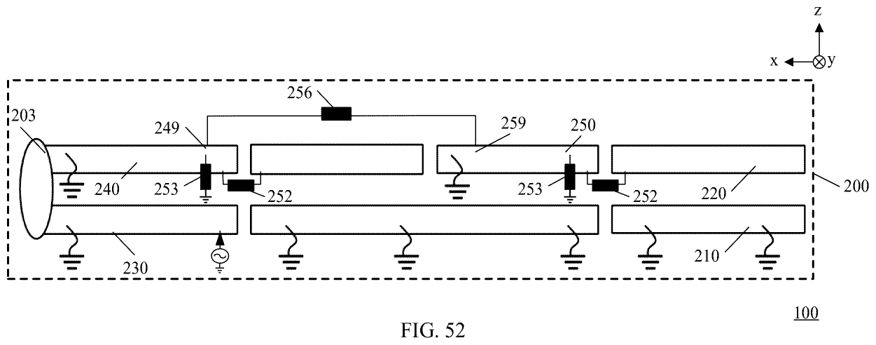

As shown in FIG. 52, relative to the antenna 200 shown in FIG. 51, at least one second element 253 may be electrically connected between the second radiator 240 and the ground plane. The second element 253 may disperse strength of a single current strong point on the second radiator 240 for a current distribution to be even. In an embodiment, the current distribution on the second radiator 240 is even, so that a loss caused by the second radiator 240, and a conductor and a medium that are disposed around the second radiator 240 can be reduced. In an embodiment, the current distribution on the second radiator 240 is even, so that a radiation aperture of the third radiator 250 can be increased for improving total efficiency and radiation efficiency of the antenna.

In an embodiment, the second radiator 240 may further be provided with at least one fourth slot. In an embodiment, the first element 252 may be electrically connected between conductors on two sides of each fourth slot.

A person skilled in the art may use different methods to implement the described functions for each specific application, but such implementation should not be considered beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A foldable electronic device, comprising:
a ground plane;
a first housing comprising a first side frame, wherein the ground plane and at least a part of the first side frame are spaced apart, wherein the first side frame comprises a first portion and a second portion, wherein the first side frame is coupled to the ground plane at the first portion or comprises a first slot at the first portion, and wherein the first side frame is coupled to the ground plane at the second portion or comprises a second slot at the second portion;
a second housing comprising a second side frame, wherein the ground plane and at least a part of the second side frame are spaced apart, wherein the second side frame comprises a third portion and a fourth portion, wherein the second side frame is coupled to the ground plane at the third portion, and wherein the second side frame comprises a third slot at the fourth portion;
a first rotating shaft located between the first housing and the second housing, wherein the first rotating shaft is rotatably connected to the first housing and the second housing separately; and
an antenna comprising:
a first radiator comprising a first feed point, wherein the first radiator is a conductive part between the first portion and the second portion of the first side frame;
a first feed circuit coupled to the first feed point;
a second radiator comprising a first coupling point, a second coupling point, and a fourth slot between the first coupling point and the second coupling point, wherein the second radiator is a conductive part between the third portion and the fourth portion of the second side frame, and wherein a second radiator length of the second radiator is less than or equal to three times a first radiator length of the first radiator; and
a first element comprising:
a first end coupled to the first coupling point; and
a second end coupled to the second coupling point,
wherein when the foldable electronic device is in a folded state, the first radiator and the second radiator are configured to at least partially overlap in a thickness direction of the foldable electronic device, the first radiator is configured to generate a first resonance, and the second radiator and the first element are configured to generate a first parasitic resonance.

2. The foldable electronic device of claim 1, wherein the second radiator further comprises:
a first length between the third portion and the fourth slot; and
a second length between the third slot and the fourth slot, wherein the first length is less than the second length.

3. The foldable electronic device of claim 1, wherein the first element further comprises an equivalent capacitance value that is less than or equal to a first threshold, wherein when a resonance point frequency of the first parasitic resonance is less than or equal to 1 gigahertz (GHz), the first threshold is 10 picofarads (pF), and wherein when the resonance point frequency of the first parasitic resonance is greater than 1 GHz, the first threshold is 2 pF.

4. The foldable electronic device of claim 1, wherein the second radiator further comprises a third coupling point, wherein the antenna further comprises a second element, wherein the second element comprises:
a third end coupled to the third coupling point; and
a fourth end coupled to the ground plane, and
wherein the second radiator, the first element, and the second element are configured to generate the first parasitic resonance.

5. The foldable electronic device of claim 4, wherein the second element comprises an equivalent inductance value that is less than or equal to 10 nanohenries (nH).

6. The foldable electronic device of claim 4, wherein the first coupling point is located between the third portion and the fourth slot, wherein the second coupling point is located between the fourth portion and the fourth slot, and wherein the third coupling point is either:
located between the third portion and the first coupling point such that a first distance between the first coupling point and the third coupling point is greater than or equal to 0 millimeter (mm) and less than or equal to 5 mm; or
located between the fourth portion and the second coupling point such that a second distance between the second coupling point and the third coupling point is greater than or equal to 0 mm and less than or equal to 5 mm.

7. The foldable electronic device of claim 1, wherein at least one of a first distance between the first coupling point and the fourth slot is less than or equal to 5 millimeter (mm) or a second distance between the second coupling point and the fourth slot is less than or equal to 5 mm.

8. The foldable electronic device of claim 1, wherein the second radiator comprises an electrical length that is greater than three eighths of a first wavelength, and wherein the first wavelength corresponds to the first parasitic resonance.

9. The foldable electronic device of claim 1, wherein when a first resonance point frequency of the first resonance is less than or equal to 1.5 gigahertz (GHz), a difference between a second resonance point frequency of the first parasitic resonance and the first resonance point frequency is less than or equal to 200 megahertz (MHz), wherein when the first resonance point frequency is less than or equal to 3 GHz and greater than 1.5 GHZ, a difference between the second resonance point frequency and the first resonance point frequency is less than or equal to 400 MHZ, and wherein when the first resonance point frequency is less than or equal to 6 GHz and greater than 3 GHZ, a difference between the second resonance point frequency and the first resonance point frequency is less than or equal to 600 MHz.

10. The foldable electronic device of claim 1, wherein the second radiator length is greater than or equal to 0.8 times the first radiator length.

11. The foldable electronic device of claim 1, wherein the first side frame is coupled to the ground plane at the first portion, and wherein the first side frame further comprises the second slot at the second portion.

12. The foldable electronic device of claim 11, wherein the second radiator length is greater than or equal to 1.5 times the first radiator length, and wherein the second radiator length is less than or equal to 2.5 times the first radiator.

13. The foldable electronic device of claim 12, wherein the first feed point is located between a first ground point and the second portion, wherein the first radiator further comprises a fourth coupling point located between the first portion and the first ground point, wherein the antenna further comprises a third element, and wherein the third element comprises:
a third end coupled to the fourth coupling point; and
a fourth end coupled to the ground plane.

14. The foldable electronic device of claim 11, wherein the first side frame comprises a fifth portion and a sixth portion, wherein the second portion is located between the fifth portion and the first portion, wherein the fifth portion is located between the second portion and the sixth portion, wherein the first side frame is coupled to the ground plane at the fifth portion, wherein the first side frame comprises a fifth slot at the sixth portion, and wherein the antenna further comprises:
a third radiator comprising a second feed point, wherein the third radiator is a conductive part between the second portion and the sixth portion of the first side frame; and
a second feed circuit coupled to the second feed point.

15. The foldable electronic device of claim 14, wherein the third radiator further comprises a fourth coupling point, wherein the second feed point is located between the fifth portion and the sixth portion, wherein the fourth coupling point is located between the second portion and the fifth portion, wherein the antenna further comprises a third element, and wherein the third element comprises:
a third end coupled to the fourth coupling point; and
a fourth end coupled to the ground plane.

16. The foldable electronic device of claim 14, wherein the third radiator further comprises:
a fourth coupling point located between the fifth portion and the sixth portion; and
a fifth coupling point located between the second portion and the fifth portion, and
wherein the antenna further comprises:
a first tuning component comprising:
a third end coupled to the fourth coupling point; and
a fourth end coupled to the ground plane; and
a second tuning component comprising:
a fifth end coupled to the fifth coupling point; and
a sixth end coupled to the ground plane.

17. The foldable electronic device of claim 11, wherein the first side frame comprises a fifth portion and a sixth portion, wherein the second portion is located between the fifth portion and the first portion, wherein the fifth portion is located between the second portion and the sixth portion, wherein the first side frame is coupled to the ground plane at the fifth portion, wherein the first side frame comprises a fifth slot at the sixth portion, and wherein the antenna further comprises:
a third radiator comprising a second feed point, wherein the third radiator is a conductive part between the fifth portion and the sixth portion of the first side frame; and
a second feed circuit coupled to the second feed point.

18. The foldable electronic device of claim 1, further comprising:
a third housing having a third side frame, wherein the ground plane and at least a part of the third side frame are spaced apart, wherein the third side frame comprises a fifth portion and a sixth portion, and wherein the third side frame is coupled to the ground plane at the fifth portion or comprises a fifth slot at the fifth portion, and the third side frame is coupled to the ground plane at the sixth portion or comprises a sixth slot at the sixth portion;
a second rotating shaft located between the first housing and the third housing, and rotatably connected to the first housing and the third housing separately,
wherein the antenna further comprises:
a third radiator comprising a second feed point, wherein the third radiator is a conductive part between the fifth portion and the sixth portion of the first side frame; and
a second feed circuit coupled to the second feed point, and
wherein when the foldable electronic device is in the folded state, the third radiator and the second radiator are configured to at least partially overlap in the thickness direction.

19. The foldable electronic device of claim 18, wherein the first side frame comprises the first slot at the first portion and the second slot at the second portion, wherein the third side frame is coupled to the ground plane at the fifth portion, wherein the third side frame comprises the sixth slot at the sixth portion, wherein the first side frame further comprises a first ground point located between the first portion and the second portion, and wherein the first side frame is coupled to the ground plane.

20. The foldable electronic device of claim 18, wherein the first side frame comprises the first slot at the first portion and the second slot at the second portion, wherein the third side frame comprises the fifth slot at the fifth portion, wherein the third side frame comprises the sixth slot at the sixth portion, wherein the first side frame further comprises a first ground point located between the first portion and the second portion, wherein the first side frame is coupled to the ground plane at the first ground point, wherein the third side frame further comprises a second ground point located between the fifth portion and the sixth portion, and wherein the third side frame is coupled to the ground plane at the second ground point.
